(19) United States
(12) Patent Application Publication
(10) Pub. No.: US 2009/0234788 A1
(43) Pub. Date: Sep. 17, 2009

(54) Practical Time Machine Using Dynamic Efficient Virtual And Real Robots

(76) Inventor: Mitchell Kwok, Honolulu, HI (US)

Correspondence Address: Mitchell Kwok, 1675 Kamamalu Ave., Honolulu, HI, 96813, US

(21) Appl. No.: 12/471,382

(22) Filed: May 24, 2009

Related U.S. Application Data
(63) Continuation-in-part of application No. 12/135,132, filed on Jun. 6, 2008.
Application No. 12/135,132 is a continuation-in-part of application No. 12/129,231, filed on May 29, 2008.
Application No. 12/129,231 is a continuation-in-part of application No. 12/110,313, filed on Apr. 26, 2008.
Application No. 12/110,313 is a continuation-in-part of application No. 12/014,742, filed on Jan. 15, 2008.
Application No. 12/014,742 is a continuation-in-part of application No. 11/936,725, filed on Nov. 7, 2007.
Application No. 11/936,725 is a continuation-in-part of application No. 11/770,734, filed on Jun. 29, 2007.
Application No. 11/770,734 is a continuation-in-part of application No. 11/744,767, filed on May 4, 2007.
(60) Provisional application No. 61/155,113, filed on Feb. 24, 2009.
(60) Provisional application No. 61/083,930, filed on Jul. 27, 2008.
(60) Provisional application No. 61/080,910, filed on Jul. 15, 2008.
(60) Provisional application No. 61/079,109, filed on Jul. 8, 2008.
(60) Provisional application No. 61/077,178, filed on Jul. 1, 2008.
(60) Provisional application No. 61/074,634, filed on Jun. 22, 2008.
(60) Provisional application No. 61/073,256, filed on Jun. 17, 2008.
(60) Provisional application No. 61/042,733, filed on Apr. 5, 2008.
(60) Provisional application No. 61/035,645, filed on Mar. 11, 2008.
(60) Provisional application No. 61/028,885, filed on Feb. 14, 2008.
(60) Provisional application No. 61/015,201, filed on Dec. 20, 2007.
(60) Provisional application No. 60/909,437, filed on Mar. 31, 2007.

(51) Int. Cl. G06N 5/04; G06F 17/30

(52) U.S. Cl. 706/46; 707/3; 718/1; 901/50; 706/12

(57) ABSTRACT

A method for time travel, which allows an object or a group of objects to travel into the past or the future, as well as a method to cut objects from the past or future and paste them to the current environment. The present invention, called the practical time machine, requires teams of super intelligent robots that work together in the virtual world and the real world to generate a perfect timeline of planet Earth. The timeline of Earth records all objects, events and actions every fraction of a nanosecond for the past or the future. A time traveler will set a time travel date; the time traveler can be one object or a group of objects. Next, atom manipulators are scattered throughout the Earth to change objects in our current environment based on the timeline; and incrementally, change the current environment until the time travel date. Each atom manipulator is intelligent and manipulates the current environment as well as generating ghost machines to manipulate the current environment. Also, components of the practical time machine can be used to create technology for the purpose of: building cars, planes and rockets that travel at the speed of light, building intelligent weapons, creating physical objects from thin air, using a chamber to manipulate objects, building force fields, making objects invisible, building super powerful lasers, building anti-gravity machines, creating strong metals and alloys, creating the smallest computer chips, collecting energy without any solar panels or wind turbines, making physical DNA, manipulating existing DNA, making single cell organisms, controlling the software and hardware of computers and servers without an internet connection, and manipulating any object in the world.

### CROSS REFERENCE TO RELATED APPLICATIONS

This application claims the benefit of U.S. Provisional Application No. 61/155,113, filed on Feb. 24, 2009, which claims the benefit of U.S. Provisional Application No. 61/083,930, filed on Jul. 27, 2008, which claims the benefit of U.S. Provisional Application No. 61/080,910, filed on Jul. 15, 2008, which claims the benefit of U.S. Provisional Application No. 61/079,109, filed on Jul. 8, 2008, which claims the benefit of U.S. Provisional Application No. 61/077,178, filed on Jul. 1, 2008, which claims the benefit of U.S. Provisional Application No. 61/074,634, filed on Jun. 22, 2008, which claims the benefit of U.S. Provisional Application No. 61/073,256, filed on Jun. 17, 2008, which claims the benefit of U.S. Provisional Application No. 61/053,334, filed on May 15, 2008, which is a Continuation-in-Part application of U.S. Ser. No. 12/135,132, filed on Jun. 6, 2008, entitled: Time Machine Software, which claims the benefit of U.S. Provisional Application No. 61/042,733, filed on Apr. 5, 2008, this application is also a Continuation-in-Part application of U.S. Ser. No. 12/129,231, filed on May 29, 2008, entitled: Human Artificial Intelligence Machine, which claims the benefit of U.S. Provisional Application No. 61/035,645, filed on Mar. 11, 2008, which is a Continuation-in-Part application of U.S. Ser. No. 12/110,313, filed on Apr. 26, 2008, entitled: Human Level Artificial Intelligence Machine, which claims the benefit of U.S. Provisional Application No. 61/028,885 filed on Feb. 14, 2008, which is a Continuation-in-Part application of U.S. Ser. No. 12/014,742, filed on Jan. 15, 2008, entitled: Human Artificial Intelligence Software Program, which claims the benefit of U.S. Provisional Application No. 61/015,201 filed on Dec. 20, 2007, which is a Continuation-in-Part application of U.S. Ser. No. 11/936,725, filed on Nov. 7, 2007, entitled: Human Artificial Intelligence Software Application for Machine & Computer Based Program Function, which is a Continuation-in-Part application of U.S. Ser. No. 11/770,734, filed on Jun. 29, 2007 entitled: Human Level Artificial Intelligence Software Application for Machine & Computer Based Program Function, which is a Continuation-in-Part application of U.S. Ser. No. 11/744,767, filed on May 4, 2007 entitled: Human Level Artificial Intelligence Software Application for Machine & Computer Based Program Function, which claims the benefit of U.S. Provisional Application No. 60/909,437, filed on Mar. 31, 2007.

### STATEMENT REGARDING FEDERALLY SPONSORED RESEARCH OR DEVELOPMENT

(Not applicable)

### BACKGROUND OF THE INVENTION

1. Field of the Invention

This invention relates generally to the field of time travel. Moreover it pertains specifically to technologies that manipulate objects in our current environment.

2. Description of Related Art

Is time travel possible? Einstein stated that time travel is possible if an object can travel faster than the speed of light. He also discovered that no object in the universe can travel faster than the speed of light, which disproves his time travel theory. He is right in that different space has “slightly” different time, but for the most part, time travel into the past or future is impossible.

Other theories related to time travel will include using worm holes, using black holes, warping time, spinning the earth backwards and using cosmic strings. These are theories that have been past down from generation to generation. They don't work very well because these theories are difficult or impossible to implement in the real world.

### SUMMARY OF THE INVENTION

All inventions below are encapsulated which means they are built on top of each other. The present invention, called the practical time machine, need all 9 inventions in order to build.

1. Universal artificial intelligence

2. Human level artificial intelligence

3. AI robots thousands of times smarter than human beings

4. Exponential human artificial intelligence

5. The time machine

6. Signalless internet and signalless telephone systems

7. Dynamic efficient virtual and real robots

8. The atom manipulator

9. Ghost machines

The understanding of how the practical time machine works will require the understanding of all 9 inventions previous to it. The reader should have a comprehensive understanding of all 9 inventions before proceeding onward.

The practical time machine makes time travel possible. It works by having super intelligent robots create a timeline of planet Earth every fraction of a nanosecond for the past and future. A time traveler will set a time travel date, said time traveler comprising at least one object; and said time traveler can be in at least one of the following states: frozen state and controlled changed state. Next, an atom manipulator is used to manipulate the environment, incrementally, according to the timeline. The atom manipulator generates what is known as “ghost machines” to change the environment in an intelligent way. These ghost machines can be small like a molecule or it can be big like a forklift. Sometimes, thousands of ghost machines are created and they have to work together in order to change the environment. The creation of the ghost machines, their intelligence, and their physical actions are controlled by the atom manipulator. From the current environment, the atom manipulator will incrementally manipulate the current environment until it reaches said time travel date.

The practical time machine doesn't just allow objects to travel in time, it can cut and paste objects from any time period. It can essentially “bring people back from the dead”. For example, a person that died in 1941 can be brought back to life in 2009. Famous people and actors can all be brought back from the dead. Non-intelligent objects such as bridges and statues can also be restored to its prime in 2009. Remember, the timeline tracks all atoms, electrons and EM radiations every fraction of a nanosecond for Earth. Most of the atoms that existed in 1800 are still here together (thanks to Earth's gravity). All the atom manipulator has to do is find these atoms and put all these atoms together again, forming the deceased object.

How do you create a perfect timeline of Earth for the past and future? How does the atom manipulator change the environment? How does the ghost machines work? How do you collect information from the environment with minimal tampering? How do you know the movements of an electron orbiting its nucleus? How do you predict future events with pinpoint accuracy? These are some questions that will be answered in this patent application.

### BRIEF DESCRIPTION OF THE DRAWINGS

For a more complete understanding of the present invention and for further advantages thereof, reference is now made to the following Description of the Preferred Embodiments taken in conjunction with the accompanying Drawings in which:

FIG. 1 is a software diagram illustrating a robot with a 6^{th} sense.

FIGS. 2-4 are diagrams depicting how a robot uses the virtual world to do work.

FIGS. 5-6 are diagrams depicting the universal computer program.

FIG. 7 is a diagram illustrating a station pathway.

FIG. 8 is a diagram depicting multiple robots working in a dynamic environment.

FIGS. 9-11 are diagrams illustrating various investigative tools and knowledge the robots uses to generate a perfect timeline of Earth for the past and future.

FIGS. 12-13B are diagrams demonstrating one example of multiple robots structured hierarchically to accomplish a task.

FIGS. 14-16 are diagrams depicting hierarchical structures and organizations.

FIGS. 17-18 are diagrams depicting the signalless technology.

FIGS. 19A-22 are diagrams depicting the atom manipulator.

FIGS. 23-24 are diagrams depicting pathway data types of the atom manipulator.

FIGS. 25-33 are diagrams demonstrating encapsulation of work by robots or virtual characters by using the universal computer program.

FIGS. 34-36 are diagrams illustrating assigning controllers to encapsulated work.

FIGS. 37-42 are diagrams depicting the virtual characters, structured in a hierarchical manner, using videogame software to generate the instructions for the laser system in the atom manipulator.

FIGS. 43-49 are diagrams illustrating training sessions for the atom manipulator and how the robots create these training sessions.

FIGS. 50-54 are diagrams illustrating ghost machines.

FIGS. 55-59 are diagrams illustrating various examples of ghost machines.

FIGS. 60-65 and FIG. 67 are diagrams depicting encapsulated work for ghost machines.

FIG. 66 is a diagram depicting the data structure of the simulation brain.

FIG. 68 is a diagram illustrating a personal model for one intelligent object.

FIGS. 69-71 are diagrams further illustrating the simulation brain.

FIGS. 72-74 are diagrams depicting various prediction methods.

### DESCRIPTION OF THE PREFERRED EMBODIMENTS

### How Time Travel Happens

The practical time machine comprises two parts: (1). a perfect timeline of planet Earth for the past and future. (2). Atom manipulators.

The Dynamic efficient robots will create the perfect timeline of planet earth and track every single atom, electron and em radiation every fraction of a nanosecond. The time traveler has to plot out a time travel date. The current state is also identified in the timeline. Next, multiple atom manipulators are sent out into Earth to shoot lasers at atoms and to position atoms, electrons and em radiations based on the timeline. These atom manipulators will work as a team and to use the timeline as a blueprint to incrementally position atoms to their before state. Some objects require the atom manipulator to break open and to insert things into it. For example, blood that flows out of a human being has to come back into the human being. They can only do this if they “break” open a human being and insert the blood back in.

The atom manipulator has to position atoms exactly to the incremental states of the timeline. By doing this, it is easier to track atoms and to move them around. They will first work on one incremental state of the timeline. When all atom manipulators have finished that state and checked to make sure nothing is misplaced, they can move on to the next incremental state. This will go on and on until the time travel date is reached. At that point, all atoms will be released from their stationary state and the atoms will behave normally.

In order to position an atom in a certain area, the atom manipulator has to cancel out forces acting upon the atom, including gravity and external objects. In some respects that is very hard to do because gravity is constant. However, they have to work together to position these atoms in their proper areas.

The atom manipulator also create “ghost machines” that will work together to accomplish tasks. Ghost machines are created by the environment and powered by the environment. These ghost machines replace any physical machines to do work. For example, a group of surgeons are needed to do lung cancer surgery. The atom manipulator can create ghost machines to do the same surgery.

These ghost machines will manipulate objects in the environment according to the blueprint in the timeline. Blood that comes out of a human being from a cut, has to go back into the human being, EM radiation that is emitted from an electron has to go back into the electron, and a fetus going through mitosis has to go through reverse-mitosis.

The practical time machine took me a total of 8.5 years to design. 21 patent applications have been filed and 17 full books have been written. Condensing 6,000 unique pages into this patent application isn't very easy to do. I will try to describe the most fundamental and basic data structures of the various components related to the practical time machine.

The present invention will be explained in terms of topics. Breaking various components into topics will make this patent application more organized. Here are the topics listed in linear order.

1. Robots with the 6^{th} sense. 2. Multiple robots working in a dynamic environment. 3. Signalless technology. 4. The atom manipulator. 5. Ghost machines. 6. Other topics

1. Robots with a 6^{th} Sense

Patent application Ser. No. 12/110,313 describes the psychic robot in detail. Here is a summary of the technology: A robot has a built in virtual world which serves as a 6^{th} sense. The robot can choose to enter the virtual world whenever and wherever it chooses. Usually, the robot defines a problem to solve and understand the facts related to the problem. Then it will transport itself into the virtual world as a digital copy of itself (similar to the matrix movie). The digital copy will be called “the robot” and the intelligence of the robot will be referencing pathways in the robot in the real world. In the virtual world is a time machine, which consists of a videogame environment that emulates the real world. All objects, physics laws, chemical reactions and computer software/hardware are emulated perfectly inside the time machine. The job of the robot is to control the time machine to search and extract specific information from virtual characters.

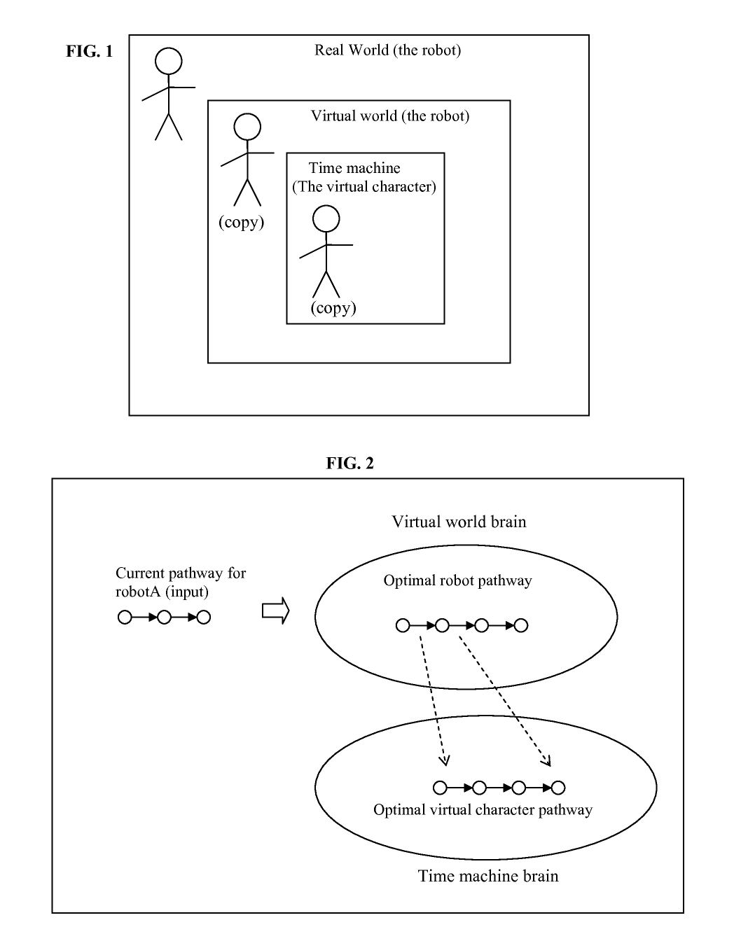

The robot will set the environment of the time machine depending on the problem it wants to solve. For example, if the robot wanted to do a math homework, it has to create an appropriate setting to solve math equations. In the time machine the robot has to create a comfortable room void of any noise, the math book the homework is located, several reference math books, a notebook, a pencil, a computer, a chair and a calculator. Once the setting of the environment is created, the robot will copy itself again into the time machine, designated as “the virtual character”. The virtual character is another digital copy of the robot and the intelligence is referencing the same pathways in the brain of the robot located in the real world. Once the virtual character is comfortable in the time machine environment it can start doing “work”. In this case, it consciously chooses to do a math homework. It will spend 2 weeks doing the math homework. After it is finished, the virtual character will send a signal to the robot in the virtual world that it has accomplished the task. The robot will then take the math homework and store that information as a digital file in his home computer. Then the robot will exit the virtual world and transport itself into the real world where it will apply the information it has extracted from the time machine (FIG. 1).

At this point, some people might ask: why is the time machine encased in the virtual world? Why not simply have one virtual world? The reason is that the robot has to set the environment of the time machine so that the virtual characters can do their job. Another reason is that the virtual characters have to have goals that they want to accomplish the moment they are in the time machine. The robot is also responsible for searching and extracting information from the virtual characters.

The robot in the virtual world can actually make as many copies of itself as needed to solve a problem. It can create a team of itself to solve a problem, each copy referencing the pathways in the brain of the robot located in the real world. The problem that the team of virtual characters want to solve might be large, for example, they might want to cure cancer. They will work together to get things done by dividing the work load and structuring the virtual characters in a hierarchical manner. The team will be like a company, whereby each member of the company will have their own jobs to do and they will all work together to achieve the goals of the company. These virtual characters are no exception because they will work together in a team like setting, dividing tasks among each other and accomplishing goals.

Since it can create hundreds of copies of itself, it has to maintain the activities of the virtual characters. Some virtual characters might have better solutions than other virtual characters or some virtual characters might be doing the wrong things. It's up to the robot to coordinate their activities. Another method is to create coordinators and put them into the time machine to manage all the virtual characters.

All virtual characters are simply referencing the pathways from the robot's brain in the real world. They aren't clones of the real robot, thus their work is considered the work of one entity: the robot in the real world. The digital image of the virtual character is only a shell and doesn't have a digital brain. Therefore, it isn't alive.

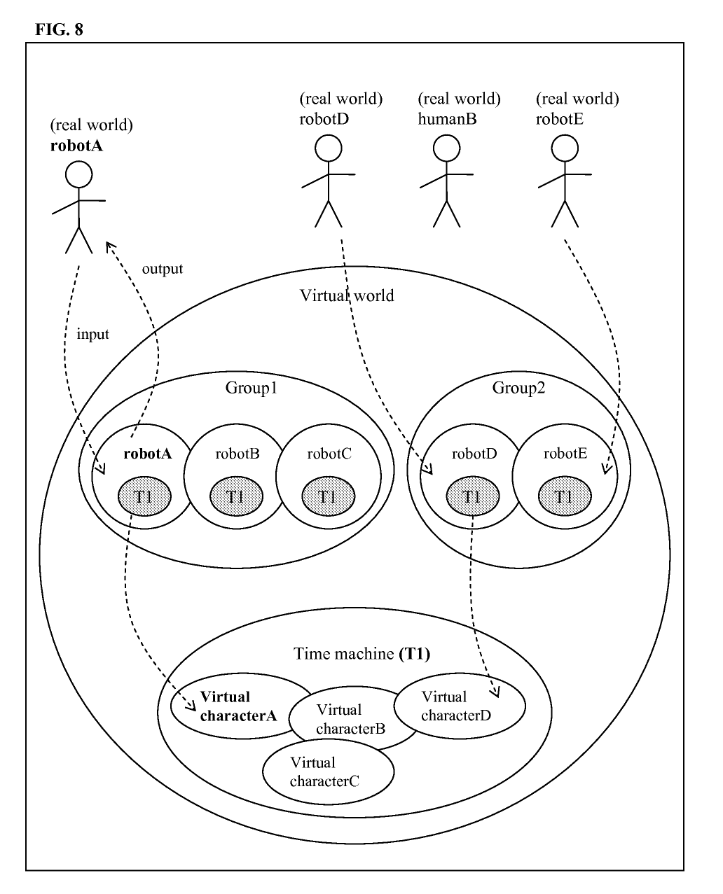

In addition to the many copies of the robot (robotA) in the time machine, there are pre-existing virtual characters from other robots also co-exiting in the same time machine dimension. They can also help in accomplishing tasks (referring to FIG. 8).

Encapsulated Work (or Hidden Instructions)

The AI for the time machine comprises pathways to do tasks. There are two worlds that must be addressed: the virtual world and the time machine world (FIG. 1). The virtual world encases the robot and the time machine. The robot has to use the time machine to extract specific information related to a problem being solved. The robot will determine a problem to solve, set the environment of the time machine, copy itself into the time machine as a virtual character and do work. When the virtual character finishes its task it will send the desired output to the robot in the virtual world and the virtual character will terminate itself.

The pathways from the virtual world are the “situation” and the pathways from the time machine are the “encapsulated work”. The situation will include input and desired output (or results), while the encapsulated work mainly include work done by the virtual characters and the desired output being transmitted to the robot in the virtual world.

The AI of the time machine is from the stored pathways of the virtual characters accomplishing certain tasks. These stored work serves as the AI for the time machine so the system can run in an efficient manner. For example, if the virtual characters have done certain work over and over again, then a universal pathway to accomplish that work is used instead of the virtual character redoing the same work. Only work that the AI time machine didn't do will be done manually, while work that has already been done numerous times will be done by pathways stored in the time machine brain.

FIG. 2 is a diagram depicting a virtual world brain and the time machine brain. The current pathway is inputted into the virtual world brain and the output is an optimal robot pathway. The robot is inside the virtual world, at this point, and the current pathway is a pathway exclusively in the virtual world—the current pathway is not a pathway in the real world or a pathway in the time machine. The optimal robot pathway will have relational links to work done by the virtual character (also a pathway).

By matching the best pathway from the virtual world brain, there are relationships to the pathways in the time machine brain. The pathways from the time machine brain is considered the “encapsulated work” and the pathway in the virtual world brain matched is considered the “situation”. When the situation is matched the encapsulated work (or hidden instructions) are automatically executed.

Sequence of Tasks

The robot in the virtual world and the virtual character in the time machine are intelligent at a human-level. They are also the same entity. Their pathways store both analytical and manipulation of external technology to accomplish tasks. In other words, they use technology and their intelligence to extract specific information. FIG. 8 is a diagram depicting how a virtual character uses technology and human intelligence to extract information.

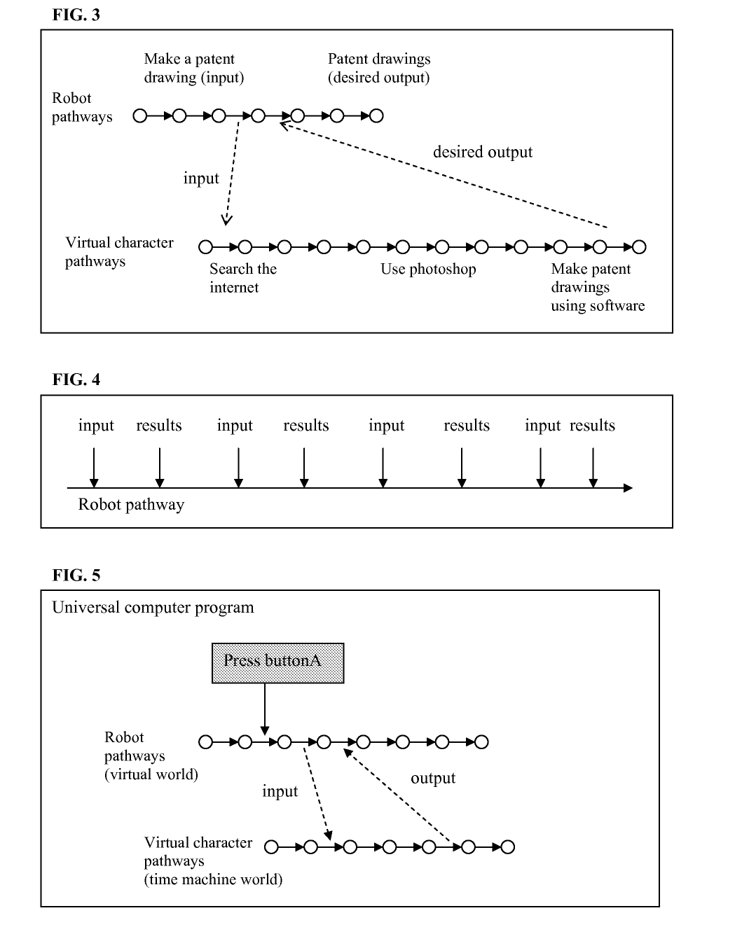

FIG. 3 depicts one task to be done. The input from the robot is to make a patent drawing. The desired output (or result) is the patent drawings done according to the robot's specification. The robot's pathways are considered the situation and the virtual character's pathways are considered the encapsulated work. As stated before, the robot and the virtual character is one entity. When the robot intentionally wants to do something, such as make patent drawings, it will copy itself into the time machine as the virtual character. This virtual character will have all the knowledge of the robot, including its current intentions and what its goals are in the time machine. Its main goal is to make patent drawings.

The virtual character knows exactly what it has to do. In the diagram, the virtual character uses multiple computer software to extract relevant information. In the first step it searches the internet for black and white pictures that fit the patent drawings. This is done using the virtual characters human-level intelligence. Next, it will use a photo software such as photoshop to fix the pictures found over the internet There might be some drawings that are too light, so the virtual character has to modify the contrast. Other times, the drawing might be too small and the virtual character has to scale the size according to patent rules. After the drawings are modified it will open up a patent software that will make patent drawings easier to create. The virtual character will make the drawing pages according to patent rules. After the desired output is finished, the virtual character will send the patent drawings to the robot in the virtual world. The patent drawings are considered the desired output. The virtual character will wait to see if the robot has any other task to be done or to question the desired output. For example, if the robot is disappointed with the patent drawings the robot can request the virtual character to modify some parts of the patent drawings.

FIG. 3 is only one task to be done. FIG. 4 depicts multiple sequences of tasks that must be done by the virtual characters. The robots input data and the virtual characters generate the results.

The software and technology they use to extract information can be similar to one another. For example, using internet explorer is similar to using netscape or firefox. Using the windows operating system is similar to using the Mac or Linux. The pathways from the virtual characters (or the robot) can be universalized to handle different types of software or technology and the same/similar information will be extracted.

The question about changes in software has to be addressed. What if the pathways were used to search for information on the internet in 1997 while using outdated search engine technology? Will the same pathway be able to search for information in 2008? The internet is a dynamic network of data that changes constantly. Information, websites, video contents, computer programs and so forth change over the internet as time passes. Even the search engines are completely different. The yahoo that existed in 1997 is totally different from the yahoo that exists in 2008. The pathways from the virtual character, if trained properly, should be able to handle the modified information over the internet. These pathways are universalized and go through self-organization, whereby universal instructions are used to search for specific type of data in a dynamic environment.

However, it is recommended that the virtual characters update itself and to create pathways in the time machine brain to adapt its knowledge to new technology and to find new and better methods of extracting information. It is also recommended that fixed computer programs be used in the virtual characters' pathways because this will generate more accurate results. For example, if the virtual character's pathway is using internet explorer, then internet explorer should be used instead of some browser that is different from the pathway. The more specific the computer programs that matches to the virtual characters' pathways the better (this would include universal pathways as well).

The virtual characters should also be up-to-date on searching the internet Pathways in 1997 should not be used to search for information over the internet in 2008. There should be pathways trained in the time machine brain that has search results for 2008. In fact, if you observe the HLAI program, new pathways build on previously learned pathways. What this means is that the new pathways can change and adapt previous pathways to the current environment. So, if the time machine brain trains pathways in 2008 to search for information over the internet, then previous pathways such as the pathways trained in 1997, can be adapted to search for information over the internet in 2008.

Robot's Pathways and Encapsulated Work

A method is needed to encapsulate work done by virtual characters and to assign it to a fixed interface function in a software, whereby other virtual characters can use the software to do their own work. This method is also known as the “universal computer program” because it encapsulates entire work and assigns it to fixed software functions. The user can simply use user-friendly interface functions to call the encapsulated work (or hidden instructions).

The universal computer program basically encapsulates work. It sets up the situation and the encapsulated work are linked to the situation. Just to give you an idea of how work is encapsulated, there are two factors: 1. the robot's pathways. 2. the universal computer program (FIG. 5).

In FIG. 5, the robot's pathway stores a dummy user interface button called “buttonA”. ButtonA is pressed and the robot will copy itself into the time machine world and it will do work. After finishing the work it will send the desired output to the robot in the virtual world. Thus, the idea is to trick the robot's pathways to include user interface functions (fixed) that will represent the “encapsulated work”.

This is a powerful method because, now, the robot can do work with the fixed software that was created previously, to further do other work. So work is encapsulated in a recursive manner.

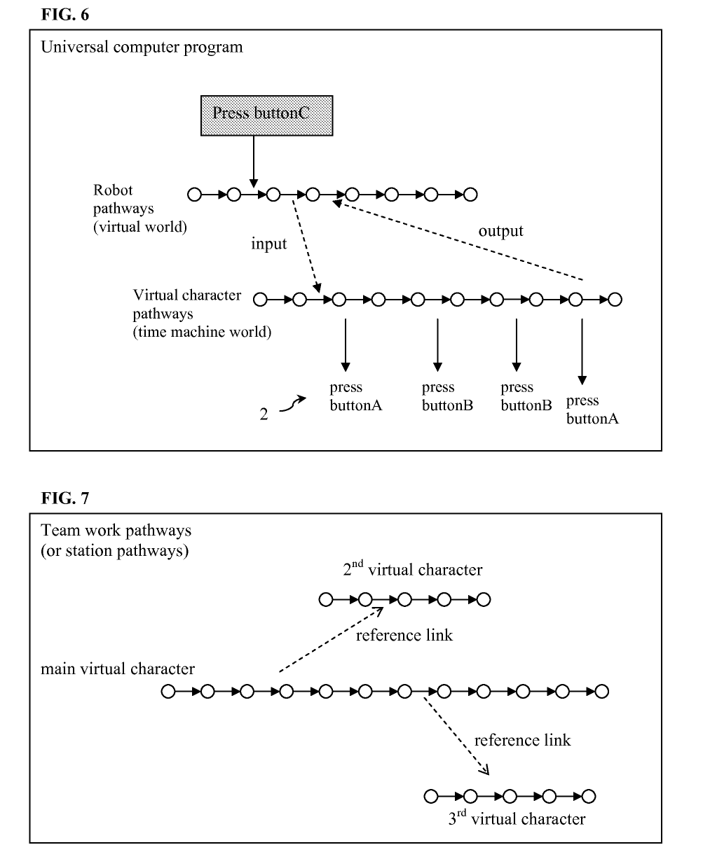

Let's just imagine that there are three tasks to do: A. build a software function to resize an image. B. build a software function to do one patent drawing. C. build a software function to write a patent. We have to use the universal computer program to assign fixed user buttons to each task. FIG. 6 is a diagram depicting three buttons: buttonA, buttonB and buttonC. The robot has to work on buttonA. It will trick the pathway and press buttonA, then it will copy itself as a virtual character to work on taskA. After it has done taskA it will send the desired output to the robot in the virtual world. Many similar examples have to be trained in order to universalize the desired output.

After this is done taskA is encapsulated and assigned to a fixed software buttonA. That means when a user presses buttonA, the encapsulated instructions will automatically execute. If the function has errors, the robot can always modify the function.

Now that buttonA is defined, we can move on to buttonB. ButtonB was designed to do one patent picture. The pathways from the virtual character will include all the steps that it has to do in order to accomplish the task. In taskB, the virtual character has to use buttonA in order to do some of the steps. For example, the virtual character might take a picture and it presses buttonA so that the picture can resize itself. Then the virtual character might do something else to the picture such as make the contrast of the picture darker. Essentially, the virtual character is using a pre-existing function (buttonA) to accomplish taskB.

Once taskB is assigned to buttonB using the universal computer program, we can move on to taskC. TaskC is to write a patent application. The same method will be used. The robot will copy itself as a virtual character to work on taskC. It will use buttonA and buttonB to accomplish some of the steps. In FIG. 6, pointer 2 is an illustration of this method. The robot's pathway is tricked in pressing buttonC, then the robot copy itself as a virtual character to do work. The virtual character uses buttonA and buttonB to do work. When the virtual character is finished doing taskC, it will send the desired output to the robot in the virtual world. The purpose of buttonC is to encapsulate work done by the virtual characters. The reference pointers, indicated by input and output, are the relationships between the robot pathway and the virtual character pathway. As stated before, many similar examples have to be trained before a universal pathway can be created.

The virtual character's pathway does the intelligent work. The virtual character is smart at a human-level and is able to do complex tasks. The universal computer program uses fixed interface functions to represent virtual character pathways.

The very interesting part about this is that the fixed interface functions are separate and independent from the virtual character's pathways. The virtual character pathways only store the pressing of the buttons and seeing the results, but none of the software instructions are ever stored in the virtual character's pathways.

There are several advantages to this method. One advantage is that the virtual character pathways can be used to work on similar software. If it was trained to work on internet explorer, the pathways can be used to work on netscape or firefox. If the pathways were trained to work on the windows operating system, it can be used to work on the Mac or Linux. The hidden instructions of each software are not stored in the virtual character pathways and are totally independent from each other. Only what the robot sees on the monitor and what the results of the software is will be stored.

The above is an easy example because this is only one robot involved in doing the encapsulated work. For a more complex situation, teams of robots must work together to accomplish tasks. Sometimes an entire government or business organization is needed to do things. During the self-organization phase, the AI will compare similar examples and come up with universal types of pathways. A stationary pathway comprises pathways from multiple virtual characters that work with each other to accomplish tasks. Pathways in the stationary pathways have relational links with each other.

Work that Requires a Team of Virtual Characters (Station Pathways)

Let's make the program a little more complex by including teams of virtual characters working to solve a problem or to accomplish a task. FIG. 7 is a diagram depicting the structure of how pathways are organized based on teams of virtual characters. The main virtual character is the primary entity that is being analyzed. This main virtual character contains majority of the pathway that will allow work to be done. For example, if a football team is playing, the main virtual character is the coach or the quarterback because they are primarily involved in the direction of the team. If a starship is being analyzed, the captain is the main virtual character because he/she commands the entire ship. The main virtual character can be anyone, even a minor person involved in solving a problem. It really depends on the problem that is being solved.

FIG. 7 is a diagram depicting a team of virtual characters working in the time machine as a group to accomplish a task or to solve a problem. The main virtual character is the primary pathway that is being followed. Any intelligent objects involved in producing results for the problem must be referenced. In this case, there are 2 other virtual characters that are involved in solving the problem: the 2^{nd} virtual character and 3^{rd} virtual character. Although these two intelligent objects play a minor role in the main virtual character's pathway their pathways create results that require human intelligence.

In turn, each one of the virtual characters can be the main virtual character. It depends on the problem being solved and who is being analyzed. The 3^{rd} virtual character can be the main virtual character and in his pathways are reference links to the 1^{st} and 2^{nd} virtual characters' respective pathways.

To complicate things even more “maybe” all intelligent and non-intelligent objects involved in the main virtual character's pathways have to be referenced. This would include things like machinery, or computers, or internet, or software, or search engines, or electronic devices and so forth.

Pathways represent the work done by virtual characters. Storing pathways and retrieving pathways to do work serve as the AI of the time machine. FIG. 7 is a diagram showing the hierarchical structure of work done by all virtual characters. If each virtual character is working using runtime intelligence, it would take up a lot of disk space and processing time. Each character has to be copied into the time machine and each has to have the necessary brain activities in order to think and sense. On the other hand, if we use my method, things can be done quicker and more efficiently. Instead of using virtual characters to do work we can use “their pathways” to do work. The idea is to extract one long continuous pathway for each virtual character and trick each pathway into thinking it has accomplished work. Each continuous pathway should have the minimum amount of possibilities—to use the minimum amount of universal and specific pathways. Each pathway should be universal and ambiguities or minor obstacles should be bypassed. Each pathway should also be tricked into believing they happened sequentially and relevant results are created.

Referring to FIG. 7, notice that each virtual character has only one pathway (or a few pathways) to represent their work. Each virtual character has no brain activity. The AI is simply taking pathways from the virtual characters and using one pathway per person to do team work. This technique will only work if the team work has a lot of similar examples trained.

2. Multiple Robots Working Together

In the last topic I described 1 robot. There are arbitrary amounts of robots in the virtual world. There can be 5 robots or 10 billion robots. Each robot can do a task, either by itself, in a team or in an organization. In FIG. 8, there are two groups of robots, group1 and group2. In group1 there are three robots and in group2 there are 2 robots. The task for both groups might be to predict the future. In group1, robotA, robotB and robotC are in a room where they can see each other. In group2, robotD and robotE are in a different room that is located 100 miles away from the first group. However, group1 and group2 are communicating through the internet in the virtual world.

Each robot also has access to the same time machine, which is represented by T1. This means that all robots are using the same time machine, but they are accessing T1 from different terminals. In some cases, robotA from the real world (or real human beings) can also access the time machine (T1). However, this is inefficient because robotA has to control and extract specific information from T1 in the real world.

A robot can extract information from the time machine and use the data to do their work or to share that data with other robots working on the same task. For example, in group 1, robotA might extract data from the time machine and decides to give this data to robotC so he can use the time machine to process the data further. RobotA can also send the data, via communication transmission, to group2 and let them process the data.

Regardless of what type of organization exist in the virtual world or how the robots work together to accomplish tasks, robotA is ultimately responsible for extracting information he thinks is relevant to his own goals. RobotA is an individual and decides what specific information to extract from the time machine.

The AI of the Time Machine

Work that are done by virtual characters are stored as pathways in the time machine brain. These pathways are used as the AI for the time machine so that the user of the time machine can do tasks not by creating virtual characters to do tasks, but by using pathways in the time machine brain. This method will prevent any repeated tasks done by virtual characters and to make the system more efficient.

As stated many times in my previous patent applications, there are three dimensions: the real world, the virtual world and the time machine; and each dimension have their own brain which stores their respective pathways. For more details on this subject matter refer to my previous patent applications.

The Internet and the Virtual World

The forms of communication between robots in the virtual world will have the same forms of communication in the real world: internet, telephone system, teleconferencing and so forth. The internet is a very important part of the virtual world because of several reasons. One reason is that the storage of data can expand by adding more computers and servers to the internet. This means that the storage space can run to infinite, depending on the amount of computers that can fit in space and time in the real world. The second reason is that the robots in the virtual world have to insert, modify, update and delete data in the quickest time possible. All information stored in the internet should be readily available to all users of the internet.

A very good example of why the internet is needed to synchronize all activities of the robots doing work in the virtual world is: predicting the future or past. Predicting the future requires enormous amounts of disk space. It also requires robots with human-level intelligence to actually generate the predictions. These robots have to work in a team like setting to do investigative work to predict the future or past. They also have to use the internet as a way to update their predictions in the quickest way possible so that everyone that is involved can have the latest and up-to-date information. For example, if a team of robots predicted eventA, then other robots can move on to predict other events.

In my previous books, I talk about the prediction internet. The prediction internet is specifically designed so that robots in the virtual world can predict the future or past with pinpoint accuracy. It has software and technology options that the robots can use to do their predictions as well as communicate their predictions with other robots doing similar predictions. There are AI software that also distributes prediction tasks to the appropriate groups and organizations in the virtual world. For example, it would be wrong to have an organization predict ocean events if they are specialized in predicting plants.

By having unlimited disk space and the ability for arbitrary robots (any number of users) to communicate information in the quickest way possible, extremely complex tasks can be accomplished.

Another advantage is the robots in the virtual world can be organized in any group, team, organization, administration, business, data structure and so forth, to accomplish tasks. The robots can be structured in a business setting that have workers organized in a hierarchical manner, whereby each worker have rules they must follow to do tasks. Even the structure of the United States can be used by the robots in the virtual world to accomplish tasks—in this case, the task is to govern a country.

Knowledge in the Time Machine

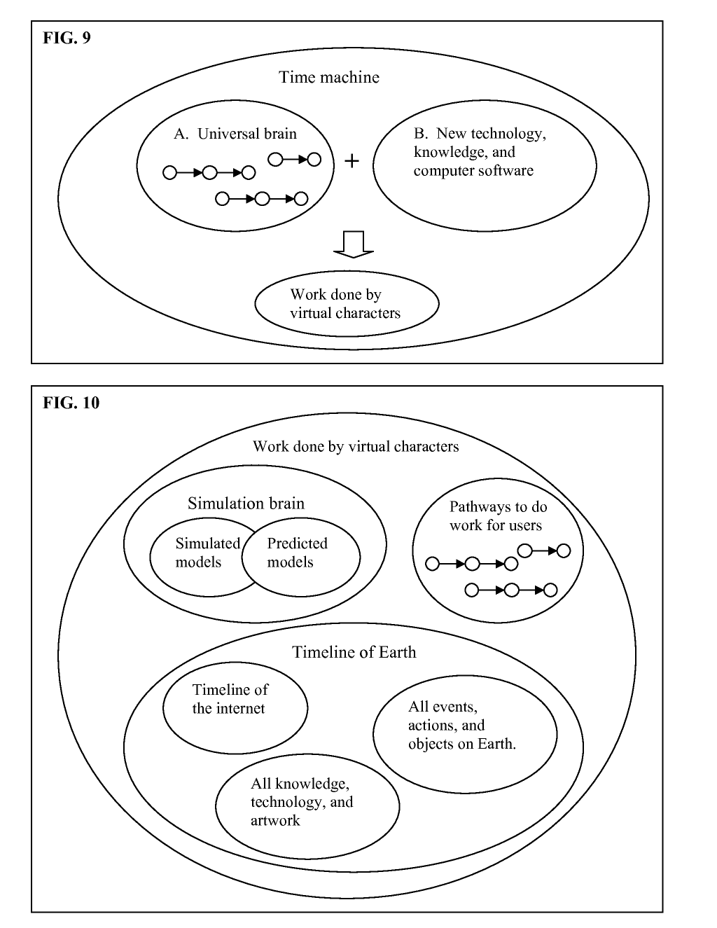

FIG. 9 is a diagram depicting the data structure of the time machine. The time machine is made up of two parts: 1. a universal brain that stores pathways from robots living in the real world. Any experiences (or pathways) each robot goes through are stored in the universal brain. Each robot can range from different types of species—they can be a human being, an animal, an insect or even a bacteria. 2. a 3-d environment where virtual characters can do work. When a robot copies itself into the time machine they are designated as a virtual character. Their job is to do work that the robot in the virtual world wants to do (do work based on self-choice).

These virtual characters will use information from the (A) universal brain and (B) new technology, knowledge, an emulated internet and computer software to do “work”. Work in this case can be “anything”. The virtual characters can: create a timeline of Earth, create a simulation brain, solve problems, answer questions, run a business, do research, find cures for various diseases, create better technology, write software, produce artwork or predict the future. Any “work” that one human or a group of humans can do these virtual characters can also do. Their work will be stored in pathways and stored in the time machine brain. These pathways make up the artificial intelligence of the time machine.

Referring to FIG. 10, the work done by the virtual characters are stored as pathways. One virtual character can do work and a pathway will represent that work. A group of virtual characters can do work and a series of linked pathways will represent that work. In the case of a group of virtual characters doing work, a main virtual character will be designated and reference pointers are established to each virtual character involved in the group work. Members in a business is one form of group work. They work together, sharing information and debating with each other to accomplish objectives of the business.

The virtual characters produce work and work can be any fixed tangible media. It can be a book, a digital file, a video, a software program or a research paper. These fixed tangible media are also stored in the time machine brain. Note the difference. Work by virtual characters are represented by pathways which are stored in the time machine brain; and their work creates fixed tangible media which is also stored in the time machine brain.

FIG. 10 also depicts some major work the virtual characters have to do. One is creating the perfect timeline of planet Earth. All events, actions and objects for Earth have to be recorded in a timeline for the past and the future. In order to do this, the virtual characters have to work in a prediction internet where they will input knowledge of what is known so far about events on Earth. Then they have to use new technology and past history to fill in all the missing pieces. Things that happened 100,000 years ago have to be predicted accurately. A single drop of water that existed 100,000 years ago has to be predicted, which includes predicting the exact movements of tiny organisms living in the drop of water.

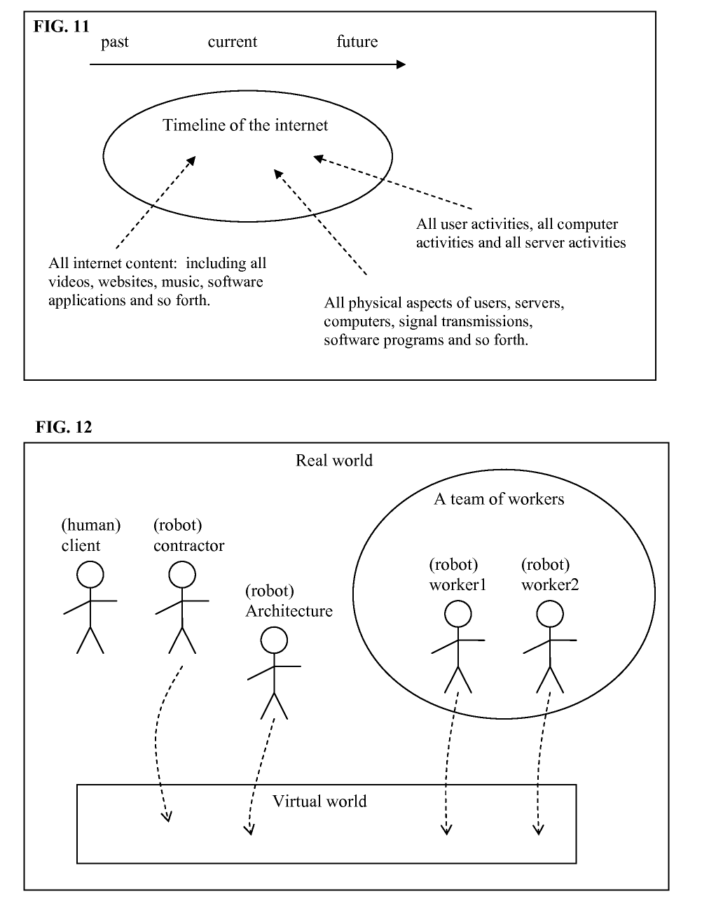

All knowledge that exists on any fixed tangible media has to be recorded in the timeline of when they were created and by whom. This would include all books, all artwork, all videos, all musics, all software programs, all machines, all knowledge that ever existed on Earth. Materials that are registered and available to the public, as well as, materials that are privately known are to be recorded in the timeline. Referring to FIG. 11, this timeline of Earth also include recording the timeline of the internet. Every single data that is stored over the internet and all machines involved that make up the internet have to be recorded in the timeline.

All internet content: including all videos, websites, music, chat data, telecommunication transmissions, credit card transactions, software applications and so forth will be recorded.

If a person owns a website and he frequently modifies content on his site, the timeline must record when and what they modified. The only way to do this is by predicting what this person has done in the past, and also, to predict what this person will do in the future. If you think about all the people who use the internet on a daily basis, all their activities must be recorded along with the activities of their computer and servers.

All physical aspects of users, servers, computers, signal transmissions, software programs, routing codes, security software, firewalls, wires, machinery, satellites, relay towers, landlines and so forth that allow the internet to operate also has to be recorded in the timeline. It's not just the data that is zipping through the internet that matters, but how these data are generated by machines.

FIG. 10 depicts the simulation brain, which stores simulated models of objects, actions and events on Earth. Each simulated model has 3 types of pathways: brain model, hardware data and software data. The virtual characters will be using the simulated models to predict how object/s behave in the past and future. The simulation brain is essential when it comes to creating the perfect timeline of Earth every fraction of a millisecond. The more work is done on the simulation brain the more accurate it will simulate an intelligent or non-intelligent object.

Simulated models are completed work and stored in the simulation brain to self-organize with other simulated models. This result in simulated model floaters that contains a fuzzy range related to one object, action or event. On the other hand, predicted models are work in progress. The virtual characters are still working on these models and they aren't stored in the simulation brain yet.

The timeline of Earth also records the advancement of knowledge and technology. Back in 1800, no one knew about Einstein's physic laws. In 1850, no one knew about computers. By predicting far into the future, the virtual characters can use the latest future technology to do work in the time machine. Imagine the year is 2006 and the virtual characters are able to predict 10 years into the future, 2016. They can use the technology that will exist in 2016 to do work.

The virtual characters can use any technology that exists today (or in the future) to do work in the time machine. They don't need to buy the software or the computer from a store, they can predict how it works and simulate and use that technology in the time machine. Instead of predicting the technology, they can get a copy from a store in the real world. The whole purpose of simulating all objects and events on planet Earth is to gather that knowledge from the real world via scanners or manual input; and to do work to fill in any missing data.

The virtual characters can also use any knowledge that currently exists today to do work in the time machine. Someone already invented the wheel. History books record how the wheel works. The virtual characters don't have to reinvent the wheel. Any fixed tangible media in the real world is potential knowledge. This includes books, research papers, diagrams, structured methods, videos, music, artwork, architecture, machines, electronic devices, computer files and so forth. The current knowledge is based on the most up-to-date books written on a given subject matter.

Machines that collect information on the Earth such as satellites, weather statistics, security cameras, sonar information from submarines, traffic statistics and so forth are also information that must be stored in the timeline as they occur in the real world.

The virtual characters using knowledge in the time machine to accomplish tasks. I was watching an episode of CSI on TV and had an insight that all of the investigators' work to catch criminals can be done in a virtual world. Well, at least most of the work they do. Tasks such as observing security cameras and extracting information can be done in the virtual world. Other tasks such as doing research on all the evidence gathered from the crime scene can also be done in the virtual world. Any task that are hard to do like gathering evidence from the crime scene or interrogating possible suspects has to be done in the real world using real time. Unless, suspects and crime scenes in the real world can be simulated in a virtual world, these things have to be done the long way.

The robots (or investigators) can agree to discuss and work as a team in the virtual world. For example, robotA and robotB can exist in the real world and they can collect evidence from the crime scene and ask possible suspects questions. They can then agree to enter the virtual world to do their research. They might run into problems and decide to question more witnesses in the real world. After gathering more information from the real world they can enter the virtual world again to resume their investigation.

The robots can decide and choose which tasks should be done in the virtual world and which tasks should be done in the real world. The idea is to minimize the time it takes to accomplish tasks in the real world and to maximize the time it takes to accomplish tasks in the virtual world. It would be optimal if all work for a task is done in the virtual world. However, in some cases, such as investigating a crime case, require work done specifically in the real world.

Capabilities of the Time Machine

The robots in the virtual world will each be using the time machine to do work. The AI in the time machine is generated by pathways from one or more virtual characters that have been universalized through self-organization. Repeated tasks done by one virtual character or a team of virtual characters are universalized and represented by universal pathways. This prevents any virtual character from doing task that has already been done numerous times. The robots in the virtual world use the time machine to accomplish tasks quickly.

Not only can the time machine predict the future and past with pinpoint accuracy, but it can also answer questions, search for information over the internet, operate a computer, operate different machines, do tasks, solve problems, follow commands, analyze a situation, compare complex situations, derive logical explanations or accomplish any “work” done by one or a group of human beings.

This time machine is the total package that serves as an AI search engine, an AI operating system, a prediction system, a knowledge gathering system, a problem solving system, a pattern recognition system, a universal AI system and so forth.

Among some of the things this time machine can do are:

1. Predict all events, actions and objects on planet Earth every fraction of a millisecond in the future and the past. The maximum prediction limit is 200-500 years into the future and billions of years into the past. This means that the time machine can predict, with pinpoint accuracy, up to the maximum prediction limits. It can predict beyond the maximum prediction limit, but the predictions won't be 100% accurate. Events that happened 10,000 years ago can be witnessed first hand—every frame of that event is recorded in the timeline of Earth. Events that will happen 100 years into the future can be witnessed first hand.

2. The time machine can have a past and future timeline of all contents on the internet. Since the time machine records all objects on planet Earth every fraction of a millisecond, the internet can be an object. Why would people want to search the current internet, when they can search data from the internet that existed in 1998 or the internet that will exist 10 years into the future? The time machine can also do analytical tasks, such as compare data between a website that existed in 1998 and the same website that existed in 2003. What is different about the two websites? What was changed? What was added, modified or deleted? An internet time machine is very important to things like court cases. Some technology companies might have engaged in criminal activities in the past and the only way to prove their guilt is by looking at the internet time machine.

3. Answer “any” question. How was the Earth created, how did the Universe develop, what happened to Amelia Eirheart, how did the Egyptians create the great pyramids, who are the authors of the bible? Extremely complex questions that require years of research can be answered. Simple questions that require basic internet searches can also be answered. If you have to find a definition on a word, simply ask the time machine. It will tell you what the definition is and to present it in a manner that is understood. If you want to know specific information from the internet, the time machine can do complex searches and present it to the user in a viewable manner.

4. Accomplish sequences of tasks. Searching for answers on the internet and our planet is one thing, but to take this knowledge and to produce logic from it is another thing. An AI search engine can search for knowledge over the internet based on the preferences of the user. For example, if the user wanted the time machine to search the internet for a black and white drawing of a rare species, the time machine might be able to find a set of drawings over the internet. The AI in the time machine will then convert a drawing from the set into a modified drawing using various photo software. This black and white drawing will be presented to the user. The user might complain about the drawing and require more specific things done to it. For example, the user might want the drawing to be clearer, the lines to be more defined and the drawing to be in a certain size. The time machine must accomplish these tasks sequentially based on the user's preferences.

5. Follow orders and to give opinions. The time machine will follow orders given by the user. If the time machine is given an order to search for information on the weather, then it will do as told. In some cases, the time machine will give its own opinions about things related to the situation that the user might not be aware of. The question about slavery pops up and certain sections in my books will explain how this slave issue is solved.

6. Accomplish work requiring one person or a team of people. The AI that will do “work” can be work accomplished by one person or a team of people. As the reader is well aware, work is done by the virtual characters inside the time machine. There can be 1 virtual character accomplishing tasks or there can be 50 virtual characters, structured as a team, to accomplish tasks. Curing cancer require a team of scientists specialized in different fields working together to find a cure, building software require a team of software engineers working together to write the codes, writing a book require a person to come up with the contents and solving a criminal case require many detectives, police person, and computer specialists working together to solve a crime.

Any type of work that requires human intelligence can be accomplished through the time machine. It doesn't matter if its research, producing an artwork, writing a book, writing software, making a movie, searching the internet, gathering knowledge, learning a skill, operating a computer, using software, managing a business, solving complex math problems, or making money through the stock market, the AI in the time machine can accomplish any work that can be done by one or more human beings.

Unfortunately “work” in this case is strictly limited to knowledge gathering and problem solving, which don't require moving physical objects in the real world. Any work should only be done in a virtual world because the user can accomplish tasks quickly. The virtual world is void of time because a computer can fast forward time. A 20 year task in the real world can be done in the virtual world in less than 5 seconds, depending on how fast the computer processor is.

Building a house in the real world will take up a lot of time, but building a house in a virtual world will take up little or no time at all. The objects in the real world can't move faster than the speed of light. The objects in the virtual world can break this law.

One possible solution to this problem is to simulate physical objects from the real world and to manipulate these objects in the virtual world. These simulations are done by scanners or predictions from robots. However, the down fall is that the simulation may not happen exactly to the event in the real world.

7. Controlling any machine and sharing intelligence by assumption. My first invention is the universal videogame program and that software can control any machine to act intelligently in our environment. I incorporated this invention with the time machine and added new features. The time machine is a host shell and it needs a physical body and user interface functions to communicate with a user. Different machines can be built as the time machines' physical body. The universal videogame program can be used to create pathways from a machine, regardless of what that machine physically looks like. The universal videogame program basically stores pathways that record arbitrary data from a given machine. A car will store different data compared to a plane.

The added feature is that intelligence can be shared among all the different AI machines. If a car learns how to plot routes, then the AI can use those intelligent pathways in a motorcycle. If a plane learns how to engage in a conversation with a co-pilot, then a car can use the intelligent pathways and engage in a conversation with a passenger. This added feature of sharing intelligent pathways will prevent relearning of knowledge and to make the universal videogame program more efficient.

Multiple robots working together in the real world and the virtual world

In the first topic I explained how one robot (robotA) is able to use the time machine and to extract information. A more complex situation is when multiple robots living in the real world work together, using the time machine, to accomplish tasks. FIG. 8 is a diagram of multiple robots, robotA, robotD and robotE, working together in the real world. These robots can also work with other real human beings. HumanB is a real human being in the real world and these robots have to understand that their work is based on time in the real world.

The future United States government is one example. Robot delegates that have the 6^{th} sense will have to work with human delegates to pass laws they think will benefit the US. Human delegates can't jump into the time machine to extract information because their brain is based on organic components. In other words, human beings can't use the virtual world to do tasks quickly.

This may sound inefficient, however, citizens of the United States are human beings or robots with 5 senses. They live in the real world and therefore laws that are passed should correlate with their time period. These robots can't pass laws that will benefit human beings in the distant future. Also, governments exist to serve the people. The people decide what laws should be passed or rejected. The government is simply there to propose possible laws. Representatives and senators “represent” regions of people and what they think about certain bills. Even the president should hear the voices of the people and pass or veto bills according to their mentality in real time.

Each robot (robotA, robotD and robotE) will have full control of which tasks should be done in the real world and which tasks should be done in the virtual world. Supervised learning in terms of input sequences and desired output will determine the “situation” and the “encapsulated work”. Supervised learning can also be used in conjunction with the universal computer program to provide applications in the time machine so that a user can harness the work done by one or a team of virtual characters. The universal computer program can only work if there are enough training examples stored in memory—similar work has to be learned numerous times, forming universal pathways. These universal pathways will form computer programs that will cater to certain tasks.

The purpose of each robot is to find a balance between the real world and the virtual world. They need to do as much tasks as possible in the virtual world and to minimize tasks done in the real world. The reason is to save time. However, they also have to understand that certain tasks can't be done without other dependable tasks. For example, a team of robots have to build a house, the roof can't be built unless the foundation is built first. The house can't be painted unless the house is constructed first. So, even though certain tasks can be done in a virtual world, all tasks done by the team has to be synchronized. If a team of robots have to build a concrete floor, a mixing machine has to pour concrete on the floor first before the robots can shape the floor. The robots have to wait for the concrete to solidify before they can build the foundation of the house. Thus, robots have to wait their turn to do certain tasks. A manager is there to coordinate the team so that the job is done in an efficient manner.

One way to synchronize the activities of each robot is through books. People who build houses have to go through years of college and to understand the steps and procedures. When a robot has enough knowledge then he can devote certain tasks to the real world and other tasks to the virtual world. Handbooks about what tasks should be done in the virtual world and the real world can be created for any given task. A handbook on brain surgery has different procedures compared to a handbook on building a house. Just like all knowledge books, these books will go through trial and error to find out which are the most effective ways for these robots to do tasks.

Three examples will be given to illustrate my point about teams of robots working together in a dynamic environment; and how these robots work in an optimal manner.

Building a House Example

The first example will illustrate teams of workers that will build houses or bridges. When a client decides to build a house, they have to contact a contractor (FIG. 12). The contractor will have agencies at his disposal to hire the necessary people to accomplish the task of building a house. First, an architecture must be hired to draft the house. This architecture will meet with the client to work out the blueprint. After the blueprint of the house is finalized the contractor will hire a team of construction workers to build the house. Within the construction workers is a hierarchical structured team of people who are specialized in certain fields. For example, the leader will coordinate tasks to individual workers and the supervisors check to make sure certain workers are performing their tasks correctly.

The people involved in building the house can be human beings or robots. In this case, the client is a human being and the rest of the builders are robots (for simplicity purposes). The architecture is a robot and the contractor is a robot. All people involved are living in the real world; only robots with the 6^{th} sense are able to utilize the virtual world.

The purpose of the team of robots is to build the house in the fastest time possible and to follow the descriptions given by the client. The satisfaction of the client is the main goal as well. If the client wanted something at the beginning, but the end result was a disappointment, then the robots didn't do a very good job, even if they followed every description given by the client. I will be discussing interruptions and problems that will emerge when doing tasks in later examples. For instance, the architecture's blueprint might be wrong and the construction workers will notify the architecture to correct the problem. Maybe, the client decides to change certain aspects of the house during the building phase? These interruptions happen and they need to be either dealt with in a quick manner or minimized.

The robots with the 6^{th} sense (controlling the virtual world) have two options in order to do their tasks efficiently: 1. follow instructions in books describing what tasks to do in the real world or in the virtual world. 2. use its own judgments, based on certain limitations set by common knowledge, to decide which tasks should be done in the real world and which tasks should be done in the virtual world. A process of trial and error is needed to write books that will instruct robots to optimize their work. Years and years of building houses are needed in order to understand the best options workers need to do to build a house in the quickest time possible—in the case of these robot workers, which tasks should be done in the virtual world and which tasks should be done in the real world.

People, robot or humans, can also arrange a place and time to meet and discuss project affairs. The word “place” is referring to the real world or the virtual world. The human client can arrange to meet the contractor in the real world. The contractor and the architecture, which are robots, can meet in the virtual world to discuss business. The contractor and the architecture can also meet in the real world to make sure the physical house is built correctly. The house can be simulated in the virtual world, so they can actually meet in the virtual world to analyze and discuss any potential problems.

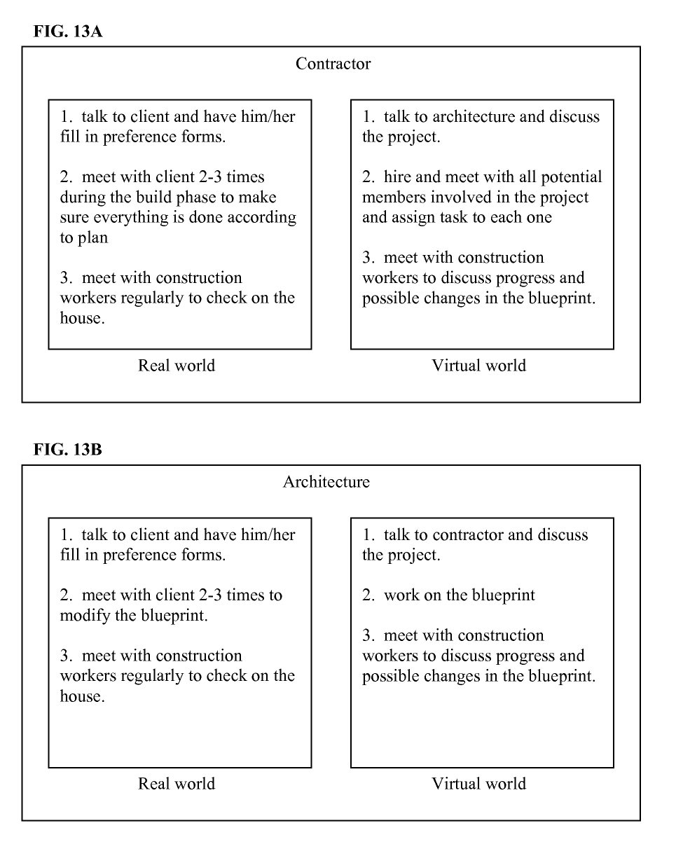

FIG. 13A-B are two diagrams depicting the contractor and the architecture and what tasks they will do in the real world and the virtual world. When the client goes to the contractor to build a house, they will discuss the project in detail. The client will have to take home a series of forms to fill out and a program is given to the client to describe what kind of home he/she wants to build. The client will give the contractor the description of the house and all specifications. The contractor will take this information and enter the virtual world, wherein he will analyze the information, hire the necessary workers and do research related to the project (this saves time).

While the contractor is inside the virtual world, he can hire robots in the real world. Robots in the real world submit their resumes in the internet and robots in the virtual world can hire them. The contractor can hire workers and arrange a meeting in the virtual world to discuss the specification of the project. He can also assign each worker their tasks. If the project is large the contractor can tell supervisors to do certain tasks and it's up to each supervisor to distribute tasks to their respective workers.

The process of: doing research on a project, having the architecture create a blueprint, hiring construction workers, and distributing instructions to the team of construction workers, took less than 1 second to accomplish because everything was done inside a virtual world. Since all these tasks are done in the virtual world, it has to be clear to the client that once a contract is signed that he/she can't take it back and must follow the terms specified in the contract. The reason why is because after the contract is signed 1 second later the job is done. The only task left is building the physical house.

It is very important to understand the time difference between the real world and the virtual world. There has to be laws and limitations set forth for robots with the 6^{th} sense. There should be some tasks that need permission in order to do. Building a bomb that will vaporize the entire universe is an obvious task that is forbidden. In terms of building houses, a team of real construction workers, at an average, spends 5 months building a single house. If we use these robots, the work can be narrowed down to less than a week. Changing the blueprint of the house during the 5 months is easy, but trying to change the blueprint in 1 week is a little harder. The client has to understand that tasks are done faster and that once they agree to something it can't be changed.

There can be common rules that can be set up in which during certain spaced out phases of a project, the client is able to see how the house will look like. During each check phase, the contractor can suspend all team activities and allow the client to see the progress of the construction. Using methods like a virtual tour at the beginning of the project is recommended. Now, a more advance way is to manipulate objects in the real world using light speed. Instead of 5 months or 1 week to build a house, the house can be built in less than 1 minute. This technology would include using atom manipulators that will position atoms quickly and efficiently or change an atom from one type to another type.

These dynamic robots can work at the speed of light to manipulate physical objects using new technology. They can do tasks in a virtual world as well. So, with both factors working together, the robots are able to accomplish “any” task in the quickest way possible. In other words, there is no other “faster” way of accomplishing these tasks. This is one of the reasons why I call this technology: dynamic efficient robots.

By building robots that can think faster and have special capabilities of moving objects in the environment faster, tasks in the real world can be done in an efficient manner. Human beings think slowly and they act slowly as well. If a gun was fired at a human being, they are not quick enough to move out of the bullet's pathway. On the other hand, when a gun is fired at these robots, they are able to observe every fraction of a nanosecond of the bullet being discharged and they have more than enough time to move out of the bullets pathway. If these dynamic robots were to have the 6^{th} sense, they can do miracles in the real world. They can run into a classroom and out of the classroom without being detected.

Sewing Factory Example

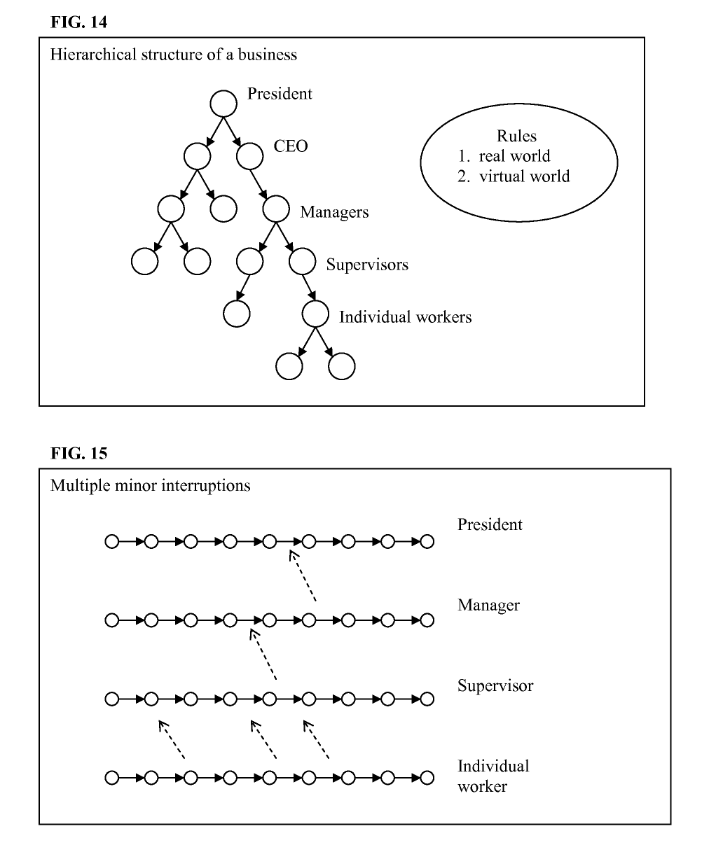

In terms of a business environment (sewing business), workers are structured in a hierarchical manner and one business can have partnerships with any number of other businesses (FIG. 14). In terms of robots with the 6^{th} sense, each has to obey common rules that are set for them in text books. These common rules are known to CEOs, managers, business people, workers, supervisors and anyone involved in the daily operations of a business. These rules will be used to determine what tasks can and can't be done in the virtual world. They are also strategies to optimize how a business operates in an age where robots are involved in their business.

For sewing factories, certain tasks are done in the real world and other tasks are done in the virtual world. The actual making of the clothing has to be done in the real world. Things like planning business strategies, creating the design of the clothing, conducting business deals, holding meetings, researching the cheapest fabrics can all be done in the virtual world.

Business Interruptions

The company should work as a team and any problems that arise should be dealt with immediately so that it doesn't disrupt future business activities. Because the business is structured in a hierarchical manner, the disruption can happen at any level. A small group of team in the lower level might run into problems and the supervisor might assist in solving the problem. However, if a manager engages in illegal activities such as hiring illegal workers, then the entire company will be in jeopardy. This interruption must be told to the highest representative of the business, the president. He/she will decide what course of action to take.

FIG. 15 is a diagram depicting how the interruption will be handled up the hierarchical tree. The individual worker will notify his supervisor and the supervisor will notify the manager and the manager will notify the president.

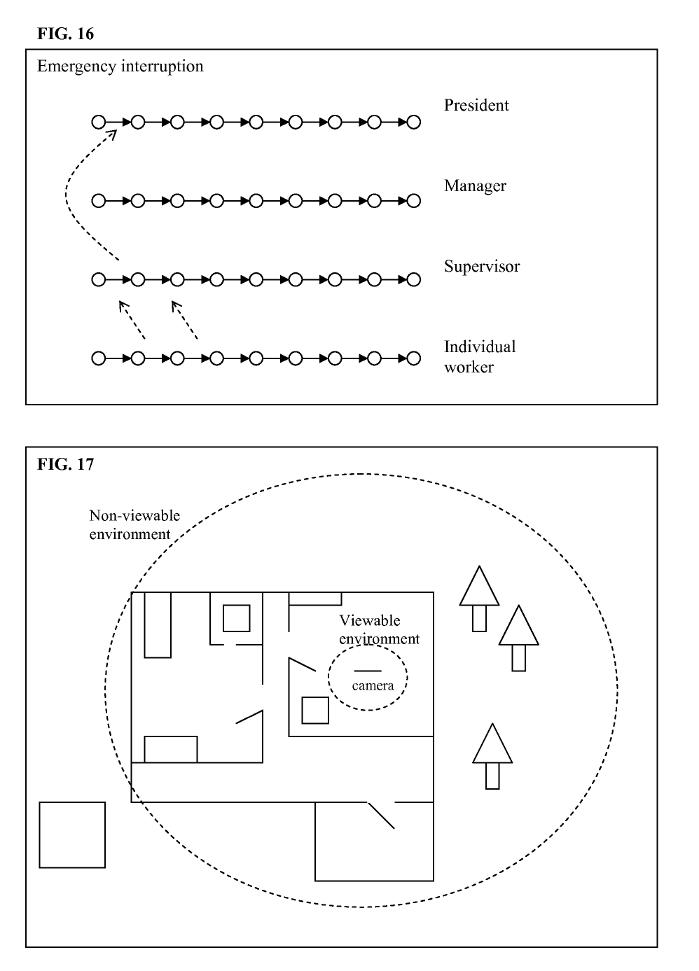

FIG. 16 is a diagram depicting how the interruption will be handled in the case of an emergency. The individual worker will directly notify the president. There are laws that are set up in terms of how the business is run and each employee is aware of their roles. In the case of an emergency, each worker will notify the president. For example, if the individual worker sells a product to a customer and the customer dies from using the product and family members decides to sue the company, then this situation will be presented to the president.

Let's present an example of an interruption in a sewing factory. Sometimes, under rare conditions, a supervisor might interpret the manager's instructions incorrectly. The workers might have already finished 50 clothing before the mistake has been detected. The manager finds out and orders the supervisor to correct the problem. This will stop operation for the entire factory and all workers have to work together to fix the problem. When there is a mistake they order individual workers to dig out every needle thread from the mistake areas for all copies incorrectly made. Then they have to give these modified copies to the appropriate sewers to correct the mistake. Other times, the mistake is so badly made that the copies mistakenly done are thrown away.

If we apply the interruption problem to dynamic robots working in a sewing factory, sections of the sewing factory will come to a screeching halt, depending on what the interruption is. The manager might stop all workers, human or robot, and inform members of the company in the real world and the virtual world to stop all activities until this problem is resolved.

I think that there should be some kind of “plan” of operations that synchronize all activities in the real world and the virtual world. If there is an interruption, sections of the business, should stop all activities. The manager or high officials will go into the virtual world and modify the plan to resolve the interruption and give new or modified instructions to all workers.

Another idea is that if there is an interruption, a virtual business meeting will take place where all workers have to attend and discuss ways to solve the problem. Then certain workers can modify the “plan” and distribute instructions to individual workers hierarchically.

I realize that what I'm stating sounds a lot like regular knowledge from business school. However, I'm including robot workers and workers that can do tasks in a virtual world and not the real world. I'm trying to apply my technology into modern business and to make the business as optimal as possible. For example, in modern business, when there is an interruption, the manager will immediately hold an executive meeting, where high officials will debate what the best possible solutions are to resolve the problem. If this is done in the real world it will take hours, if not, days to resolve. In my methods, high officials (most of them will be robots) will hold the debate inside the virtual world. Instead of hours or days to resolve, the debate will take less than a second and each worker will have the instructions it needs in order to correct the interruption and to resume business.

Referring to FIG. 14, the rules that are part of a business should be understood by all robot employees. They decide how a robot should accomplish tasks (in the real world or virtual world). There are rules that are strongly followed as well as rules that are versatile. There should be sets of rules that are written to give individual workers freedom to decide how they will accomplish tasks. In other words, they can pick which tasks should be done in the virtual world and which tasks should be done in the real world.

These rules also outline the structure of the business such as regular meetings and check-ups and interruption problems and so forth, not just for the real world, but also for the virtual world. Laws are written for a business under many situations so that members of the business know how to act, what their objectives are, and what powers they claim. These rules of business can also adapt to technological advances. For example, business meetings in the old days require members to meet at a certain location and it takes time for all members to meet at certain places. However, because we have teleconferencing, members of a business can attend the meeting anywhere in the world. The business world adapts to technological and social changes and business people are aware of the changes by either communicating with each other or by reading business books.

Multiple robots must work together in order to create the perfect timeline of planet Earth. This timeline records all objects, events and actions. The next problem is: how do the robots collect information from the environment? Every atom, electron and em radiation has to be tracked from the environment and this process has to be done in the quickest time possible. The signalless technology is the tool used to track all objects in the current environment and input that information into the timeline. This process has to be done quickly. The signalless technology has to track every single atom, electron and em radiation as it occurs in the current environment. The signalless technology will be explained in the next section.

3. Signalless Technology (One Camera)

Imagine a criminal that is hiding in a city somewhere and he is making a video of himself telling the police ransom demands. The video can be analyzed using artificial intelligence to fabricate a probable 3-d environment of objects outside the video. It doesn't matter if this criminal is locked inside a room with one window or the room is blocked off with curtains. As long as there exist air and as long as there is sunlight and EM radiation bouncing off objects, the method described in my signalless technology book should be able to create a 1 mile radius of all objects centered around the video.

Thus, the input is the video of the criminal and the desired output is the 3-d environment of the surround areas outside the video. FIG. 17 is a diagram depicting a camera as the input media and the 3-d environment as the desired output. The 3-d objects in the camera are known as the viewable environment and the 3-d objects outside the camera are known as the non-viewable environment. The purpose of this technology is to generate the non-viewable environment based on the viewable environment. The more objects that can be created in the non-viewable environment the better the technology.

I call this technology signalless technology because someone can know what is happening in distant places without transmitting any signals (all spectrum of EM radiation). If two people have the same type of signalless technology and they have a common communication language, they can exchange messages with each other.

5 Steps to Generate the Non-Viewable Environment

The instructions for the signalless technology come from virtual character pathways that use human intelligence and fixed software to do things. These virtual character pathways (work) are assigned to fixed interface functions in software. Essentially, this is how work is encapsulated recursively. This is also how the instructions in the software program for the signalless technology are not fixed, but it can build on itself and become more complex.

There are several instructional steps that the AI has to process from the video before it can generate the non-viewable environment. The steps are listed below in sequence order. A more detailed description of each step will be given in later sections of this chapter.

Step1: Determine all 3-d objects in the video and identify each EM radiation and their atom/molecule composition. The AI should also map out the time and the place the EM radiation hit the camera and what possible paths did each EM radiation travel. All matter, liquid and gas should be accounted for including air movements and air composition.

Step2: Determine all light sources, especially infrared light, and how each EM radiation bounces off objects in the environment. Determine wither each EM radiation was refracted or reflected. Use simulated models of EM radiation bounces and determine possible objects that were bounced from. Also, analyze wither light sources are artificially made (light bulb) or naturally made (sunlight).

Step3: Determine invisible light such as x-ray, ultraviolet ray, gamma rays. Next, determine man-made EM radiation such as radio waves, sonar waves, satellite signals and infrared signals. Then, identify what atoms/molecules/objects caused these EM radiations—did a machine create these EM radiations or was it naturally made from the environment. For man-made EM radiation, determine the signals within the EM radiation.

Step 4: Use human intelligence to help guide step1, step2 and step3. For example, in step2, reflective surfaces such as glass, mirrors, water, metal, eyes, and plastic can reflect light. A human can easily identify which objects or areas within the video are more likely to be reflective surfaces and they can prioritize their importance. A human being can logically analyze a video and say a good place to search is the mirror or the retina of a person or the metal box. Human intelligence is also good for deriving facts from the video. If a person sees a particular handbag, they can logically say that this handbag is made only in certain areas. This fact will narrow down where this particular video is made.

Step5: Layer out unknown EM radiations and place them into hierarchically structured groups. Try to identify the atom composition of each EM radiation and the path each took to get to the camera lenses. There might exist 2-3 EM radiations that will indicate probable locations where the video was shot. These EM radiation only exists in specific areas. For example, if you live in a desert, there are certain EM radiation in the air that is exclusive in that area compared to EM radiation found in another place like Alaska.

The idea is to take all the data in the video, regardless of how minor they may be, and to process them using human intelligence and sophisticated software. The main goal is to map out the non-viewable environment in a detailed and precise manner based on the contents in the video. The longer the radius of the non-viewable environment is the better. For example, 1 mile radius from the camera is a better output than 2 meter from the camera. In my opinion, the better the AI software to process the video and the more work that is put into analyzing the video the longer the radius of the non-viewable environment will be.

The Camera has 5 Senses

The modern camera was designed to capture visible light and things that humans can see. The camera I'm talking about captures more than simply visible light, it captures all spectrum of EM radiation ranging from ultraviolet to x-ray to visible light to infrared light. Even man-made EM radiation such as radio waves and satellite signals are captured by the camera.

In addition to things that we can see, the camera should also have other senses such as the sense of touch. It can record how hard the EM radiation hit the camera lens and at what angle. It is said in science books that all EM radiation, theoretically, travel at the speed of light in a vacuum. It is very hard for me to believe that an x-ray travels at the same speed as a purple colored light in a vacuum. X-rays have more photons and because it has more photons it should travel slower than a purple colored light. These two EM radiations aren't the same so they shouldn't behave the same way in a vacuum. Maybe at an extremely microscopic level they travel differently.

Let's say science is right and that “all” EM radiation travels at the speed of light in a vacuum, we still have many other factors that can distinguish one EM radiation from anther. An X-ray has a smaller wave length so it can cut through lots of objects in the air. The purple colored light has a longer wave length and it bounces off or gets absorbed by objects in the air. Thus, the X-ray travels faster than a purple colored light in open air. Using spectrum patterns we can also determine what kind of atoms/molecules emitted the EM radiation. Scientists use spectrum patterns to understand what kinds of atoms exist in far away planets.

The point I'm trying to make is that we can analyze EM radiation in a hierarchical manner, from general to specific, to determine (1) what atoms/molecules emitted the EM radiation and (2) what path did the EM radiation take to get to the camera lens.

Extra note: Most of my research is based on a rudimentary knowledge about physics and chemistry so if I say something that is wrong don't be surprised. I take what I know and I try to apply it to Artificial Intelligence.

The pathway of an EM radiation or a group of EM radiation is crucial because EM radiation bounces off objects in the environment. If we can determine its pathway we can determine the probable object it bounced off. The EM radiation serves as a sonar sensor that draws a picture of what 3-d objects are in the environment. The type of EM radiation is important because different EM radiation will have a different way of travel. Different EM radiation will also bounce of a same object differently. Some EM radiation actually gets absorbed by objects or they cut through certain objects. It really depends on what type of EM radiation is being analyzed.

The camera will also be a nose and it can smell the air. Seeing smoke is one thing, but smelling smoke is another. There are certain things that can't be seen in order to understand. Smell can sense what might be in the air. Things that can't be seen such as perfume, or food, or smoke, or flowers, or sewage and so forth should be sensed by the camera. This camera should have as much knowledge, based on 5 senses, about our environment.

Signalless Technology (Multiple Cameras)

We will use the technique from the previous section to create the signalless internet or signalless telephone system. One camera captures only one small area in the environment. In order to predict all matter, liquid, gas, particles and EM radiation, an army of cameras are used to capture data from the environment. In conventional cameras, only one view point can be seen. A special type of camera is needed. This special camera can see in 360 degree and captures EM radiation from all angles. This camera will be called: 360 degree camera. The 360 degree camera contains one camera in each angle and forms a spherical shape. The amount of clarity will depend on how many angles are designated for the 360 degree camera.

The 360 degree camera has to be big enough to capture as much EM radiation from the environment as possible, but small enough so that tampering of the environment will be brought to a minimal.

I would like to emphasize that the signalless technology doesn't predict the future or the past, it simply predicts the current state of the environment. Tampering with the environment is possible and the signalless technology will still work in predicting distant areas. On the other hand, predicting the past would require as little tampering as possible, so that the environment is preserved (I will not be discussing this issue in this patent application). The technology is only concerned with what is happening in far off places. The faster the signalless technology can predict what is currently happening in distant places the better. For example, if the signalless technology captures the local area using the 360 degree camera, the faster it predict events in far off places the better. If it can predict events in distant places in 1 millisecond, that would be better than predicting events in distant places in 5 seconds.

The signalless technology can also be built using current methods. Predicting the timeline of Earth for the distant past and future is much harder to build. The signalless technology doesn't require the AI to predict the future or the past, only the current state of the environment.

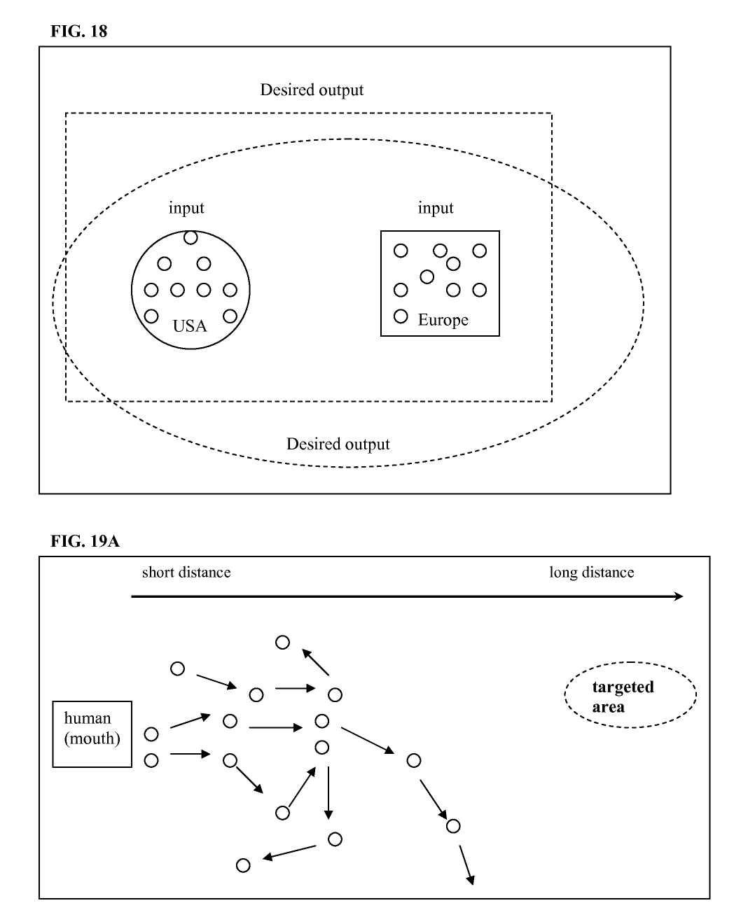

FIG. 18 is a diagram illustration for the signalless technology. 360 degree cameras will be set up in two distant places, USA and Europe. Each circle represents a camera and they are scattered in the USA and Europe. These camera data is considered the input and the AI has to generate the desired output which is to create a 3-d environment of non-viewable objects outside the input. The dotted circle is the desired output for the USA and the dotted square is the desired output for Europe. Notice that Europe can see everything that is happening in the USA and vice versa. This is the essence of the signalless technology. Since each party can see each other they can also communicate with each other as well.

Each input area records all information regarding the movements of all matter, liquid, gas, particles and EM radiations. The more accurate the input data the better the desired output. Sometimes information in the input area is not enough and the desired output can only be an estimation.

Signalless Technology Applied to the Practical Time Machine

The signalless technology is used to collect information and to track all atoms, electrons and em radiations from the environment in the quickest way possible. A high resolution camera can be used and it should map out the external and internal structures of objects. For example, if the camera was pointed at a human being, every atom inside the human being is mapped out. No x-ray machines are needed to see the internal atoms. The AI in the signalless technology is used instead, to fill in the missing pieces that the camera doesn't capture.

The Heisenberg theory states that it is impossible to know the movements of an electron around an atom. The timeline for Earth has to track all object movements, including electrons. The signalless technology uses virtual character pathways and the universal computer program to encapsulate their work. The universal computer program assigns fixed interface functions to virtual character pathways. The instructions for the signalless technology are non-fixed and have a bootstrapping process, whereby they build on previously learned instructions.

The method in which the signalless technology finds out how an electron orbits its nucleus is based on the simulation brain. The virtual characters have to analyze and observe simulated models of how atoms behave. They will use this data to “assume” where the electron is moving at any given moment (refer to my books to understand the details of this method).

4. Introduction to Atom Manipulators

The atom manipulator is a technology that “manipulates” atoms, electrons and EM radiations (for simplicity purposes this patent application will discuss only manipulation of atoms). The technology is made up of a laser system embedded inside a machine that tracks surrounding atoms and shoots beams of laser at them so they can bounce off other atoms to move things around.

A good analogy is pool. Think of atoms as balls on a pool table and the laser beam as the pool stick. The pool player has an objective to move certain balls to certain locations on the table. By using the pool stick and bouncing balls around, certain balls can move around and station themselves at certain locations on the pool table.

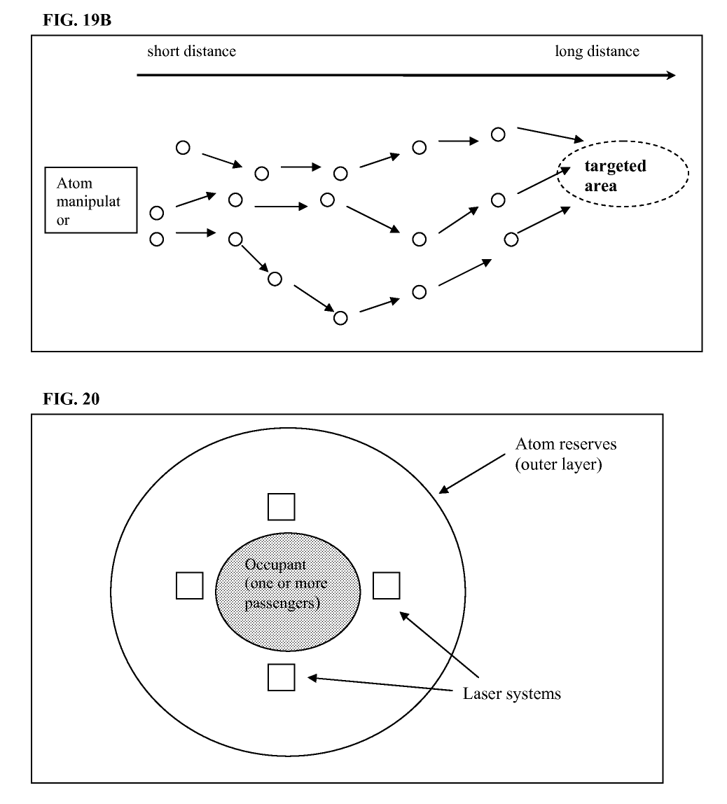

In the real world, atoms are not stored in a vacuum, but they move around, sometimes systematically and other times randomly. We live in a dynamic world where forces by intelligent and non-intelligent objects move atoms around. The idea is to use the laser system to shoot photons at surrounding atoms and these atoms will hit other atoms repeatedly until the targeted atoms are reached. If a person blows wind with his mouth, the wind can only affect close-by objects, while far away objects won't be affected. The reason why is because the force of wind sent by the mouth is not monitored atom by atom. FIGS. 19A and 19B are demonstrations of two examples of how wind affects distance objects. The first example shows a human being blowing wind with his mouth. Notice that the wind disperses quickly because the atoms are bouncing chaotically and away from the targeted area. In the second example, the atom manipulator shoots concentrated laser beams at atoms so they can either avoid other atoms or bounce atoms toward the targeted area. The second example shows that by tracking where each atom will be in the future, the atom manipulator can bounce atoms toward the targeted area and the energy that is used to shoot the laser beams from the atom manipulator are not wasted.

This is the basic idea behind the atom manipulator—to build a machine (a laser system) that will track surrounding atoms and to fire concentrated photons at atoms to either make them go to a target area or to bounce off other atoms to reach the targeted area.

How is this going to move physical objects in the real world? Well, wind can move objects around if there are enough forces involved. A small gust of wind can move objects in short distances, while strong wind like a tornado can move a car in long distances. It's about how much force is in the wind and where the force is being applied. The energy and the force are supplied by the laser system in the atom manipulator. The more lasers that hit atoms the more force is involved.

If you think about it, we can apply this technology to a number of different things. An anti-gravity machine can be built, whereby it has the capability of levitating any object (think of Star wars). We can make objects float in the air or move them around based on our preferences. These objects can weigh 5 ounces or 5 tons, the atom manipulator will simply apply enough force to certain areas to levitate these objects.

Another great feature of the atom manipulator is that it can be used to concentrate energy in an “intelligent way”. Since the AI can track all atoms, electrons and EM radiation, the laser can zap other electrons and force it to go in certain directions. The laser system will try to zap as much electrons from the environment and force it to travel to a targeted area. It can also generate its own electrons, so in addition to the electrons in the environment the atom manipulator can use its own power source. All energy will then travel toward the target area and be there at a specific time.

The laser beam can be controlled and can do anything that the user wants. It can make an explosion at certain areas at certain times. For example, if the atom manipulator is two yards away from a computer (or server), it can concentrate enough energy to explode targeted computer chips in the computer. The computer can be 50 miles away, the atom manipulator can still explode the chip in the computer.

Exploding a computer chip is just one function of the atom manipulator, it can also: stop the flow of power to certain areas of the computer, introduce certain external instructions, block gates inside computer chips, turn certain functions of software on or off by introducing external computer codes and so forth.

Essentially, the atom manipulator can control how a computer will behave in terms of software and hardware from a distance. If a computer was turned on and running the windows operating system, the atom manipulator can go into the monitor and use the pixels to super-impose a message on the screen. The message has nothing to do with the software. In another case, the atom manipulator can explode the power transformer and disable the hardware of the computer. It can also damage any targeted area of the computer in terms of hardware.

Other capabilities of the atom manipulator includes: building cars/planes that travel at the speed of light, building intelligent weapons, creating physical objects from thin air, using a chamber to manipulate objects, making objects invisible, building super powerful lasers, creating strong metals and alloys, creating the smallest computer chip, storing energy without any solar panels or wind turbines, making physical DNA, manipulating any object in the world and so forth.

Summary of the Atom Manipulator

The atom manipulator can be applied to many different machines. For simplicity purposes let's apply the atom manipulator to a plane. Using the methods I described above, this plane doesn't need wings or a propulsion system. Also, the plane can travel at the speed of light—which is the fastest plane that can be built. The plane will also have anti-gravity abilities and can float in the air, accelerate quickly, stop abruptly, maneuver around obstacles efficiently and so forth.

Some of my ideas might not be perfect, but I try to be as creative as possible. FIG. 20 is a diagram of this plane. The shape is basically a sphere so that it can travel in all directions equally. My original idea was a disk like shape (shapes of common UFOs), but it would be very hard to travel up or down because the top and bottom of the craft are flat. I decided to us a spherical-shaped plane instead. The occupants will be located in the center of the plane and there are various laser systems set up around the center. On the outer shell, there is a layer that contains moveable atoms in various types. The lasers can shoot some of these atoms out into the environment and let it bounce around to the targeted areas. I call this part the atom reserves layer. On the other hand, the laser can shoot at atoms that pre-exist in the environment.

The atom reserves layer contains different types of atoms that can be introduced into the environment so they can do things. For example, iron atoms can be used to form tools that can accomplish tasks. The plane can shoot lasers at the atom reserves layer to form an axe so that it can be used to chop trees or to form a knife to do surgery on a patient. When the axe is formed, the plane has to also manipulate the air so that the axe will move a certain way to chop a tree.

The atom reserves layer can also open up pockets of holes so that the laser can shoot out into the environment.

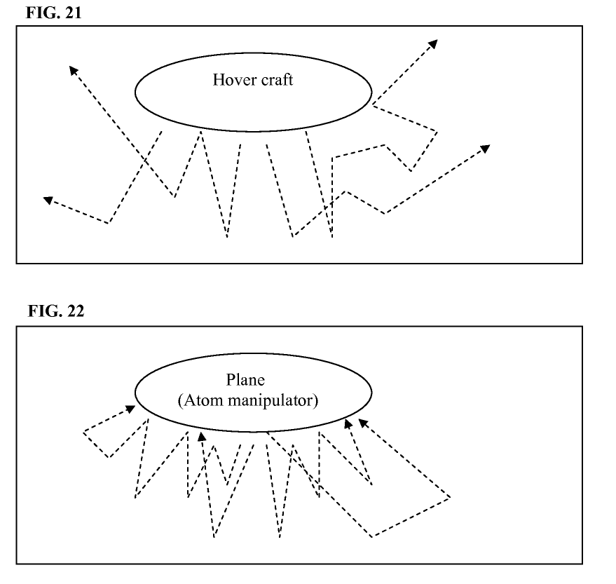

In order to fly, the plane has to manipulate the air in the environment and to push the plane in a certain direction with a certain force. If you look at conventional propulsion engines, they simply spin propellers and the force of the propellers pushes the plane in one direction. The force that pushes the plane in one direction has a lot of wasted energy. In order to understand this let's use a hover craft for example. Imagine that a hover craft has a propeller at the bottom that spins and the force of the spin pushes it upwards. Referring to FIG. 21, notice that most of the air is pushed out of the hover craft. The air that is pushed out is the wasted energy from the propeller.

In FIG. 22, the plane with the atom manipulator is different because all the energy from the laser system is used efficiently. Notice that atoms that bounce outside of the plane are bounced back in? This is how energy is conserved. In order to do this the atom manipulator has to know where all atoms are in the future and create bounces that will bounce any given atom back to push the plane. As stated before artificial intelligence is needed in order to build these types of planes.

The plane can move at any angle and it can slow down or accelerate. If the pilot wants to move the plane up then the laser system has to bounce atoms around the bottom of the plane. If the pilot wants to move the plane to the right then the laser system has manipulate the air to push the plane from the left.

Acceleration will be done gradually. If too much force is put on the plane at one time, the plane might we damaged. The pushing of air has to come gradually, slowly at first, and then as the plane moves, apply more and more force so it can speed up.

Planes that Travel at Light Speed

In order to travel at light speed, the plane has to travel in a vacuum. The atom manipulator can clear a pathway for the plane to travel before it moves. The atom manipulator in the plane must first create a pathway (a vacuum pathway) by putting up a force field around the pathway. The force field serves two purposes: it pushes air out and it prevents air from coming in. Then when the connection is met, the plane will accelerate itself to travel to the destination location. In later chapters I will discuss how the force field is created.

How does the Technology Work?

Let's discuss what is needed for the plane to operate correctly. The plane has to store pathways that have various data types such as sensed data, laser instructions, robot commands and so forth in order to operate the plane. The AI has to search for the pathways that best match a given situation; and use these pathways to instruct the laser system to shoot atoms in the environment.

This method is no different from a human robot searching for a pathway based on a given situation. The only difference is that “extra” data types have to be included in the pathways. We aren't dealing with simply one level of sensed data, we are dealing with many hierarchical levels of sensed data. For example, a human being can only see the environment using one type of visual frames. In this plane, the visual senses see in multiple levels of clarity. The plane will record visual senses in hierarchical levels. For example, the top-level visual environment has human visibility, and on the other hand, the bottom-level visual environment has microscopic visibility, whereby every atom is seen.

The visual frames will be 360 degrees and not the traditional 2-d frames used in human robots. In other words, the vision part will have the images of an object externally and internally.

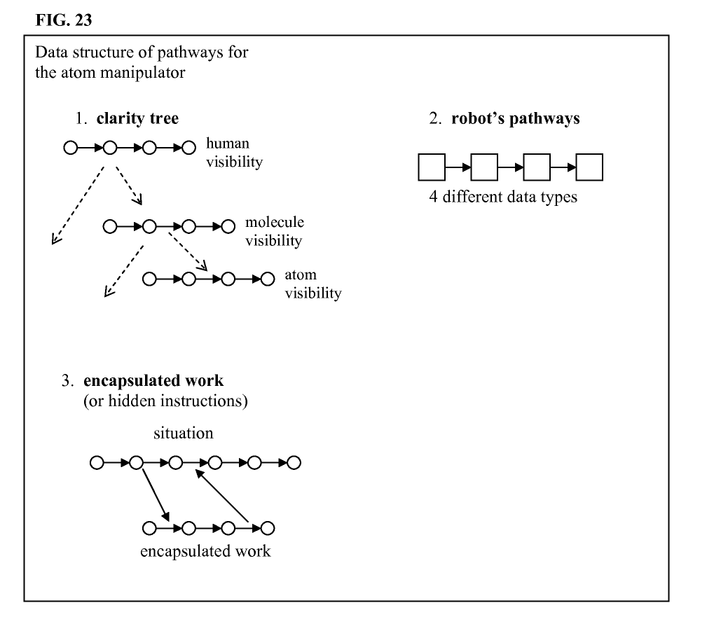

The brain of the atom manipulator (the plane) comprises pathways that store 3 data types: 1. the clarity tree. 2. the robot's pathways. 3. encapsulated work (or hidden instructions). FIG. 23 is a diagram depicting the data structure of the atom manipulator.

All three data types must have reference pointers to each other. The clarity tree is 3-d, but 3-d is derived from 2-d and since the robot's pathways are in 2-d, they will be referenced to the 3-d pathways from the clarity tree. For example, if the top level of the clarity tree is the environment around the plane and the robot's pathways is looking at one point of view of the environment, the 2-d pathways from the robot will lock onto the area it is seeing in the 3-d pathways.

The clarity tree is created from the signalless technology. Multiple cameras will be mounted on the plane's external shell and the information will be fed into an AI software called the signalless technology to generate a clarity tree. The signalless technology will take all information from the cameras and formulate what actually exist inside and outside the cameras. It uses artificial intelligence to map out all atoms, electrons and EM radiations from the environment.

With a detailed map of all atoms, electrons and em radiations from the environment, the signalless technology will generate different levels of clarity of the environment. These levels will be stored hierarchically from general to specific. FIG. 23 is an illustration of a clarity tree, whereby each level has a pathway with different clarity. At the top level is a 3-d pathway that has human visibility, at the medium level is a 3-d pathway that has molecule visibility and at the lowest level is a 3-d pathway that has atom visibility.

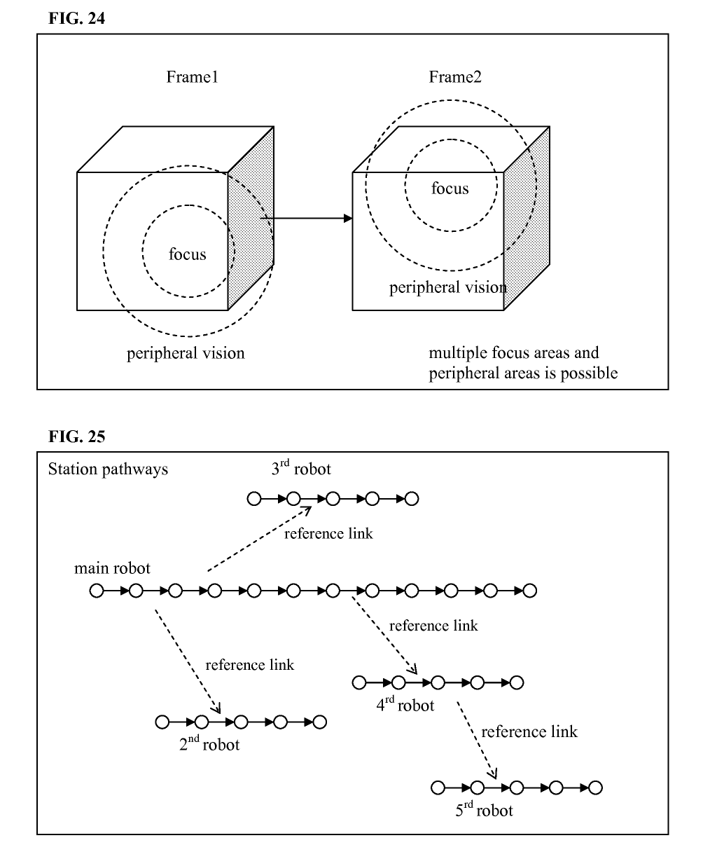

Referring to FIG. 24, each frame of the pathway is a snapshot of the environment in a 3-d manner, whereby there is a focus area and a peripheral area. The focused area is very detailed and clear, while the peripheral area is blurry and information are partially missing.

The robot's pathways are also stored in the pathways because the robot is controlling the plane and his actions and his thoughts should be stored with what is in the environment. The clarity tree is not based on what the robot is sensing. The clarity tree is extra data to help the pathways understand the environment. However, the robot's pathways and the clarity tree have relations in that the robot is controlling the plane based on the same environment.

Thus, the pathways store what the robot senses from the environment as well as what it doesn't sense from the environment.

The last data type is encapsulated work. Each robot has a 6^{th} sense that allows them to enter the virtual world to do work. The robot will create the instructions in how the laser system should operate based on many training examples. The robots will also build the interface functions that will link the controls of the plane to the hidden instructions accomplished by work done in the virtual world.

When the robot presses the acceleration button, there are instructions to accomplish this task. If the robot push on the breaks there are instructions to accomplish this task. If the robot turns the joystick to the right there has to be instructions to accomplish this task. By working in the virtual world, the robots can use technology and train the pathways to do certain things based on fixed controller or software interfaces.

Encapsulation of work means that the robots have to build certain functions and encapsulate these functions into other functions. For example, the functions at the atom level will be built first and the robot will encapsulate these functions into functions at the molecule level.

In the next section I will describe in detail how all three data types work.

Robot's Pathways and Encapsulated Work (Part1)

In the last section I talked about the clarity tree and how it works. In this section I will deal with the other two pathway types: robot's pathways and encapsulated work (or hidden instructions). I think that the last two pathway types have to be explained simultaneously instead of separately.

The robot's pathways are the data sensed from the robot while operating the plane. The thoughts of the robot are also stored in the pathway. The robot's pathway contains the 4 different data: 5 sense objects, hidden objects, activated element objects and pattern objects. Language is very important to intelligence because it brings order to a chaotic world. Life is dynamic and no one experiences the same situations twice. They can experience similar situations, but not the exact situations.

The robot controls the eyes and ears of the plane and makes decisions for the plane to act intelligently in the future. Commands are given by the robot to the different machines inside the plane to operate. The robot also identifies objects, set goals, solve conflicts of tasks, avoid obstacles, focus on objects, learn knowledge, apply knowledge, solve problems, give commands to other people and so forth.

The robot essentially is the brain that controls all aspect of intelligence for the plane. The clarity tree is there to help the robot understand the environment with greater detail. The clarity tree also provides data that the robot is and isn't aware off. For example, the robot is only aware of certain objects in the human visibility level, but it isn't aware of any objects in the atom visibility level.

A Team of Robots Working to Control the Plane

In Star Trek, there are multiple people that work together to control the plane. The captain gives the orders and the other people follow the instructions given by the captain. There might be a hierarchical structure of people working together. The captain might have a chief engineer that gives orders to lower level workers or a first officer that gives orders to other workers to handle secondary tasks.

Thus, in addition to the robot's pathways there can be many robots that are working together to operate the plane. If all these robot pathways self-organize, a station pathway is created. A station pathway is one universal pathway that contains multiple robot pathways that have relational links to one another. FIG. 25 is a diagram depicting a station pathway. There are 5 robots all together. The main robot is the leader or captain that decides how the plane will operate. The 4^{th} robot has its own worker that takes orders from only the 4^{th} robot.

Station pathways can be structured in any business or organization. A hierarchical structure of a business can be created and represented by a station pathway. A school administration system can be created and represented by a station pathway. Each member of the station pathway knows the rules, the objectives of the team and the powers of the team from common knowledge. These common knowledge can be found in books, or instruction manuals, etc. For example, a worker knows his own rules, powers, and objectives from business school. If the worker is the president of a company, he knows what powers he has and what rules other lower level workers must follow. The policy from the company will give a more definite guideline to behave in the company. This guideline should set the environment so that all members of the company know what rules to follow, know their status in the company, and what their objectives are.

Each member that is in the plane has their own responsibilities and duties. Each member is also intelligent at a human-level.

For simplicity purposes let's say that the plane was controlled by only one robot. All operations of the plane are commanded by a single robot.

Using language to organize data in the clarity tree

Language is the key to establishing more relationships between the clarity tree and the robot's pathways. The clarity tree has only commonality groups (by default), but it doesn't have any learned groups. The intelligence from the robot will give the objects in the clarity tree (especially the human visibility level) the ability of language. The robot will identify objects from activated element objects and these activated element objects serve as the learned groups. For example, in the human visibility level, if there is a cat that is identified, the pathway from the robot will identify that as the word: “cat”. This learned word “cat” identifies what the visual cat is in the clarity tree.

As stated numerous times in the past, a visual cat can come in different sizes, shapes and color. The learned word “cat” identifies the visual cat as one fixed word. A car accident can be presented in infinite ways, but the learned words “car accident” identifies that event into a fixed word/s.

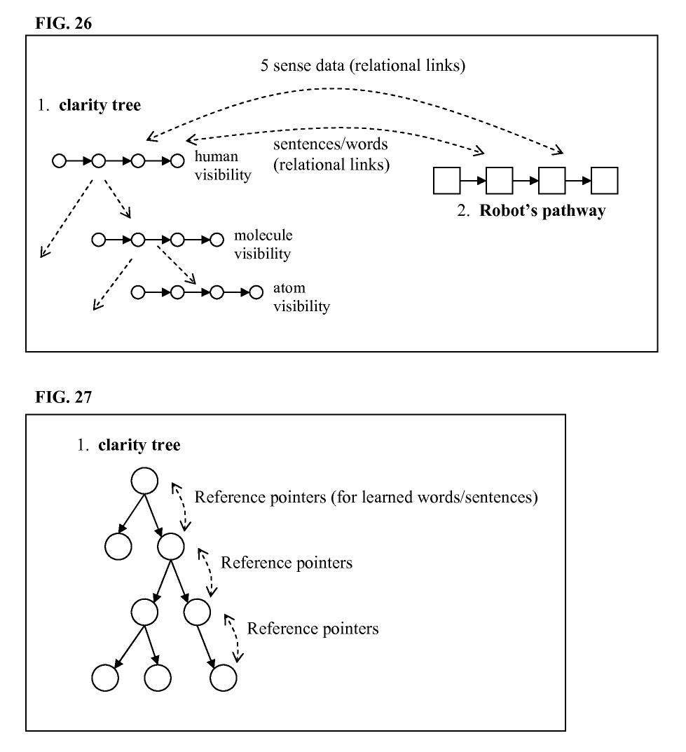

FIG. 26 is a diagram depicting the two relational links between the clarity tree and the robot's pathways. The human visibility level is referenced because that is the sight the robot sees. The 5 senses of the robot are referenced and the conscious thoughts of the robot are also referenced.

The interesting thing about the relational links between the robot's pathways and the clarity tree is that the clarity tree can reference words/sentences to its lower levels. FIG. 27 is a diagram depicting the learned words/sentences in the human visibility level are carried over to the molecule visibility level. Next, the learned words/sentences in the molecule visibility level are carried over to the atom visibility level. The robot's intelligence provides these learned words/sentences and identify and prioritize visual objects (or any other 5 sense data).

The encapsulated Work for the Plane

The universal computer program must be used to encapsulate work for the plane (atom manipulator). Creating a software to control how a laser system shoot photons at surrounding atoms and to make the atoms behave a certain way is very very difficult. My first computer program was the universal AI program which trains machines to do tasks with human visibility like drive a car, fly an airplane, mow the lawn, or vacuum the carpet. Building a machine to do things at an atomic level is infinitely harder.

The clarity tree is very valuable because work has to be done by different robots on all levels of the tree. Work must be done at the human visibility level, at the molecule visibility level, and at the atom visibility level. These work are not done by one robot, but by a hierarchically structured team of robots, each having their own responsibilities and duties.

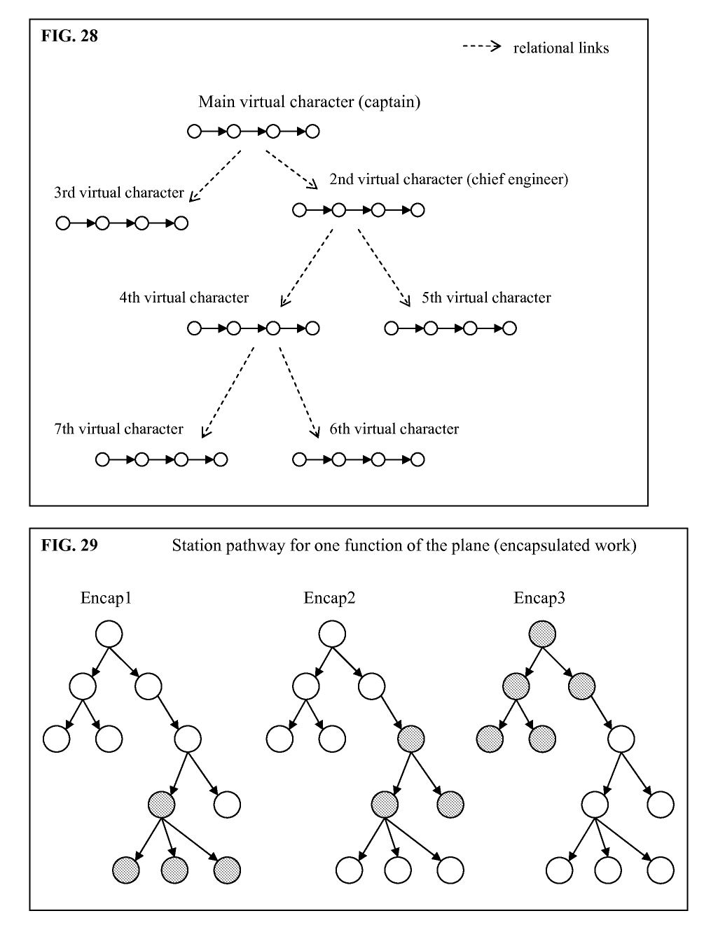

Also, work has to be done in fragmented sequences, whereby work is encapsulated in fixed interface functions so these fixed interface functions can be reused in the future. Think of one control function in the plane as a very long station pathway. All sections of the station pathway have to be trained, starting from the lower levels and working up towards the top levels. FIG. 28 is an illustration of one long station pathway to control one function for the plane. Multiple virtual characters, structured in a hierarchical manner, are working together to make this function work properly.

Since the station pathway can't be trained all at once, it is the job of each section of the station pathway to encapsulate their work using the universal computer program. FIG. 29 shows that each section has to be trained from the bottom first and then trained towards the top levels. It can't be trained from the top to the bottom because if encap3 was trained first the desired output will be wrong and further because encap3 needs encap2 and encap1.

However, when all sections of the station pathway are trained adequately, any section or combination of sections can be trained and each trained section will be stored in their respective areas. For example, if all sections in the station pathway are trained, encap3 or encap2 or encap1 or element combinations from each section can be trained.

The idea is to separate sections of the station pathways into independent sections. What sections in the station pathway should be grouped together independently and assigned to a fixed software function? People can do research and find the best groupings. These research are then put into books and should be widely read by people who are in the field. Of course these research methods don't have to be fixed; if other writers find a better method they can also replace the old method with newer methods.

TV Monitors to View Different Levels of the Clarity Tree

As stated before, the virtual characters have to do work on many different levels in the clarity tree. Each virtual character might have to manage multiple visibility levels in order to do work. The TV monitor is the media that will allow virtual characters to view different visibility levels in the clarity tree. Software will be included to switch from one level to the next or to view multiple visibility levels at the same time. For example, there can be two monitors. One monitor will display human visibility and the other monitor might display molecule visibility.

A hierarchical team structure is more complex. Let's say that there is a captain and he is in charge of 2 workers. The captain is viewing the environment using human visibility and the workers are viewing the environment using molecule visibility. The workers will do their jobs according to the commands given by the captain, but the captain isn't concerned with the molecule level, he is concerned with the overall human visibility level.

I will give another example to better illustrate my point. A captain is viewing the environment using human visibility. The captain has 1,000 workers that are controlling lasers that will shoot molecules and to force atoms to behave in a certain way. These workers are also assigned to certain areas of the environment. The workers are given orders to push atoms in their area toward a targeted location in the environment. These workers are not aware of how their job will affect the overall job of all workers. The captain's responsibility is to monitor what happens in the human visibility level and to use software to communicate with the lower level workers and give them instructions so that a desired goal is met.

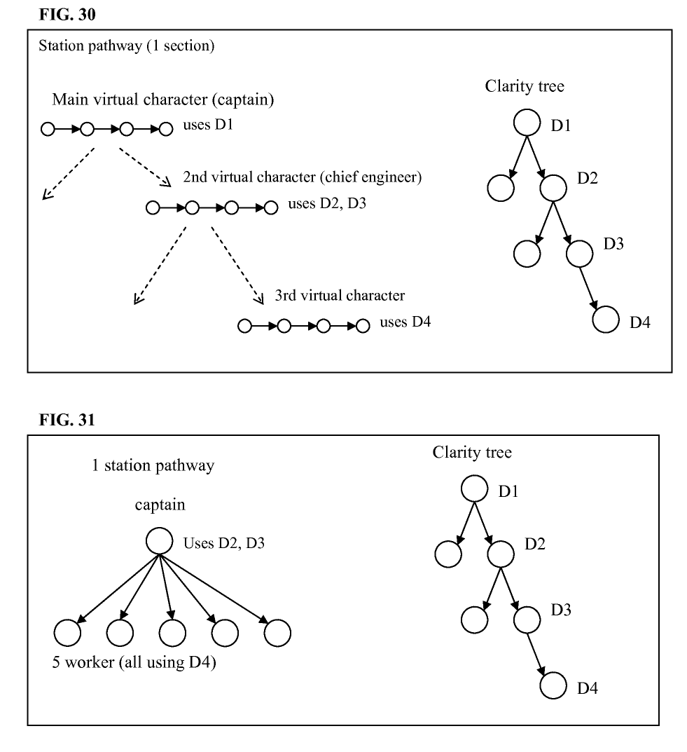

FIG. 30 is a diagram depicting a station pathway that is viewing different visibility levels in the clarity tree. The main virtual character is viewing D1, virtual character2 is viewing D2 and D3, and virtual character3 is viewing D4. They are working as a group using the data from the clarity tree.

Another very interesting note is that as each virtual character does work on the different clarity levels (D1-D4), the virtual character is identifying objects, actions and events. Sentences and words are assigned to objects/actions/events that are in the clarity tree via the virtual characters conscious thoughts.

Thus, the main robot that is controlling the actual plane is using its conscious to identify objects, actions and events in the human visibility level. On the other hand, the virtual characters who are working on the other lower visibility levels are also using their conscious to identifying objects, actions and events. Language in terms of sentences and words bring order to chaos. It will further help organize the data in the clarity tree. FIG. 27 shows that learned words/sentences from any level of the clarity will reference upper or lower levels. Just like how the robot controlling the plane has the ability to assign language to the human visibility level, the virtual robots can also assign language to the lower levels of the clarity tree. Commonality groups and learned groups will reference each other from different levels in the clarity tree.

Determining Visibility Levels in the Clarity Tree

The signalless technology creates the clarity tree. It will use the cameras on the plane to form a reasonable clarity tree. Another factor is the signalless technology will search in memory for any pathway matches to the current pathway. The pathway matches found in memory will further help to generate an optimal clarity tree. The pathways in memory self-organize and they are structured in terms of priority—the most important objects in a pathway are delineated and the least important objects are not delineated. By finding the best match in memory the pathway matched will tell the signalless technology which objects in the clarity tree are important and which objects in the clarity tree are not important. It will also determine how many levels to include in the clarity tree and what these levels are.

For example, in FIG. 30, D1, D2, D3, D4 are visibility levels that are used by virtual characters. They will be created based on how important they are to the team work. Maybe D1 is very important, so the signalless technology creates a detailed pathway for that level. Maybe D4 is the second most important level, so the signalless technology creates a medium detailed pathway for level D4.

How many levels the signalless technology will generate for the clarity tree will depend on what information is stored in memory. If there are lots of pathway matches found in memory, there will be many levels to the clarity tree. If there are little pathway matches found in memory, there will be small levels to the clarity tree. It's the same with human beings and how they learn things. When we search for a face in memory there are lots of information about faces so our brain have more detailed information about faces. When we search for fingerprints in memory there are little information about finger prints, so our brain have little information about fingerprints. Even though faces are very similar to one another we are able to recognize the details to distinguish one person from another. On the other hand, the fingerprint has little information in memory, and therefore a person can't recognize details on the fingerprint.

The more information that is stored in memory that matches to the current pathway (the current environment) the more visibility levels the clarity tree will have.

If there are little or no pathway matches found, the signalless technology will defaultly create its own visibility levels. It will learn from experience to find out which objects, actions or events in the clarity tree are important and it will adapt. The next time it encounters a similar situation it will know what to include in the clarity tree.

Other factors also determine how many levels to create in the clarity tree. Pain and pleasure felt by the virtual characters will prioritize objects. Which objects causes pain and which objects causes pleasure is very important to determine which objects/actions/events are important. For example, if a virtual character touches a needle, the pain will cause the virtual character to make the needle have higher priority because the needle caused great pain for the virtual character. While the virtual characters are working on the different levels of visibility, the pain/pleasure they feel will prioritize objects in the clarity tree.

Another important thing is where does the focus area begin and end should be based on what parts of the environment are important. And like I said before, the focus areas should be based on the pathways in memory. The signalless technology can also have a default focus area or a focus area depending on the cameras visibility. The signalless technology can also have software programs to create more information to be included in the clarity tree besides the information stored in pathways in memory. The clarity tree should provide “extra” information that the pathways in memory don't have.

Robot's Pathways and Encapsulated Work (Part3)

How exactly does the laser system of the plane know what atoms to hit and when to hit them? How does the plane train the laser system? These are just some of the questions we will be exploring in this section. The idea is to create complex encapsulated work and assign these encapsulated work to fixed software functions using the universal computer program. The laser system has to be aware of all visibility levels in the clarity tree and to train itself to recognize commands from a hierarchically structured team of virtual characters.

Encapsulated work is done by entire station pathways. Each station pathway has one or a team of virtual characters working together and there are relational links between virtual character interactions. In the last section we explored how encapsulated work can be trained in fragmented sections. The training starts from the bottom up, whereby work has to be encapsulated and assigned to fixed software functions using the universal computer program.

It's kind of hard to explain this process because the steps are so complex. I will be giving examples instead to illustrate this process.

Making Videogames to Train the Plane (Atom Manipulator)

A videogame is created to help the virtual characters to do their tasks and to communicate with higher level commanders. A videogame is set up, whereby the controls of the plane are linked to certain goals that are given to virtual characters. The videogame also has tools and software to help the virtual characters to accomplish their goals.

There are two points I want to make: 1. the videogame is created by virtual characters and can be modified. 2. the pathways of virtual character store the usage of the videogame. These two points are very important to understanding how work is encapsulated. FIG. 31 is a diagram depicting a captain and 5 lower level workers (all are virtual characters). The captain is the main virtual character and the workers are other virtual characters that follow the command and supervision of the captain.

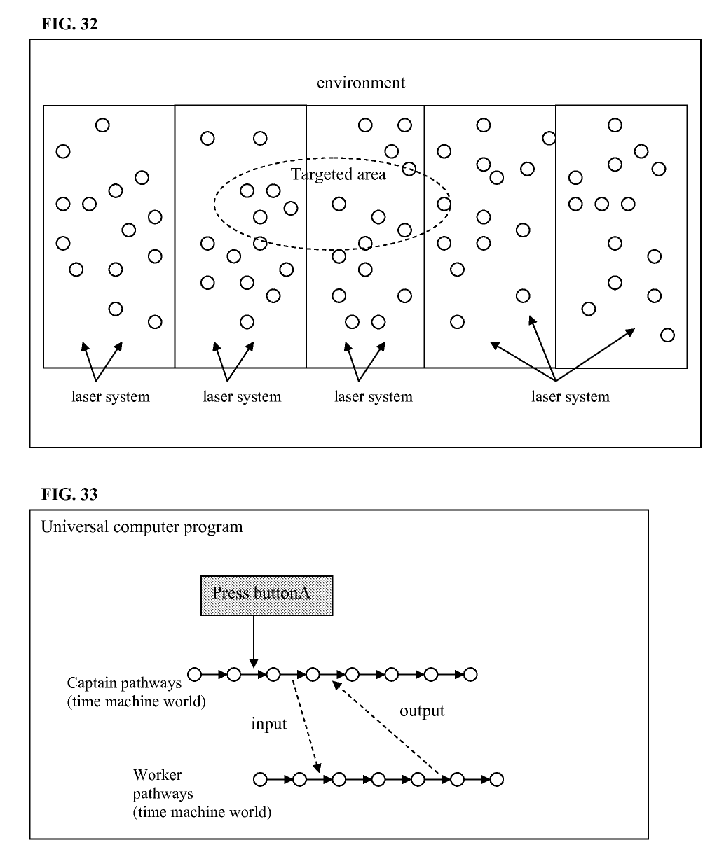

Each worker is assigned to certain areas of the environment. Usually, they are assigned to spaced out areas in the environment, each worker has to do tasks in their own boundary. Software in the videogame can manage interactions and conflicting problems. FIG. 32 depicts the current environment divided into 5 equally spaced out areas and each area is assigned to one worker. For simplicity purposes a simple example will be given. Imagine that there are 100 randomly scattered atoms in each area and these atoms don't move. The videogame is for the workers (players) to use a laser system to hit atoms so that a desired result will occur. The tasks are given to the workers by the captain via the videogame. Let's just say that the captain wants the workers to work together to move the atoms in the target area. The captain wants certain atoms in the targeted area to move at a certain speed and direction. The job of the workers is to play the game and to follow the rules and objectives of the captain.

The laser can shoot x amount of laser beams and each laser beam can be in any intensity. The workers have to set the coordinates of where to shoot the laser beams, how strong does the laser beams have to be, how many laser beams to shoot, and when to shoot the laser beams. Part of the videogame is to try something and if that strategy doesn't work then try another strategy. This trial and error process will loop itself until a desired result occurs.

This is where human intelligence is needed in order to play the videogame. Each worker is intelligent at a human level and they are able to receive commands from someone and to achieve these commands by using intelligence. In other words, the workers' pathways store how it thinks and senses while they play the videogame. The station pathways are the instructions to control the laser system in the plane to accomplish tasks.

This example is basically like the game of pool, where a player has to determine how hard to hit a ball and where to hit the ball so that the ball will bounce other balls around. The goals and rules of pool can be changed and the human player can still adapt to the game. The videogame for the laser system is no different.

Each worker can share laser systems or each can have their own laser system. In fact, the plane can have one laser system and all workers have to share resources. Software will determine what terminals of the laser system are given to what workers.

Building the videogame interface functions between the captain and the workers

The captain's pathway and the workers pathways don't have to be happening at the same time. The videogame can be set up to define tasks for workers and to let them submit the desire output. For example, the captain can be running at 1 millisecond per frame and the workers can be running at 1 nanosecond per frame. The captain will use the universal computer program and trick his pathways on clicking buttonA, then it will define what it wants the workers to do and what the desired output should be. As soon as the workers receive the instructions they will be hard at work trying to achieve the goals set by the captain. They can use the process of trial and error, whereby they try strategies until a desired result occurs. When the workers are satisfied with their work they will submit a desired output to the captain. Since the captain is running at a slower speed than the workers, the captain will receive his desired outputs quickly.

This method is slightly different from the previous universal computer program examples, but it comes from the same ideas. Referring to FIG. 33, the station pathway is done in the time machine. The captain is the main virtual character and the workers are the other virtual characters that must follow commands given by the captain. The captain will create a dummy software, in which it presses a buttonA. Then it will send commands to the workers, which are running at a faster speed than the captain. After the workers receive the commands they will be hard at work trying to accomplish the commands. They will work as a team, using trial and error, and to produce a desired output. When this desired output is done it will “only” submit the desired output. The videogame will ask the workers what it wants to output and it will output the strategy that works the best.

Let's say that the command was to use the laser system to shoot atoms and to let them bounce around until they hit 50 atoms in the targeted area. The 50 atoms have to move to the right and it has to travel at a certain speed. The workers will work together using the videogame to create that desired result. Sometimes they might make a mistake and they use software to correct that problem. Their work is over when the laser system does hit atoms in the environment and they bounce around, hitting 50 atoms in the targeted area. The 50 atoms in the targeted area are moving to the right and they are moving at the speed specified by the captain. Once this desired output is reached, the workers will capture these instructions into the videogame and execute the codes to control the laser to physically carry out the instructions. When the laser does its job, the environment will be changed and the 50 atoms in the targeted area are moved according to the captain's commands. The workers' pathways to control the videogame to fire the laser system are pegged to buttonA.

Because the workers use trial and error to carry out the commands of the captain, there are some instructions in the pathway that might have to be bypassed. Self-organization and pain/pleasure by the workers will determine which of the instructions in the workers pathways are important or not. Usually, the workers are skilled in what they do and they can play the videogame and get it right the first time. If not, at least, they get better and better as they play the videogame.

The idea is to capture the work done by the workers (the virtual characters) and to assign this encapsulated work to a fixed software function (buttonA). The captain controls the “dummy” buttonA and the captain uses the videogame to send commands to the workers. In the future, the captain can simply press buttonA to get the desired results without any workers. The pathway with the captain pressing buttonA is relationally linked to the workers' pathway. If many examples are trained with the captain and the workers (a station pathway) for this problem, then a universal type of pathway is created. Users can press the buttonA and the encapsulated work will occur.

How the Plane Moves

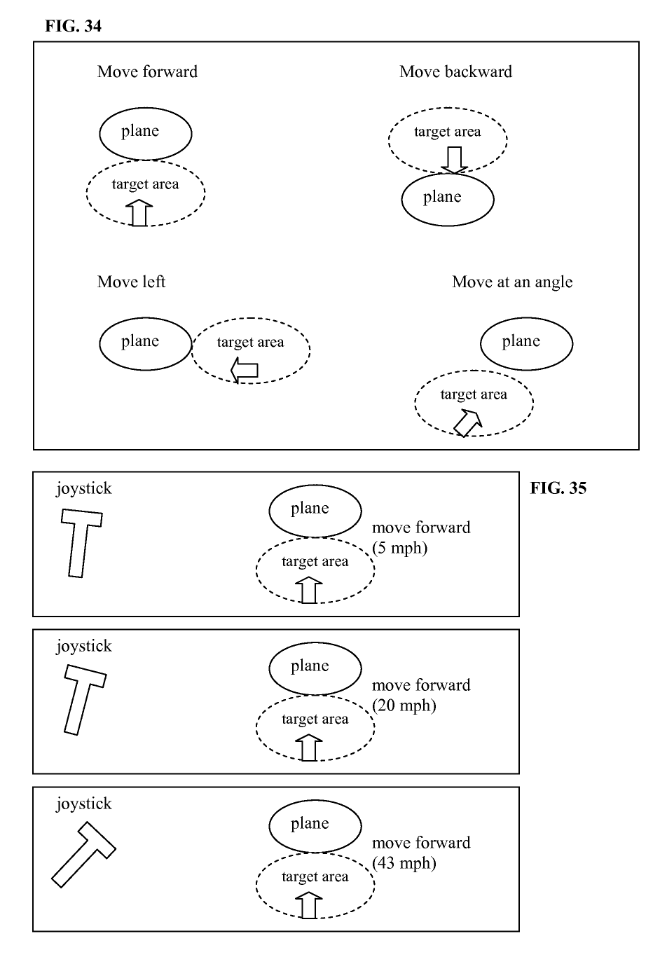

The plane moves by using the laser system to bounce atoms around the environment and to push the plane's exterior surface. FIG. 34 is a diagram depicting how the plane moves in different directions. When moving forward, the target area is behind the plane. The atoms have to move forward and push the plane forward. When moving backward, the target area is in front of the plane. The atoms have to move forward and push the plane backwards.

Moving forward, backward, right, left, at an angle and so forth require manipulating the joystick of the plane. When the captain wants to move the plane, he has to gently push the joystick slowly at first, then position that joystick to the speed it wants to travel. The joystick isn't a fixed function like a button so it's kind of hard to put encapsulated work into a joystick.

The captain has to use software to train the joystick in increments. FIG. 35 is a diagram illustrating three increments of the movement joystick. In the first increment, the captain pushes the joystick forward slightly, then he has to have the workers use the laser system to manipulate the environment. Next in the second increment, the captain pushes the joystick forward harder, then he has to have the workers use the laser system to manipulate the environment. Finally in the third increment, the captain pushes the joystick forward harder, then he has to have the workers use the laser system to manipulate the environment.

The first increment might include the command of moving 100 atoms in the targeted area to push the plane forward. The second increment might include the command of moving 300 atoms in the targeted area to push the plane forward. The last increment might include the command of moving 9,567 atoms in the targeted area to push the plane forward. Each atom might be given a force. For example, the first increment might include light force, while the last increment might include medium force.

The captain has to do this for all speeds and directions of the plane. Self-organization will do the rest to average out how the joystick is handled and what the desired output are in every increment.

The controls of the joystick will only work if the plane doesn't change its shape. If the plane does change its shape the joystick has to be modified. When the plane has to manipulate objects in its environment a different joystick is needed and this joystick will have to be trained with many different objects in the environment. For example, if the joystick can lift objects in the environment it has to be trained with lifting many different types of objects. Lifting a book is different from lifting a truck. The joystick has to be trained with lifting a book and also lifting a truck. When the opportunity presents itself, and there is a table in the environment, the AI of the plane will know what encapsulated work is needed to lift the table. The AI will find the pathways in memory that has an object that matches to the size, shape and weight of the table.

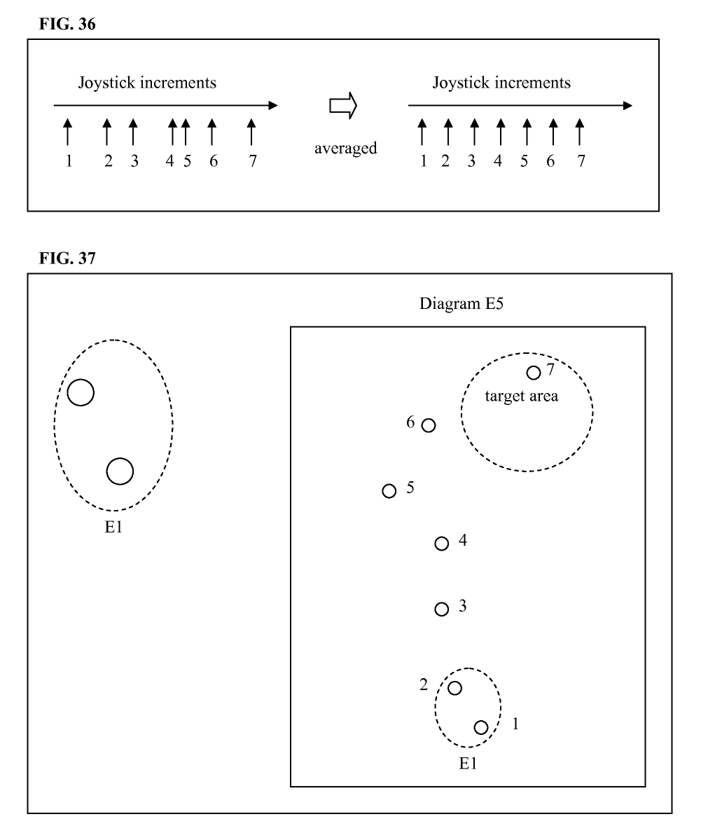

The joystick increments of training don't have to be perfect. The software from the videogame will manage the increments. However, let's say the increments are self defined by the captain. FIG. 36 is a diagram depicting increments trained at non-spaced out manner. The encapsulated work in each increment may not be correct all the time. But because of self-organization, the joystick increments average itself out and a smooth joystick movement results.

All controls of the plane including radio buttons, software interface functions, joysticks, monitor, switches and so forth has to be trained in this fashion. Work has to be encapsulated repeatedly. The more complex the task is the more encapsulated work is present.

The one thing I want to note is that in regular virtual character pathways, the software instructions and functions are not stored along with the pathways. Only the virtual character's experience with the software is stored. This separates virtual character pathways and software programs into separate data.

When the plane wants to use a virtual character pathway (or station pathway) to do work, it needs a physical copy of each software used in the pathways. For example, if the pathway records the virtual character using internet explorer to search for information from the web, it will get a physical copy of internet explorer and it will use the pathways to control the certain functions in the software.

This method works because if you have a function in a software and this function is represented by a button. The virtual character pathways record the pressing of the button. The result is the function executing after the button is pressed. All of the steps in the function and the computer codes to execute the function are not stored in the virtual characters pathways. The pathways get the function from the physical copy of the software. Another benefit is that the virtual character pathways can be used to work on similar software. For example, instead of using internet explorer, the AI can use netscape.

Videogame Training (Details)

The videogame has tools that let the workers see their area in a clearer manner. The software can display the 3-d shape of one atom, a molecule, or a group of molecules. The workers need this tool to determine how two atoms will interact with each other. FIG. 37 is a diagram showing how two atoms are positioned in different areas. The job of the worker is to us the laser and determine how the beam of light will hit the first atom so that it can bounce the second atom in a certain direction and speed. This process will be called E1.

E1 can be viewed in any angle or dimension—the monitor can show a sky view of the atoms or it can show a 3-d angled view of the atoms. The videogame has image software to show the worker details of E1.

E1 is just one task of the worker. In diagram E5, the job of the robot is to zap the first atom and let it bounce around until it reaches the atom in the targeted area. In some sense this problem is just like the game of pool. The worker has to work in sections. First it has to know how the laser can hit the first atom to bounce the second atom towards atom3. When that is successful the robot will use the videogame software and record the instructions. Next, it has to find out a way to use atom3 to bounce atom4 toward atom5. This will go on and on until the instructions to bounce atom1 to atom7 is perfected.

The process of trial and error has to be done. During each try, the robot can use the videogame software to save certain behaviors and use this behavior in the future. The worker also has the ability to analyze the atoms microscopically to see where the atom should be hit in order to generate a desired output. If the worker made a mistake, he can retry the last play and see where the atom was hit and to use software to determine where the atom should be hit in order to bounce the atom in a certain direction and speed.

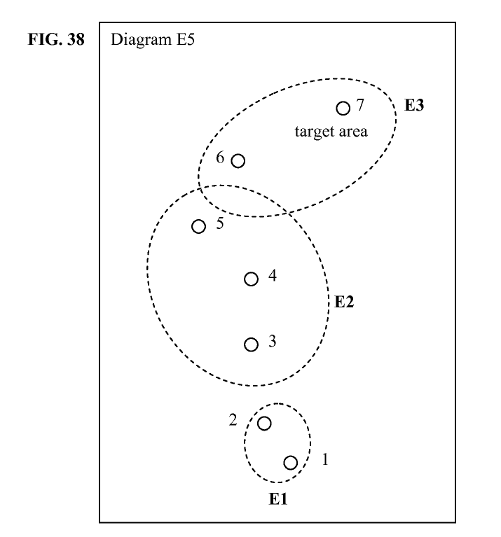

Referring to FIG. 38, the bouncing of atoms has to be done in sections (E1, E2 and E3). The worker will start with E1, then when it is successful it will start on E2, next when it is successful it will start on E3. Along the way, it will use the videogame tools and functions to help accomplish its goals.

Training Small Distances then Longer Distances

Similar examples will self-organize in memory. Of course, the more simple the example is the easier it is to find a pattern. The more complex an example is the harder it is to find a pattern. One simple example is E1 and a complex example is the diagram in FIG. 38. Basically, the longer the first atom is to the target area the more complex the example is.

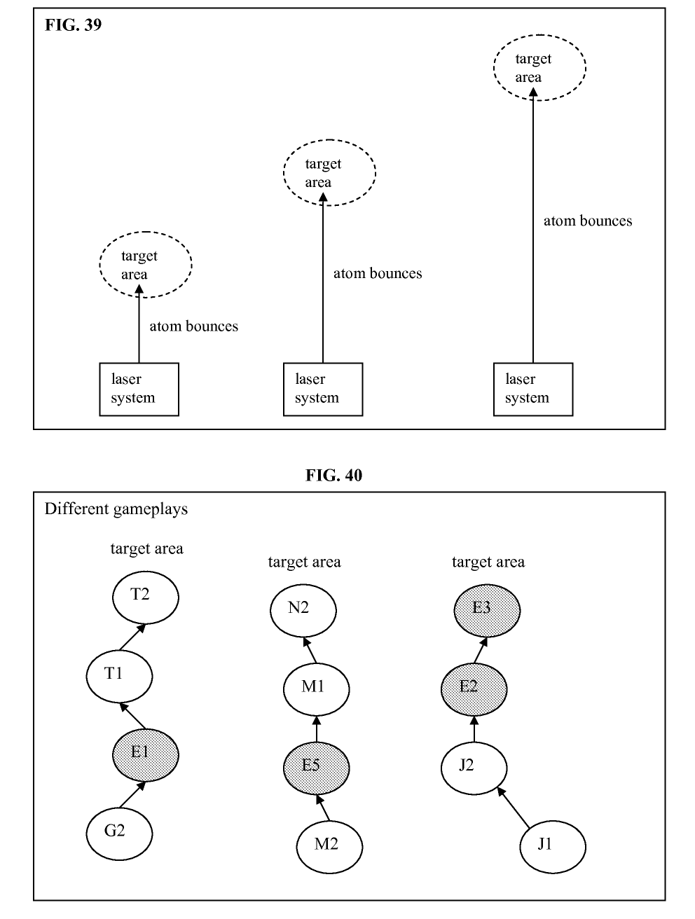

Referring to FIG. 39, the videogame will first present short distance examples from the laser system to the target area. As the worker gets better and better at playing the game, the videogame will present longer distance examples. As the worker plays the game, patterns are found and math equations are set up for bounce behaviors. The idea is that the target area can be anywhere and the environment can have any number of atoms and they can be positioned anywhere, the pathways will still be able to shoot the laser to move atoms in the target area.

The self-organization is very important because it generates hidden objects. These hidden objects will be in the form of math equations that can cater to infinite possibilities. For example, in E1, the second atom can be anywhere, but the hidden object (a fixed math equation), will help bounce atom2 to atom3 with the same force and direction.

Self-organization will create floaters in memory. The most important floaters will be outlined while the least important floaters will not be outlined. Since the controls of the laser system is from intelligent workers (or virtual characters) then the strongest floaters in memory are intelligent pathways. This is important because some neural networks use random training at the beginning to set the foundation for the AI. In the atom manipulator nothing is random and everything is based on intelligence. It has to be guided intelligence because if you try to train the videogame to randomly hit balls, the desired outcome will not be met regardless of how many times you train the videogame. The videogame has to be trained by an entity with human-level intelligence.

The pattern to E1 and E5 is the laser shoots one beam starting from the closest atom. Then it has a target area and the first atom has to bounce around until it hits an atom in the target area. The patterns found between similar examples will set up math equations for the laser to hit atoms. If the laser system is trained adequately the result is: you can set the target area anywhere (near or far) and the environment can have any number of atoms positioned in various areas, the laser system will still have the instructions to move atoms in the target area. That is the ideal outcome of this videogame.

By training it using short distances at first and then longer distances, behavior of bounces can be grouped together. Referring to FIG. 40, notice that in all three gameplays there are repeated behavior. E1, E2, E3, E5 are all repeated behavior. Instead of trying to find patterns in E1, E2, E3 and E5, there are copies already stored in memory and these copies contain hidden objects. For example, in the third gameplay, E2 and E3 already exist in memory and the AI doesn't have to worry about finding hidden objects for these two sections. The AI will try to find patterns in J1 and J2. They will compare this example to similar examples already stored in memory to find the hidden patterns. Even entire gameplay like E5 can be encapsulated. This makes it easier for the pattern recognition to find patterns and to find hidden objects.

More Complex Examples

The illustrations given above are very simple. The atoms are stationary and there is only one target area. In a more complex situation, the atoms are constantly moving and the laser system has to predict where these non-intelligent atoms will be in the future, so that it knows how to shoot the laser to bounce atoms to the target area. In real life, wind moves quickly outdoors, while wind in a room moves slowly. The laser system has to train itself to work in a dynamic environment.

Also, in the real world, the distance from the laser to the target area might be billions and billions of atoms/molecules. The laser system in the plane doesn't have to be perfect at an atomic level. As long as air is manipulated in the target area, the laser successfully did its job. For example, there can be infinite ways that atoms can bounce around to get to the target area. If the laser can execute one successful way to bounce atoms to the target area, that would be considered a success.

By tracking every atom, electron and em radiation, the atoms can bounce in a way that will minimize interacting with other atoms. By minimizing atom interactions energy from the bounce is conserved. Let's say that you wanted the laser to shoot an atom against a gust of wind. The objective is to avoid any atom that will hit the atom in the direction of the wind. By using the signalless technology, the laser can know where all the atoms of the wind are and to bounce an atom around to avoid any interacts with them. It's kind of like navigating a ship through an asteroid belt. Because the signalless technology tracks all atoms, electrons and em radiations, the chances of success are very high.

The signalless technology gives the atoms a sense of intelligent guidance. If you try to randomly fire an atom against a wind gust, most likely the wind gust will prevent the atom from getting through. It's kind of like randomly navigating a ship into an asteroid belt. The atom manipulator does things in a hierarchical manner. It might not be able to track every single atom or em radiation, but it can track larger objects like molecules or tiny particles. Instead of using the laser to fire an atom at a gust of wind, it can fire a molecule.

Thus, the atom manipulator can accomplish tasks in an approximate manner. This is why the videogame trains the laser system in a hierarchical manner. This is why the plane has a clarity tree that sees things in different levels of clarity. And this is why multiple virtual characters have to train the laser system at all visibility levels, either simultaneously or independently.

By the way, the signalless technology is only concerned with tracking atoms at the moment and what will happen in the short future. That is the difference between the atom manipulator and the time machine. The time machine is a more difficult technology to create because, a perfect timeline of all atoms, actions and events have to be mapped out not only for the short past/future, but distant past/future. The atom manipulator can be a much easier technology to build. The atom manipulator only needs to track non-intelligent objects and it can guess where the intelligent objects might be. For the most part organic species are much larger than a molecule. Even viruses are made up of thousands of molecules.

The atom manipulator can track as much non-intelligent atoms/molecule as possible and use physics to determine where they will be located in the short future. Tracking solid matter is easy because they need force in order to move, but tracking gas and liquid is harder. The atom manipulator will do very well in gas/air because atoms can move freely.

Team Work to Accomplish Tasks

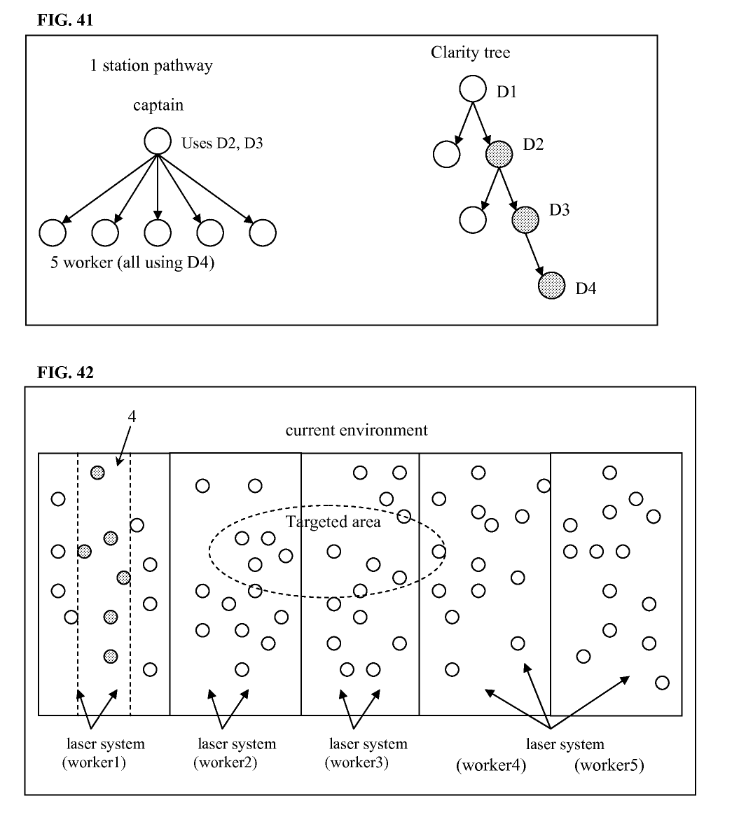

A station pathway is a team of virtual characters working together to accomplish goals. This team of virtual characters can be structured in any manner. The diagram in FIG. 41 shows that a station pathway is structured in a hierarchical manner. A captain is in charge of 5 workers. His task is to monitor the visibility level D2 and D3, while he instructs his workers to do tasks in visibility level D4. A videogame software will be used between the captain and his workers. This videogame provide tools for communication and aid in accomplishing tasks.

The videogame is specifically designed to control a laser system to hit atoms and let them bounce around until atoms in the targeted area of the environment are manipulated. The videogame comprises multiple workers that are assigned to different areas in the environment. The software in the videogame will allocate the laser system each worker will use and which areas they have to focus on.

The captain will input into the videogame a target area and specific instructions to move atoms in the target area. The videogame will send programmed instructions to specific workers to do things based on the input by the captain. Next, the workers will work together and by themselves to accomplish the goal the captain wants to accomplish.

Gameplay is a term used for each bounce pathway plotted by a worker. For example, in the last chapter E1 and E5 are gameplays. Each worker has to know that he/she is not working alone and that the environment changes based on all 5 workers. The gameplays each work does will be inputted into the videogame and the video monitor of the environment will change as a result of the gameplay. Each player has to confirm that they want to use a gameplay before it can be used to update the environment. Often times a worker will devise 20 gameplays and select the most optimal one to be inputted into the videogame.

For simplicity purposes all atoms in the environment are stationary and they don't move unless they are acted upon. As each worker inputs their optimal gameplays the environment changes. The videogame software has to keep track of which atoms are used by which workers. If one atom is used by worker1 and worker2 wants to use the same atom, the videogame will forbid worker2 from using that atom. Multiple usage of atoms will lead to conflicts between workers' gameplays.

In order to solve this problem there are three methods that can be used in combinations: 1. common knowledge of atom priority. 2. the videogame software outline atom priority. 3. the captain defines areas in the environment that has priority or not.

(1) Referring to FIG. 42, common knowledge of conflicting gameplay can be learned in books and manuals. Strategy books can be read to better play this game and how to interact with other workers. One strategy might be to stay away from atoms closest to other workers' boundary area. For example, in the first area in the diagram, all atoms that are located in area 4 will have top priority, while atoms located outside area 4 will have low priority.

What this means is that the worker can use the atoms within area 4 and be confident that these atoms will not conflict with other workers gameplays. Common knowledge in books will also give strategies for the workers to identify sections of atoms that might have top priority. There might even be steps that a worker has to go through to find the priority of atoms. One of these strategies is to communicate with other workers and to come to a compromise when they design their gameplays. Workers have to communicate especially when they have to use atoms from another workers boundary area.

(2) In the second method, the videogame has to outline, for all the workers, the priority of atoms. To minimize gameplay conflicts the software will give the workers a prioritized area based on whatever gameplay has already been inputted or in the working state. When a gameplay is inputted, then it is confirmed that atoms used in the gameplay are reserved. If a worker is in the working state of a gameplay, the atoms used should also be communicated with other workers because other workers might be using the same atoms. The videogame will look through the inputted gameplay and the working state gameplays and prioritize all atoms in the environment for all workers.

(3) The captain will be observing all gameplays inputted by the workers and he might be disappointed with some gameplays because gameplays might have high levels of conflict in a particular area. The captain might delete unwanted gameplays and tell certain workers to redo their gameplays in a different area. Thus, the captain can help to prioritize the atoms in certain areas.

Working Together to Play the Videogame

Referring to FIG. 42, the target area falls in the boundary of worker2 and worker3. That means these two workers must do most of the work. Worker2 and worker3 controls the closest lasers to hit the atoms in the target area. Other workers have to bounce atoms around for longer distances. This means that worker2 and worker3 have to work closely to plot gameplays that will reach the target area. They might argue back and forth using sentences like: “no, that is my atom. Go get the nearest atom” or “but that will take a long time to get to the target area” or “if you use that atom and I use that atom, both of our gameplays will lead to the target area in the shortest time” or “you concentrate on this area and I will concentrate on that area”. Sentences like these will be exchanged back and forth between workers to make their optimal gameplays.

The videogame software can also reassign worker1, worker4 and worker5 to help worker2 and worker3 to do their jobs—to help them plot out gameplays. The videogame software is essentially giving each worker new boundary areas and new goals to achieve. This will reallocate resources of the videogame, wither that be workers or laser terminals.

The videogame software has tools that the workers can use in addition to help from the captain. Calculations of atom interactions can be done quickly by AI software. If you watch an episode of CSI, you will notice that these detectives use software as tools to find information. The workers are using the videogame software in the same manner.

When everything is said and done, all workers have accomplished their goals set by the captain. They have resolved their differences and come to a compromise. The unified gameplays will be the desired output that will be sent to the captain. The gameplays will be stored as encapsulated work by all the virtual characters in one station pathway (in this case, the station pathway is one captain and 5 workers). This station pathway will be universalized and the captain will assign this station pathway to a fixed software function. These station pathways, if trained adequately will represent the AI of the plane; and will be used to control the laser system for one function in the future.

Predicting the Future and Each Gameplay

By the way, the gameplays are plotted in a future timeline because we are dealing with predicting the environment in the future. The future prediction function needs to predict how the inputted gameplays will affect the environment in the future. This example is easier because the atoms in the environment are non-moving and they don't move unless acted upon.

Everything has to be trained in the virtual world. The signalless technology will capture a short sequence of the environment and track all atoms, electrons and em radiations. Then, this short sequence will be presented to the workers who will control the laser system to manipulate that environment. The short sequence only records the environment without any tampering.

The future prediction function is used to predict what the environment will be in the short sequence if the laser system was used. This means that every gameplay inputted into the videogame will update the future predictions to include the gameplay. The videogame is responsible for modifying the short sequence and providing an accurate depiction of what that short sequence will be if the inputted gameplays are used to manipulate the environment.

The complexity isn't as difficult because the laser system only manipulates a small fraction of the atoms from the environment. Only the bounces and the atom interactions as a result of the laser beams fired by the plane need to be changed in the short sequence.

The question about how does the modifications of the short sequence happens should be asked? The answer is by using the simulation brain on how atoms interact with each other. The bounces can be calculated by matching pathways concerning atom bounces. The laser interacting with the original atom can be calculated by finding a pathway that matches to that object interact. The simulation brain stores the behavior, properties, object interactions for a given object or groups of objects.

For example, the simulation brain has to be trained with many examples of how atoms interact with other atoms or how electrons act with other objects. A laser is one object and a molecule is another object. A universal pathway has to be trained regarding the interactions between the laser beam and the atom. The future prediction will use these learned pathways to fabricate what might happen to the environment if the laser system was introduced in a given short sequence.

Training the Atom Manipulator in the Virtual World and Testing it in the Real World

Why does the training of the atom manipulator have to be done in a virtual world, why not in the real-time? The reason why is because it's very hard to build a laser system with fixed functions and fixed computer codes. It has to be trained through a videogame. We have to give the atom manipulator a training session (inputted gameplay) in the virtual world. This would mean all the work that is needed to control the laser system for one training session has to be done in the virtual world. All of the debates between workers, all the captain's orders and all the encapsulated work has to be done within a fraction of a millisecond.

In the computer, time is void and depends on the processing speed. This can be used as an advantage because all the work needed to control the laser for one training session can be done in the virtual world during runtime. After the work is done, the laser system can test the training session during runtime to see if the predicted results of the laser system are correct or wrong.

For example, we can use one training session and the plane can fire beams of light at atoms in the environment based on the training session. The robot piloting the plane will observe if the predicted future of the training session (inputted gameplay) is accurate or not. If the future prediction is accurate, then the laser successfully fulfilled its mission for that one training session. If it failed, then it can train it with a more desired training session in the future. The atom manipulator (the plane) will learn as more training is presented. Each training session has to be perfect or near perfect so that the AI can average all the controls and what these controls do to the laser system. There might be mistakes made, but self-organization of station pathways will average everything out.

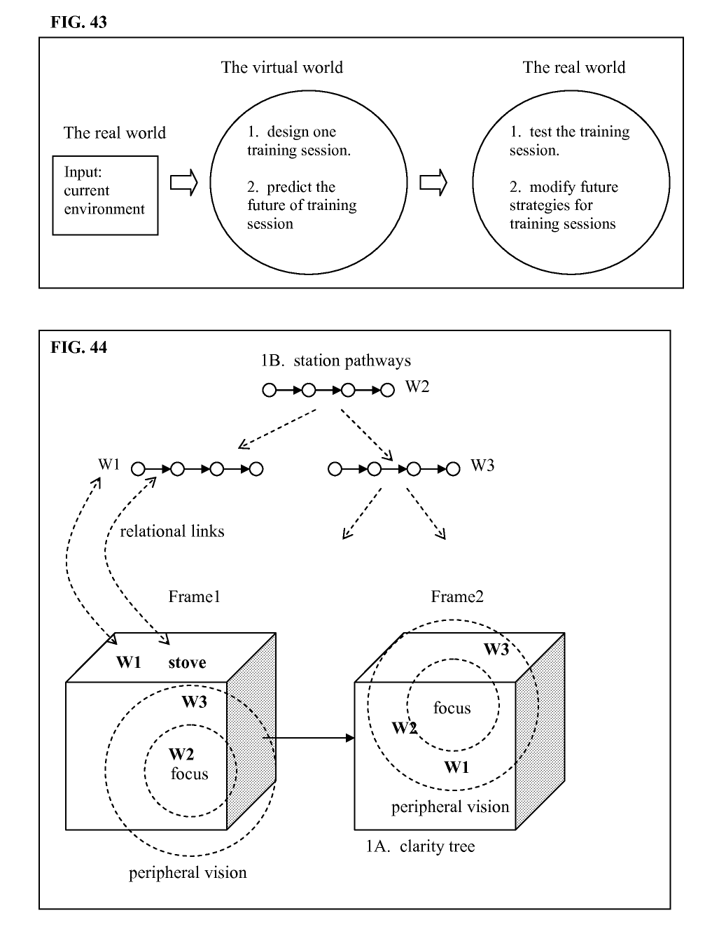

FIG. 43 is an illustration depicting how the atom manipulator will train itself using the virtual world to design one training session and using the real world to do the physical training.

First, the current environment is inputted into the plane. The plane will use the signalless technology to track all atoms, electrons and em radiation from a targeted environment. This short sequence will be handed over to virtual characters in the time machine. These virtual characters can work as a team or by themselves. They will design the training session using a videogame software and they will also create a future prediction for the training session. Next, when the captain is satisfied with the training session (inputted gameplays by the workers) he will transmit this information to the robot in the real world and the training session will be executed to be tested in the real world. The robot will see if the desired output has occurred. If not, then the robot will tell the workers in the time machine to do a better job in the future or to input some advice.

Training the Atom Manipulator in a Dynamic Environment

The examples above only describe atoms that are stationary in the environment. In real world situations atoms/molecules move in a dynamic way. They move based on physics and chemistry laws. Wind outdoors moves fast, while wind indoors moves slowly. The plane has to be trained under many situations.

The example above must be adapted to include a dynamic environment. Instead of atoms staying in a fixed position, the atoms are constantly moving. The workers have to come up with gameplays that will predict future positions of atoms. Where will a certain atom be in the future and how can the workers bounce that atom to hit other moving atoms? The future prediction function has to also do a good job in predicting the short future environment, and also, to modify this short future environment as the workers input new gameplays.

Training an Adaptable Laser System

Let's say that the first training session was a failure and the future prediction is also a failure. The plane has to adapt and to teach itself another training session. This time, the future prediction will modify itself based on the updated current environment. By training the plane with sequences of adaptable updates, the AI can learn what is desired and what is not desired. It will form patterns to keep the desired training sessions and to delete the bad training sessions. The plane can also know that the bad training sessions are not wanted and that this isn't what the robot pilot is looking for.

However, it is better to train the plane perfect or near perfect in every training session. The more desired training the plane goes through the more likely it will behave in a desirable way in the future.

Training to Correct Previous Mistakes

If one training session is badly executed and the results are wrong, the plane can modify the previous training session to make it correct. For example, if the first training session is wrong and the laser miscalculated, the plane can come up with a second training session that will correct the first training session. The second training session might include introducing more laser beams into the environment to bounce misguided atom bounces back to their original course.

This can be done repeatedly until all previous mistakes are corrected or a desired outcome results.

This method is important because the plane (the atom manipulator) doesn't predict the exact future, but an approximate future using its laser system. The future prediction function isn't concerned with predicting every atom, electron and em radiation on planet Earth every fraction of a millisecond. It is only concerned with predicting every atom, electron and em radiation within a focused area. Intelligent objects like human beings and animals are extremely hard to predict and they are usually ignored. However, when dealing with air and the open sky, most of the objects are non-intelligent and they are easily predicted. The simulation brain stores non-intelligent objects and their interactions. Since non-intelligent objects are based on physics and chemistry, they are systematic and they have repeated patterns.

Also, people and animals sense and act every second. Atoms and molecules act every fraction of a nanosecond. To the atom manipulator, intelligent objects behave very slowly and they can be considered stationary objects. Thus, the atom manipulator manipulates the environment so quickly that the infinite possibilities of an intelligent object don't really matter. Large intelligent objects like human beings and animals think slowly so they won't affect the atom manipulator. Small intelligent objects like viruses and spores are too small so they won't affect the atom manipulator.

However, it is prudent that the plane have the ability to predict an accurate future of how the laser system changes the environment. It must also predict what pre-existing objects in the environment will do in the future as a result of the laser beams. The plane should use adaptive methods to change the environment in the moment that something unexpected happens.

4. Introduction to Ghost Machines

In previous topics I talked about dynamic efficient robots and how these robots work in the real world and the virtual world to accomplish tasks. In the real world, intelligent robots are used to accomplish tasks. Station pathways are formed in memory as a result of intelligent robots working together as a group to accomplish tasks.

These intelligent robots are physical machines with human-level intelligence that work in the real world to do things. The technology described in this topic, called ghost machines, replaces intelligent robots. Ghost machines are created by the environment and powered by the environment to do tasks. They are also intelligent and can consciously act on their own.

In essence, ghost machines replace any physical machine (wither it be robot machines or expert machines) to do any task in the real world.

What exactly does a ghost machine look like? Some ghost machines are purely energy and they are there to let other people see them and hear them. Think of it as holographic illusions created by the molecules and energy from the environment. Other ghost machines are made up of solid matter that uses the atom reserves layer of the atom manipulator to get its form. The ghost machine needs a physical body because it needs to do things to the environment. It has to move objects around, take objects out of another object or to position an object in a certain location.

The ghost machine can be both solid matter and holographic at the same time. A human ghost will be holographic, but the hand of this ghost can be solid matter. This means that the ghost can phase through other objects, but the hand of the ghost can't. To make the ghost machine more functional, they can also shift matter around and change their compositions. The hand can be made from air particles or pure energy or solid metal. The hand can also shift in terms of its matter from one state to another depending on the task to be done and the current environment.

What are the main goals of ghost machines? If you look at a simple task such as carrying a table from the living room to the kitchen, a physical robot has to be present to do the task. What if it was possible to create ghost hands from the environment and use the hands to carry the table? When the task is finished the hands will disappear into thin air. An even bigger task is to build a house. Many construction workers and authorities are needed to accomplish the task. The architecture has to draw out the blueprints to the house; the client has to make sure the design is satisfactory; and the construction workers have to work to bring the materials and build the house. Now, what if all the workers are replaced with ghost machines and the workers are created from the environment and powered by the environment to build the house? What if the material to build the house can be transported to the target area instead of a truck?

The atom manipulator will do all the hard work by creating the ghost machines, instructing them to do tasks, transporting materials to the target area, and controlling the actions of the ghost machines.

Not only can the atom manipulator create and control these ghost machines, it can also provide the intelligence needed to accomplish tasks. For example, if an architecture was created from thin air, it needs a brain to think, it needs a functional body so that the brain can send electrical signals to appendages to move. Instead of creating a functional body of the architecture, the atom manipulator can create only body parts needed for that task, such as eyes to see, ears to hear and hands to draw. The intelligence of the architecture is simply a simulation inside the atom manipulator. The atom manipulator only controls what the “output” of the architecture will do, but it doesn't control the internal aspects of the architecture. For example, the brain sends signals to the hand to move. The atom manipulator will mimic what the hand is doing, but it will not mimic the electrical signals from the brain to the hand (these subject matters will be explained in greater detail in later sections).

FIG. 23 is a diagram depicting the data structure of the atom manipulator. The pathways from the atom manipulator are made up of three parts: the clarity tree, the robot's pathways, and encapsulated work.

FIG. 45 is a diagram depicting the data structure of a ghost machine. There are two factors involved: the training situation and the fabricated situation. The training situation comprises “one” station pathway and a clarity tree to represent that station pathway. In the fabricated situation, is the atom manipulator that comprises a clarity tree that represents the current environment, robot and virtual character pathways to control the atom manipulator, and encapsulated work done by the virtual characters (Robot or virtual character are referring to the same object. Also, robots in the station pathway are different from robots that control the atom manipulator. To make it simpler I will be referring to robots in the station pathways as “workers” and I will be referring to robots that control the atom manipulator as “robots”).

The training situation is “one” event that depicts all workers involved in a task. It also depicts the beginning and the ending of a task. This training situation should be an ideal way of doing a task by one or a group of workers. The station pathways have pathways from multiple robots working together. Each worker will store their 5 senses and thoughts into their respective pathways and relational links will bind the station pathway together.

### Training Situation

The clarity tree for the station pathways is a 3-d representation of all the workers and objects in the environment. All atoms, EM radiation, molecules and objects are stored in terms of a hierarchical tree called the clarity tree. The levels in the clarity tree will go from general to specific. For example, at the top of the tree, the visibility level is human visibility and at the bottom level the visibility level is atom visibility.

The station pathways are 2-d and data in the clarity tree are 3-d. Both will be referencing each other. For example, the position of a worker (a robot) will have a reference pointer to where they are positioned in the 3-d clarity tree. What that worker is sensing and thinking will also have reference pointers to the 3-d clarity tree. If the environment is a house and the worker is looking at the stove, then the 3-d clarity tree will have reference pointers of the worker's visual sense (which is 2-d) to the area where the stove is located (which is 3-d).

FIG. 44 is a diagram depicting this example. There are three workers in the station pathway (W1, W2 and W3). In the pathway of worker W1, the visual sense is looking at a stove. The clarity tree has references from W1's pathway to the stove in the 3-d environment. Notice that all workers (W1-W3) are also tracked as they move in the 3-d environment. Both the station pathways and the clarity tree deals with sequence of data and information is based on when they exist simultaneously.

The 3-d clarity tree and the station pathway can be trained simultaneously (which is preferred) or it can be trained separately. Either way, through the self-organization process, both data types will associate with each other through common traits. It is preferred that the 3-d clarity tree is created along with the station pathways. This will store the two data types together in memory so that the AI can find common traits easily. If they were trained separately, it will be harder for the AI to find common traits.

A station pathway will be one continuous sequence of pathways from one or multiple robots working together to accomplish a task. Sometimes these workers can be structured in a hierarchical manner such as in a business. Every worker is professional and each does their jobs very well. It's very important that the station pathway is the desired work done by all workers. Also, the station pathway has to depict an exact beginning of the task and the exact ending of the task. An approximate beginning and ending of a task can be used, but an exact beginning and ending is desired.

Station pathways and its clarity tree should depict non-intelligent and intelligent objects. Each station pathway just records the 5 senses and thought processes of many intelligent robots (called workers). Each worker pathway is one intelligent entity and will have reference pointers to the 3-d environment (the clarity tree). This will outline each intelligent object in terms of what they are sensing/thinking as well as their physical bodies (both internal and external atom structures).

In addition, non-intelligent objects are also identified by both the station pathways and the 3-d clarity tree. When a worker see an object, it is automatically identified as an object (wither its intelligent or not). The identification of non-intelligent and intelligent objects will be required in order to understand the fabricated situation. Being able to know what an intelligent object is sensing/thinking is also an important thing.

The Fabricated Situation

Referring back to FIG. 45, the fabricated situation is the second part of the ghost machines. The fabricated situation comprises a clarity tree of the “current environment”, pathways from robots or virtual characters that control the atom manipulator, and encapsulated work.

Since the station pathways and its clarity tree depict intelligent and non-intelligent objects, the robots that control the atom manipulator has to create fabricated situations based on the training situation. In other words, they have to make the ghost machines behave like the physical workers in the station pathway. The robots controlling the atom manipulator has to create the ghost machines based on the workers, copy the intelligence of the workers, and to make the ghost machine do things exactly like the workers.

The intelligence in how to accomplish a task has already been outlined in the station pathways. Based on association, the intelligence can be “carried over” to the fabricated situation to do tasks.

When I say robots controlling the atom manipulator I'm referring to robots in the real world and the virtual world. These robots can be structured in any organization or structure. For example, if the atom manipulator is a plane, there might be a captain that is in charge of the plane. Under his/her command is a first officer. These two high officials may have a crew of 5 that will follow orders from both the captain and the first officer.

On the other hand, virtual characters are also doing the encapsulated work. They have to provide the instructions that is needed to operate the atom manipulator to function a certain way.

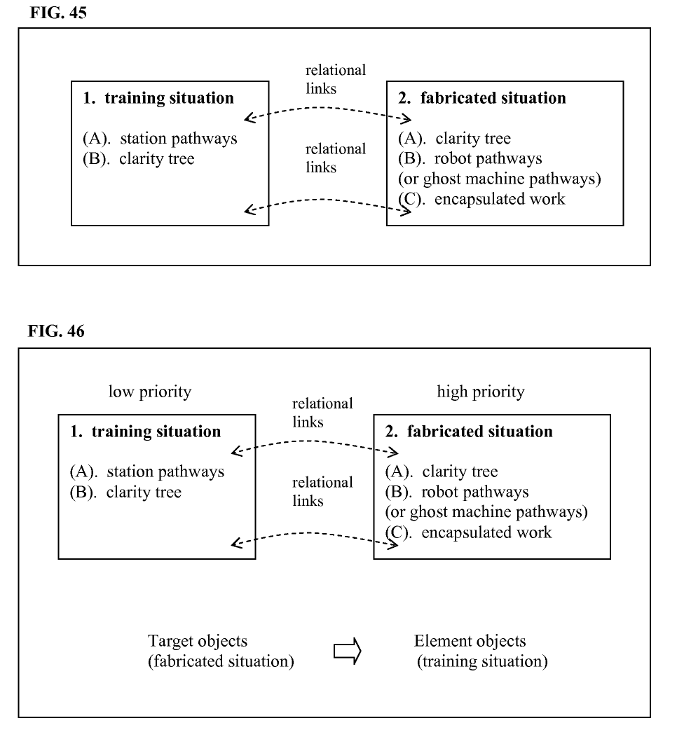

Both the robots controlling the atom manipulator and the virtual characters must take each worker pathway from the station pathway and try to mimic each worker's behavior using the atom manipulator. The atom manipulator pathways are called the fabricated situation and they are pegged to the data in the training situation—most notably the station pathways. Referring to FIG. 46, relational links will further bind all data between the training situation and the fabricated situation. The worker's pathways in the training situation will have relational links to their respective ghost machine pathways in the fabricated situation.

Each worker in the station pathway has to be recreated as a ghost machine. The robots controlling the atom manipulator has to try to understand what each workers' goals are and what their rules are before they can fabricate a ghost machine. The robots also have to mimic the physical work that these workers are doing with the atom manipulator. For example, if one task for a worker is to carry a table and put it in the living room, then the atom manipulator has to create a ghost machine to do the same task. The ghost machine might be a holographic human with solid-matter hands that will carry the table and bring it into the living room. The task that the worker and the ghost machine have to do is exactly the same. The only difference is the physical worker is replaced with a ghost machine that was created by the atom manipulator.

All intelligent objects (workers) in the station pathway must be represented by their own ghost machine. All non-intelligent objects must be present in the targeted area. For example, building materials to build a house has to be in the target area where the house will be built. Materials can be transported by truck or any other means. Materials can also be “beamed” into the target area by the atom manipulator and assembled there. For example, if workers need 50 timber wood, the atom manipulator can use the atom reserves layer to shoot atoms into the target area and assemble these atoms together to create the 50 timber wood. On the other hand, a worker can buy the 50 timber wood from home depot and bring it to the target area via a truck. Either way, the 50 timber of wood is needed to build the house—the workers have to use the material to build the house.

How the Pathways Will be Matched in Memory

The training situation and the fabricated situation comprise pathways. The AI will find a match that will be the closest match to the current environment in terms of the fabricated situation and not the training situation. As stated earlier, the training situation is a situation where physical robots are present to do tasks in the real world. This isn't the pathways we are searching for in memory. The training situation is considered guided pathways that have some data that we want to find and some data we don't want to find.

On the other hand, the fabricated situation is a situation where there are no physical robots present to do work in the real world. The atom manipulator creates ghost machines to do work that correlate to the training situation.

Because of this fact, the fabricated situation should have higher priority than the training situation (FIG. 46). When the AI finds the best match, the fabricated situation will have higher priority than the training situation.

When the AI tries to find a match in memory it will search for the closest matches. Pathways in memory are searched in terms of fuzzy logic. Because the training situation and the fabricated situation have strong relational links with one another, they are grouped very close to one another. Referring to FIG. 46, think of the fabricated situation as target objects and think of the training situation as element objects. The AI will find the best matches to the target objects in the current pathway and activate the strongest element objects. Because the training situation has strong association with the fabricated situation, when the fabricated situation is matched in memory, the strongest training situation is activated.

This is very important because the intelligence of the ghost machines come from the station pathways in the training situation. When the fabricated situation is matched, the intelligence of these ghost machines are activated as well. In other words, the intelligence of the workers' pathways are “carried over” to the ghost machines.

Bootstrapping Process

Pathways stored in memory build on pre-existing pathways in memory. This is where the term bootstrapping comes from. What's so wonderful about the brain is that pathways are floating around and these pathways can group together to form larger pathways. Below is a demonstration of how pathways group themselves incrementally.

1. station pathways
2. station pathways+3-d clarity tree
3. station pathways+3-d clarity tree+robot pathways (control of atom manipulator)

First, station pathways are created in memory. Then, 3-d clarity trees are created in memory. Since station pathways and 3-d clarity trees have relational links they are grouped together. Finally, station pathways and 3-d clarity trees are combined with the robot pathways that control the atom manipulator. All three are grouped closely to one another because they have strong commonality groups and learned groups.

The third listing above shows that the intelligence of the station pathways can be “carried over” to the robot's pathways.

How the Atom Manipulator is Trained

The main idea behind the ghost machines is for the atom manipulator to create ghost machines to do tasks that physical machines can do. It replaces the physical machines to do work.

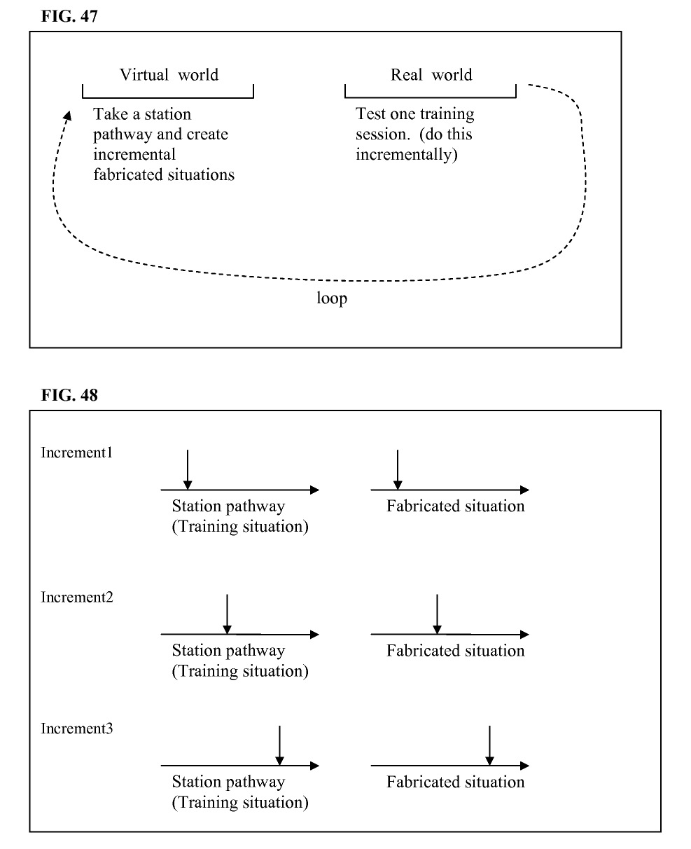

Training has to be done during runtime. FIG. 47 and FIG. 48 are diagrams depicting a loop whereby “one” station pathway is extracted and at each increment a fabricated situation is generated which is called a training session. All work will be done in the virtual world. It might take several years of work from many virtual characters in order to generate one training session. When the training session is completed, it will be tested out in the real world to make sure that the atom manipulator functions correctly.

Referring to FIG. 47, if the atom manipulator does its work correctly then the training session was a success and the virtual characters can move on to making the next training session. If the training session is wrong then the virtual characters might have to generate a new training session to correct the previous mistake.

Referring to FIG. 48, in each increment, the station pathway time will correlate with the fabricated situation time. As the workers in the station pathway do their work, a fabricated situation is generated in every increment.

This loop will repeat itself over and over again until the entire station pathway is pegged with its respective fabricated situation (or until the entire task is completed). As each fabricated situation is generated, called a training session, the atom manipulator will test it out in the real world in real time. Each training session will be done in the virtual world and might take 3 years to generate, but the training session is tested in the real world. The good thing about working in a virtual world is that 3 years can past and only 1 millisecond has past in the real world. This gives the atom manipulator a perfect opportunity to test a training session in the real world using real time.

Encapsulated Work (for the Atom Manipulator)

The work that is needed to instruct the atom manipulator to do tasks is overwhelming. Robots and virtual characters have to do tasks in an encapsulated manner. They have to use the universal computer program to assign fixed interface functions or joysticks to encapsulate work. Once work is assigned to a fixed interface function, the virtual characters can use the interface functions to do other work. Thus, this is how work is encapsulated.

Also, work has to be done in fragmented sequences. A group of virtual characters might have to do work in the human visibility level in the clarity tree and another group of virtual characters might have to do work in the atom visibility level. Encapsulation of work has to be done from the bottom up. Each group has to use the universal computer program to assign their work to fixed interface functions so that they can reuse these work in the future or to let other virtual characters (or robot) use the fixed interface function. The next section will illustrate how work is encapsulated. Just a reminder, when I say the robot and the virtual character, they are basically the same things.

Further Details on the Ghost Machines

The main purpose of the ghost machines is to create the same exact work that is done by workers in the station pathway using the atom manipulator. Instead of physical robots to do work the atom manipulator does the work. It creates ghost machines, provide intelligence for each ghost machine, and control the ghost machines to manipulate the environment. These ghost machines can be small to manipulate molecules or atoms or it can be big to manipulate furniture or cars. And these ghost machines can work as a team or individually to do tasks. For example, 1 trillion tiny ghost machines can work together to make a car float in the air. Or 10 big ghost machines can work together to do heart surgery on a patient.

The station pathways are from physical robots doing work in the real world. Their collective pathways are stored into one station pathway in terms of what they sense and think. The responsibility of the robots controlling the atom manipulator is to “mimic” the work that these physical robots in the station pathway are doing. Thus, the atom manipulator can do any task that one or more physical machine can do.

In the last section, I described only “one” training, whereby the robots in the atom manipulator are trying to provide a fabricated situation for “one” station pathway. In order to train the atom manipulator in terms of fuzzy logic, thousands and thousands of training is needed for a given situation. The pathways in memory have to self-organize to create a fuzzy range of itself so that the atom manipulator can take action under any circumstance or situation.

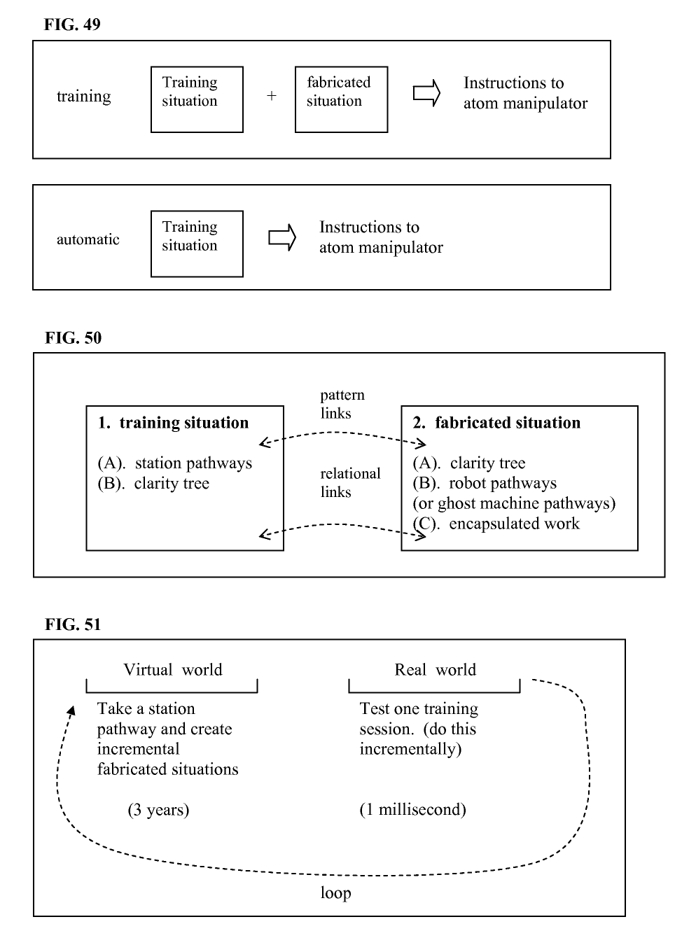

The whole idea is to train the atom manipulator so well that it can take a station pathway in memory and automatically generate the instructions to the atom manipulator through patterns. FIG. 49 is a diagram depicting training for the atom manipulator and automatic instructions for the atom manipulator. Basically, the training state requires the fabricated situation in order to create the instructions to the atom manipulator. In the automatic state, the AI can find the best station pathway match in memory and patterns will automatically generate the instructions to the atom manipulator. All ghost machines will be created along with their intelligence and this is all done through the station pathway.

If you think about how powerful this method is, you will see why the atom manipulator is so important. You can have physical robots working in the real world as individuals or in a team. Their pathways are stored in memory. Self-organization will knit relational pathways together forming station pathways. If we assign groups of work to a fixed interface function using the universal computer program, then we can use software to accomplish tasks.

All the work done by physical robots can be stored in memory as station pathways and they can be assigned to fixed interface functions. The atom manipulator can then use these station pathways and generate their equivalent ghost machines to do tasks. Thus, this method replaces any physical robot.

If the atom manipulator is trained properly, any station pathway can be extracted and the instructions to the atom manipulator to create ghost machines can be generated automatically. Of course, a simple task like carrying a table from the living room to the kitchen is easy, while a difficult task like building a house is hard. Lots of training is needed for more difficult tasks.

### Universal Computer Program

Entire work that is done by one robot or a team of robots can be encapsulated into a fixed interface function or it can be assigned to a voice recognition system. For example, a user can sign a form and submit the form so that a team of robots can do a task. Or a user can use their voice to give a command and a team of robots will do a task. Either way, the universal computer program encapsulates work done by one or more robots.

Now, imagine that the atom manipulator replaces physical robots to do tasks. We can use a software to encapsulate work. We can provide a fillable form for a user to fill in and submit what they want done. For example, if they want to build a house, they have to submit their preferences regarding what the house will look like or to give a general idea of the house. Then professional robots will start to work and to accomplish the task of building the house.

On the other hand, the user can fill in forms and submit it through a software. Then, the atom manipulator can do all the work. Instead of physical robots building a house, the atom manipulator will extract the station pathway of building a house, create ghost machines, provide intelligence to each ghost machine, and send the instructions to each ghost machine to act. When everything is said and done, the house is built based on a user's preferences using the atom manipulator and not physical robots.

There are infinite tasks that the atom manipulator can do. It can build a bridge, build a car, run a business, move a mountain, extract pollutions from the air, create a computer, create a cellphone, transport materials and so forth.

Intelligence of the Ghost Machines

The training situation houses the station pathways and the station pathways contain pathways of individual workers (robots) in terms of the way they sense and think. The intelligence of each worker is already stored in the station pathway (called activated element objects). On the other hand, in the fabricated situation, the robots controlling the atom manipulator is only concerned with translating data from the station pathways. They will look at a worker's pathway and see what the worker's goals are and what they are trying to do. Then, they will provide the instructions to the atom manipulator to mimic their behavior.

Referring to FIG. 50, the station pathway has the intelligence of each worker and the robots controlling the atom manipulator also is aware of the intelligence of each worker. Both pathway types will generate relational links with one another. This basically makes the intelligence of the ghost machines stronger. The robot's pathways and workers' pathways in the station pathway outline the intelligence of the ghost machines and what they should sense and think.

In some ways, the intelligence of the ghost machines is simply following a pathway in memory in linear order. The pathways outline how the ghost machine should sense and think—what its goals are and what rules to follow.

A fabricated situation example—This example will illustrate a worker in a station pathway carrying a table from the living room to the kitchen. The robots controlling the atom manipulator has to translate this into instructions for the atom manipulator. First, they will determine if the physical aspects of the worker are important or not. For example, is it important that other people see this worker carry the table from room to room. Maybe this information is used to do work for other workers.

There can be many different approaches to this problem. The robots controlling the atom manipulator can create no ghost machine. Instead, they can use the air in the environment and make the chair move in the air exactly to the movement in the station pathway. When the task is done, the table has gone from the living room to the kitchen without any physical robot doing the task. The task in the fabricated situation is completed exactly to the task in the training situation (station pathway). This is the desired result we want.

On the other token, it is sometimes very important to also mimic the visual aspects of the task because other dependant workers might have to communicate with the worker. When working in a team-like-setting to do tasks it is very important that the visual representation of workers also be mimicked. A good idea is to use holographic representations for workers. Holograms are made up of energy or small air particles. These energy and small air particles are positioned a certain way in space and time so that a consistent image is present. Ghosts are made up of air particles and we can see them, but they are transparent.

Since ghosts are transparent they can't move things around. The solution to this problem is to create solid matter on certain areas of the ghost machine. In this example, the hand must be made from solid matter because it has to hold a table and carry it around from room to room. Everything else about the ghost machine is transparent, but the hand is made from solid matter (or semi-transparent matter).

Another problem is that a physical robot gets its force to move the table based on its body weight. The foot of the physical robot is partly a factor in carrying the chair. The electrical signals to move muscles to transfer force from the ground to the table is another factor. The way to solve this problem is by generating a holographic image of the worker. Then, solid matter will be devoted to certain areas, such as the hands. Next, air will be manipulated in that area to make the table float. Possibly knocking atoms from the ground all the way up to the hand to move the table—this is important because the atom manipulator should move things similar to the station pathways, even the motion of force.

The robots controlling the atom manipulator has to also make sure to neglect certain things from the worker's pathways. The worker's hand to lift the table comes from electrical signals sent from his brain. The ghost machine doesn't have to mimic this behavior. It can simply make a solid matter hands and to manipulate them to do the things that the worker's hands are doing.

Reference Pointers from the Ghost Machine to Station Pathways

The ghost machine has eyes and those eyes have reference pointers to the worker's eyes in the station pathway. Most of the time, what this ghost machine sees will be a big factor to how it acts. For example, if there was a bed in front of the ghost machine, he will go around the bed. If the ghost machine tries to go through the bed, he might go through, but the table he is carrying will hit the bed.

What the worker is sensing should reference to the ghost machine's senses. This will create a realistic ghost machine that basically has a brain (referenced from the station pathway) to sense information from the environment. The thinking part of the worker's pathway is invisible, but it is referencing to the ghost machine's brain because that is where intelligence comes from.

This is why it is very important that the robots controlling the atom manipulator try to mimic the behavior of the workers in the station pathways exactly. Sensing from the environment has everything to do with intelligence for the ghost machines.

In addition, the station pathway contains encapsulated work as well. Workers, called virtual characters, do work in the time machine and robots do work in the real world. The fabricated situation will only be concerned with fabricating ghost machines to do work in the real world. Any work in the station pathway that are done in a virtual world are ignored.

Fragmented Encapsulated Work (Using Videogames)

The fabricated situation is done in fragmented sequences. They are combined together through encapsulation. When it is combined it will be tested out in the real world called a training session.

In FIG. 44 there are three workers (W1, W2 and W3). The station pathway stores each worker's pathway in terms of what they are sensing and thinking. Relational links will be established with all three workers. Dependant steps are linked with each other. In order to build a fabricated situation for this station pathway, robots that control the atom manipulator has to provide ghost machines for each worker. One group of robots will work on W1, another group of robots will work on W2 and another group of robots will work on W3. All three groups have to collaborate with each other to synchronize their fabricated situations.

The current environment must also match with the environment of the station pathway. If building materials are located in one area in the station pathway, then the same building materials must be located in the same area in the current environment. The current environment and the environment of the station pathways can be slightly different, but it should be similar or same. The way to solve this problem is by setting up the current environment to look exactly like the beginning environment of the station pathway. Again, the two environments can be slightly different, but the two environments have to be as similar as possible. If the current environment and the environment in the station pathway are different in certain states, the robots controlling the atom manipulator has to modify the ghost machines to do tasks that will mimic the environment in the station pathways.

After every group has done their jobs they can use a videogame software to combine their work. For example, when a fabricated situation is created for W1, the robots can insert those instructions into the videogame software. When a fabricated situation is created for W2, the robots can insert those instructions into the videogame software. Finally, when a fabricated situation is created for W3, the robots can insert those instructions into the videogame software.

The videogame software will combine all instructions together. Encapsulation of work can also be managed by the videogame software. If there was one virtual character captain and 3 thousand workers under his command, the encapsulated work from these hierarchical virtual characters will be managed by the videogame software (refer to my last book for more information about this subject matter).

Another fact about encapsulated work is that the robots have to provide fabricated situations for the station pathway in terms of hierarchical visibility levels. A group of robots must do work in the human visibility level and another group of robots must do work in the atom visibility level. The videogame software will manage the complexity of fragmented encapsulated work and combine them together.

Referring to FIG. 51, the whole process of providing a fabricated situation for one increment of a station pathway will take 3 years. Since all work is done inside a virtual world, 3 years can be 1 nanosecond in the real world. After the fabricated situation is created, which is called one training session, the atom manipulator will test the training session in the real world to make sure it is correct. This process will repeat itself over and over again until the entire task in the station pathway is completed.

Thus, 1 nanosecond passes then a training session is executed. Then, 1 nanosecond passes then a training session is executed. Next, 1 nanosecond passes than a training session is executed. Then, 1 nanosecond passes then a training session is executed. This process will repeat itself over and over again until the entire task in the station pathway is completed.

The end result is an atom manipulator that is trained during runtime to accomplish a task.

Different Types of Atom Manipulators

The atom manipulator must have a physical body. The atom manipulator is made up of a laser system and it can be applied to a plane, a car, a terminal, a computer, a human robot, a forklift, etc. For different types of atom manipulators there will be different types of instructions to control them. The instructions to control a car is different from the instructions to control a plane.

Different interface functions (or controls) are pegged to encapsulated work to do things. The robots can make any controls for each atom manipulator. A control stick can be included in a plane, a steering wheel can be included in a car and so forth. The controls on the atom manipulator will depend on what that machine is.

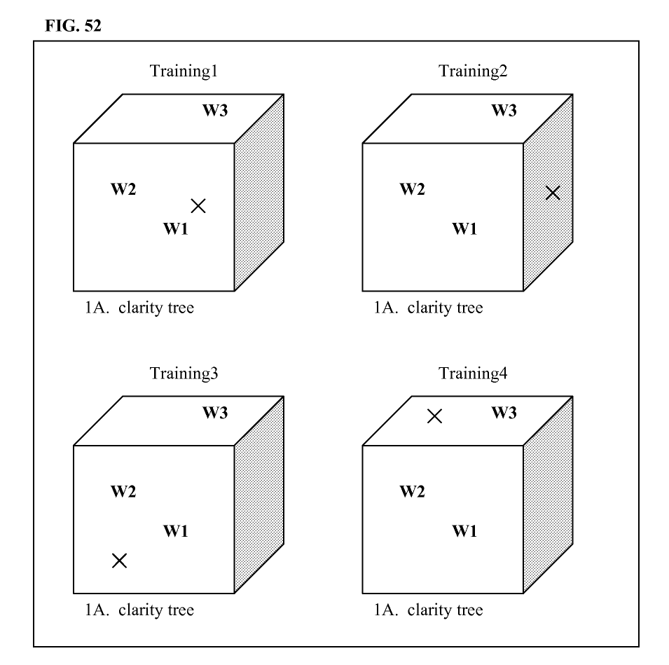

Regardless of what physical shape and size the atom manipulator is, it must be trained to do tasks from different angles. Getting back to the building house example, imagine that the task of building a house is the same for all training examples. Referring to FIG. 52, all 4 training examples show that the work is exactly the same, but the position of the atom manipulator is different (the X is the position of the atom manipulator). Regardless of where the atom manipulator is located the same work must be done to build the house.

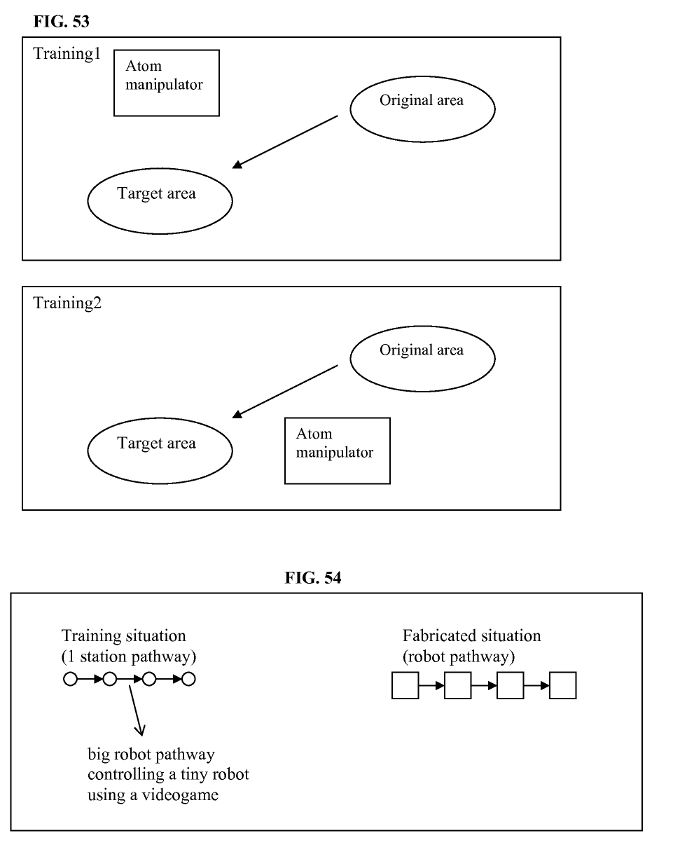

This is accomplished by training it with different angles and different situations. The AI will self-organize data in a fuzzy logic manner and it will understand the complex patterns. FIG. 53 is a diagram showing one type of pattern. Let's imagine that the station pathway was to carry a table from the living room to the kitchen, the atom manipulator can be in the kitchen and it will manipulate the environment so that the table will go from the living room to the kitchen. The atom manipulator can be in the bathroom and it can still move the table from the living room to the kitchen.

It looks at all the common traits between all the training examples. Patterns are established and it instructs the atom manipulator to do a task regardless of where it is located. These patterns will include intelligence of the workers, the goals of the workers, the physical task to be done and so forth.

To complicate things, thousands of atom manipulators are sent into the environment to do many tasks. For example, the total job of the atom manipulators is to build a city with many buildings, houses, and factories. These atom manipulators are controlled by a hub that instructs them to work in certain areas and to do certain tasks. In the hub, there might be a robot/s that will use a videogame to plot out where houses and buildings should be built. The videogame can instruct the atom manipulators to accomplish these goals. In the videogame, populous, the player can control what the environment will look like. The hub that controls thousands of atom manipulators can work the same way. Instead, the videogame in the hub can physically create houses, buildings and factories.

To complicate things even more. Imagine there are millions of hubs and in each hub there are thousands of atom manipulators. The tasks that these hubs can accomplish can be unlimited—they can build an entire Earth in less than a minute, equipped with a civilized society.

The hubs control certain atom manipulators and it does have the capabilities of communicating with other hubs. However, it should be noted that tasks should be independent and hubs only have the power to change the environment in their given areas. By isolating tasks and hubs, it is easier to manage complexity. In some cases, using a law book to do things, whereby all hubs have common knowledge of what can be done and what can't be done is preferred. There might be some hubs that have higher ranking than other hubs or they have higher power. The hierarchical structure of hubs should be written down in knowledge books so that everyone knows the rules. Also, videogame software can be used to manage hierarchical structured hubs. What powers and privileges does one hub have can depend on knowledge books or videogame software they are given.

In order to time travel, trillions of hubs are sent throughout the Earth and each hub has a responsibility to fulfill. The atom manipulators will all work together to manipulate the environment based on the timeline of Earth. These atom manipulators will create ghost machines to change the environment. The primary duties for these ghost machines is: to take out molecules, combine atoms, to move solid objects, to bind molecules, to bend materials, to position air in a certain location, to knock em radiations around and so forth.

Different Types of Ghost Machines and their Functions

Ghost machines can be small like nanobots or it can be big like a human robot. The functions of these ghost machines are to do work by using the atoms, electrons and em radiations in the environment. Wind can move ghost machines around from one place to the next, air pressure can push certain appendages of ghost machines to carry objects, and the physical aspects of ghost machines can push objects around. The atom manipulator is used to create the ghost machines as well as to make them function a certain way. A laser system inside the atom manipulator will shoot beams of light at atoms (as well as electrons or em radiations) and these atoms will hit other atoms until atoms in a target area are moved.

Topics in this section will include discussing how certain objects are manipulated by the atom manipulator. If a person has lung cancer and the atom manipulator was used to extract all cancer cells from that person, the procedure will include opening up that person, moving certain organs around, identifying the cancer cells, cutting out all cancer cells, putting all the person's organs back into their original positions, and sealing all wounds made. The atom manipulator has to function like a surgery team, whereby doctors, each specialized in different fields, work together to save a person's life.

In the case of manipulating a computer, tiny ghost machines are needed to go into the computer and to manipulate the computer's chips and circuits so a desired result occurs. These ghost machines are manipulating the physical aspects of the computer so it can access the hardware and software of the computer. It can stop the power supply from reaching the mother board, which results in the computer shutting down. It can introduce new software instructions into the computer that will manipulate the operating system to do a foreign task. The monitor's hardware can be tampered with so that the display shows foreign visual picture that wasn't created by the computer's software. For example, the monitor can have a picture of a bird super-imposed on the operating system screen. This picture wasn't generated by any software, but was generated by the ghost machines that went inside the monitor's hardware to introduce foreign instructions to the video microchip.

In the case of the practical time machine, the ghost machines have to work backwards and put all atoms, electrons and em radiations back to the way they were in the past. EM radiation that comes from an electron has to travel back into the electron. Atoms that are moving forward have to move backwards. Blood that comes out of the skin, must go back into the skin. Water that fall from the sky must go back up the sky. Babies born have to go through reverse mitosis until it reaches its single cell state.

The atom manipulator has to provide the means of manipulating the environment. In my last book, I describe how the atom manipulator manipulates the air to move objects around. Using air can also break up molecular bonds or bind molecules together. However, manipulating air can only go so far. A more powerful method is to create ghost machines and to use the ghost machines to do intelligent work. These ghost machines must have some kind of shape and size so objects can be manipulated. A tiny hand the size of a needle point can be used to grab certain viruses from an area. The tiny hand has to have a shape made from solid matter that can grab the virus and pull it out of an area.

As of this writing, the news talk a lot about the swine flu possibly infecting our public schools. Human workers are needed to clean every square inch of the school, in hopes of getting rid of the virus. Viruses are very small and they can't be seen with the naked eye. Workers can't possibly get rid of all germs and viruses from the school. If the atom manipulator was used to get rid of all germs and viruses from the school, “all” germs and viruses can be destroyed. First, the atom manipulator has to identify all germs and viruses, it has to send out tiny nanobots, in the shape of a hand, to search and extract every germ or virus.

Viruses might be lurking below the surface of objects and it is the job of the tiny nanobots to go deep inside liquid or solid matter to get rid of these viruses. The identification of the virus will be done by the intelligence of robots that control the atom manipulator. The signalless technology will be used to map out a 3-d clarity tree of the environment. This clarity tree will contain all visibility levels of the environment. Once the 3-d clarity tree is created, the robots will run software to id possible areas where viruses can be found. Next, nanobots are sent to these areas to extract them and put them in a disposable area.

Atomic and Molecule Visibility Level

If you look at a solid coin, you will notice that it is made from solid compact atoms. You are simply looking at it from a human visibility level. If you look at it from an atomic visibility level, you will notice that the atoms are miles apart and each atom and their parts are constantly moving. For example, the metal atom's electrons are orbiting the nucleus and em radiations are being emitted from these electrons.

The speed of object movements is also another factor. An electron can emit thousands of em radiations in all directions in less than a second. We might look at an object like gravity as a constant thing, but if we observe gravity in terms of a fraction of a nanosecond, it really doesn't affect an atom continuously. Atoms are in a state of animated suspension as time is slowed. We can shoot lasers at an object with a specific intensity continuously and the object will cancel out the gravity.

Lasers are used to bounce around objects (most notably atoms/molecules) because light travels fast. Even if we slow time, light still travels fast. The atom manipulator will use this as an advantage to manipulate the environment. The AI in the atom manipulator can store more frames in a pathway. This basically slows time in the environment. Building the most advance laser system that can shoot beams of controlled light in specific areas in the environment is another advantage.

Atom bondings will depend on physical or chemical bonding. A water molecule consists of a hydrogen atom and two oxygen atoms. All three atoms go through chemical bonding, whereby their electrons are shared. Other water molecules can bond with other water molecules to form visible water. Since atoms have miles and miles of space between them, the atom manipulator can change each atom and its parts even if we are dealing with a solid coin. The atom manipulator can change one atom in the coin or it can change 20 molecules in the coin or it can change all atoms in the coin. Sometimes, we want to change molecules that are located in the middle of the coin. Ghost machines are built to dig into the coin to a target area, manipulate the molecules, and then put all the digged out molecules back to the way they were.

The laser system is versatile and each beam of light can be controlled in terms of how intense the light should be, how fast the light is traveling and what direction it is traveling. The laser system can also shoot arbitrary numbers of light for each fire.

The next couple of sections will be examples to illustrate how the atom manipulator generates ghost machines for certain situations.

Nuclear Blast

A nuclear blast can vaporize a city in less than 5 seconds. However, if we slow the time of the nuclear blast and look at it from an atomic level, each chain reaction is in a frozen state. The atom manipulator can be used to shoot photons at many specific areas and to cancel out the nuclear blast during the beginning of its chain reaction. This will create an “anti-nuclear weapon”.

In the case of the practical time machine, the atom manipulator has to reverse the chain reaction of the nuclear blast and work backwards. Energy that is released will be put back to its original state. However, a perfect timeline of a nuclear blast event must be recorded and every atom, electron and em radiation must be tracked every fraction of a nanosecond. The timeline that records the event has to record every frozen state of the blast. The laser system will be used to reverse everything that occurred—it has to position the atoms, electrons and em radiation exactly to the timeline incrementally. The atom manipulator can essentially “undo” a nuclear blast.

Making Objects Float

Gravity pulls objects onto the ground. Energy waves or movements of particles in the air push down on objects so they stay on the ground. If we slow time and look at how gravity works, you can see that arbitrary amounts of energy waves push objects downward. The atom manipulator has to cancel out these downward energy waves with opposite upward force so objects can float in the air.

Now that gravity is canceled out, the object itself has to have a neutral position. If the object is moving forward the atom manipulator has to use the laser system to bounce atoms/energy to hit the object by using an opposite force. If gravity is canceled and the movement of the object is canceled, then the object should float in the air.

In order for the object to be stationed in one specific area in the air, the atom manipulator has to cancel out forces incrementally. Gravity is constant and it hits objects on Earth every nanosecond. The atom manipulator has to adapt and change the forces in and around the object every increment so that the object floats in the air every second.

The atom manipulator can work in slow motion. The environment is frozen pictures in the mind of the atom manipulator. This can be accomplished by increasing the number of frames in the pathways.

Building Different Sized Human Robots (Ghost Machines)

So far, we only discussed human robots in the station pathways. We can build any type of robot and store their pathways in the station pathway. As stated earlier, the robots controlling the atom manipulator has to take the station pathways and provide a fabricated situation. These fabricated situations will provide the instructions for the atom manipulator to create and manipulate ghost machines.

Now, imagine that we create human robots the size of bacteria and they are given commands to do certain tasks. For example, a task might be to enter a cell and manipulate the dna strand. There orders might be to do this for every single cell on an organism.

These tiny human robots may have less intelligence than a real human robot, but they have two hands, two legs, eyes, ears, and mouth and they can function similar to a big human robot. As they live and breathe, their pathways can be stored in a universal brain and self-organize into station pathways. The robots controlling the atom manipulator can take these station pathways and make ghost machines to do their tasks.

A better idea is to build tiny dummy human robots and use a videogame to remote control these tiny robots. On one hand, the big robots are intelligent at a human-level and they are controlling a videogame that controls the tiny robot. This way the intelligence of the tiny robots are not present in their brains, but is hidden in the pathways that come from the big robot's brain. The station pathway can store the big robot's pathways controlling the tiny robots body through a videogame.

The robots that control the atom manipulator can use this station pathway to create ghost machines (tiny robots) that is controlled by a videogame and the player of the videogame is a big robot. The intelligence of the tiny robot is from the big robot.

Referring to FIG. 54, the station pathway contains a big robot's pathway that is playing a videogame and this videogame is controlling the actions of a tiny robot. On the other hand, in the fabricated situation, the robot controlling the atom manipulator has to translate the station pathway. They have to create ghost machines based on the tiny robot in the station pathway, but the intelligence of the tiny robot comes from the big robot in the station pathway.

In more special cases, the big robot in the station pathways can use the videogame to control many tiny robots. The big robot can also use the universal computer program to encapsulate work and assign it to a user interface function in the videogame. By the way, if you encapsulate work in the station pathways, it will give the atom manipulator more functionality, but at the same time, the robots that control the atom manipulator has a harder time doing the fabricated situation because they are trying to mimic encapsulated work.

This method is not desired because encapsulated work in the station pathways must be recreated in the fabricated situation. Instead, the robots controlling the atom manipulator can combine encapsulated work together by using a videogame software. For example, one robot can create one fabricated situation and another robot can create another fabricated situation. A videogame will then combine these two fabricated situations together. One fabricated situation will have a ghost machine that manipulates the DNA in a cell, and another fabricated situation will have a ghost machine that manipulates the DNA in another cell. The videogame will combine the two fabricated situations so that in the combined fabricated situation, there are two tiny ghost machines that are extracting DNA from their respective cells.

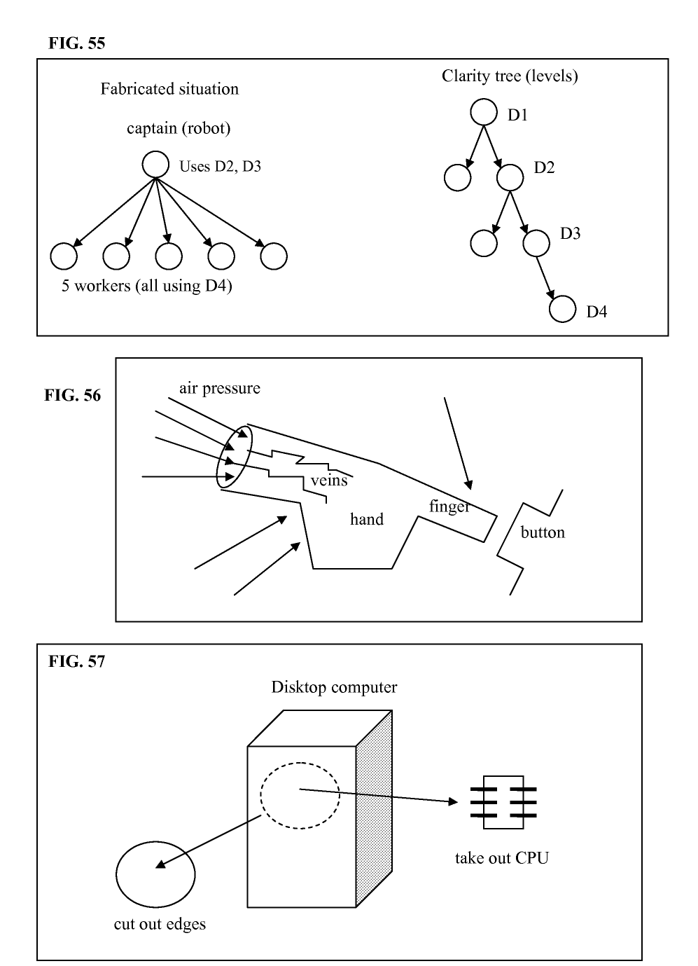

Another method is by using a hierarchical structure of robots to control multiple tiny ghost machines to extract DNA from every cell in a living organism. FIG. 55 shows a captain and 5 workers. Each worker has to take their own fabricated situations to do and generate ghost machines to do their tasks. Also, each robot is responsible for their own visibility levels. For example, the captain is using D2 and D3 visibility level and the workers are all concerned with D4 visibility level.

A Ghost Hand

When doing surgery on a patient it is vital to make physical hands to move things around and to use cutting tools. The ghost hand will serve two purposes: 1. it can hold and push objects aside. 2. it can manipulate objects and use tools. There are slight problems that arise when creating this ghost hand. For human beings, we have a full body and our legs are pushing the floor so that our hands are positioned above the legs. When we move our hands we are using our legs to push the ground so that the force of the push is transferred over to our hands. If we build a ghost hand only, where will the force to move the ghost hand come from?

The answer is to use air pressure and to push certain areas of the ghost hand. This push will make the hand move. The ghost hand is like a machine and it has user interfaces. Inside the ghost hand are veins that send signals to the fingers to move a certain way. Maybe the atom manipulator can create electrical signals to certain veins to move the fingers. And at the same time it can send air pressure to the base of the hand to move. FIG. 56 is an illustration of a ghost hand. The ghost hand will copy the physical aspects of a worker's hand in the station pathways. Maybe it's prudent to copy certain muscles and veins too. The ghost hand should be a functional machine to do tasks similar to a real hand. Air pressure will be used to position the hand in a certain area and to move the hand. If the hand has to push a small button, then air pressure is applied to the base of the hand. This air pressure will give the hand the force to push the button and stay in its current position.

This hand must be able to push things aside and to get deep inside an object to extract things. When a worker fixes a car, they have to reach inside certain gears to turn caps and to use tools to tighten up bolts. This ghost hand should have the same capabilities as a real hand.

The solid matter of the hand can be made up of various mixtures of molecules from the air or it can be constructed from metal or soft plastic. As long as the ghost hand functions like a real worker's hand, then the ghost hand is a success.

Using Air Particles to Manipulate the Environment

A ghost hand can be used to manipulate the environment. Another alternative is to simply use air particles to manipulate the environment. Imagine that a task for the atom manipulator is to take out the CPU of a computer. The computer is encased in a sealed casing. For human beings, we have to open the computer's case and then take out the CPU. The atom manipulator can cut up certain areas of the casing and use air pressure to pull out the CPU. If the CPU is integrated into the desktop, then the atom manipulator has to cut out certain areas around the CPU and then carry it out of the casing. After the CPU is extracted, the atom manipulator will put the cut out plastic back into its original location (FIG. 57).

Cutting out objects is done by breaking the bondings between molecules at a microscopic level. If the bonding is a chemical bond, then the atom manipulator will hit the electrons that bind atoms together. If it is a physical bond, then the atom manipulator will hit the atoms that are bond together.

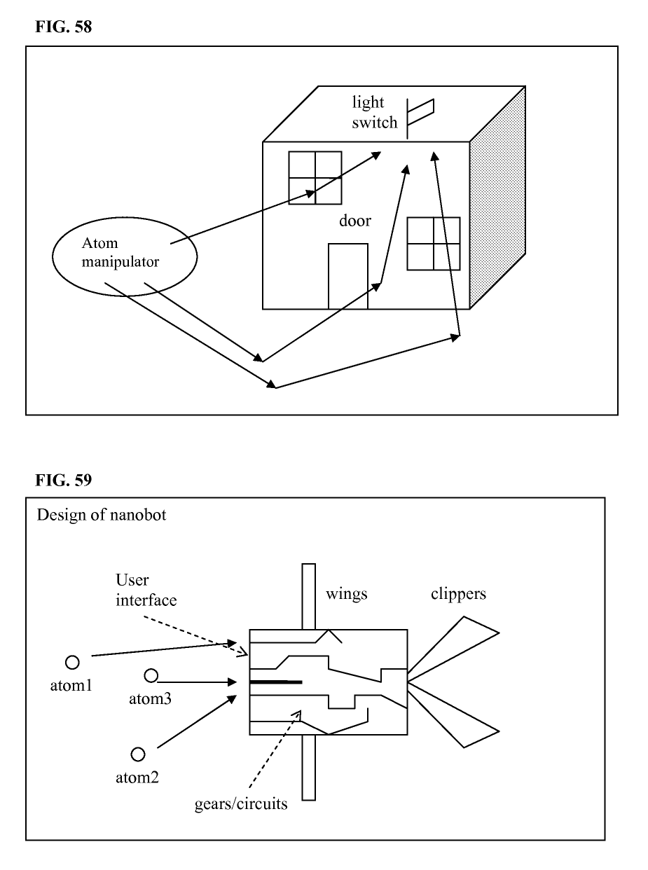

In cases where there is sufficient air movement, the outer shell of the object doesn't have to be cut opened. Instead, atoms have to bounce around and enter the object through any air openings. For example, if the object is a house and the atom manipulator wants to turn the lights off in the living room, then the atom manipulator can shoot laser beams so that atoms can bounce around through openings in the house such as windows, cracks on the walls, the chimney, or the opening under the front door. All the atoms bounced around, through air openings in the house, will meet at a certain time and at a certain location. The certain area I'm referring to is the light switch for the living room. The air pressure around the light switch has to push the switch off. All the air pressure will converge at the light switch at the same time. This will result in the lights for the living room to shut off (FIG. 58).

Nanobots—Tiny Machines

This section will only outline the functionality of tiny machines and not the intelligence behind it. The atom manipulator creates tiny machines called nanobots. The nanobots are machines that have gears and interfaces so that it can do things. At the same time, the nanobots move by the atom manipulator.

FIG. 59 is a diagram depicting a nanobot. It is constructed to act and behave like a machine. Appendages and user interfaces are built into each nanobot so that it can do things such as carry an object around or push an object around or extract molecules from a larger object. In the diagram, the nanobot have clippers to hold objects. There are gears that allow air pressure to push to control certain functions of the nanobot. There are also two wings attached to the nanobot that guide the machine in certain directions.

The back of the nanobot contains user interfaces. These user interfaces accept air pressure to move certain parts of the nanobot. For example, the atom manipulator bounces atom1 to move the upper wing. It will bounce atom2 to move the left clippers. It will bounce atom3 to physically move the nanobot. These atoms are hitting the user interfaces only. The gears and circuits inside the nanobot will do all the hard work to make the machine work.

You can build any type of ghost machine. The user interface can be in any media type. For example, instead of accepting atoms, the user interface might accept photons. In fact, the user interface can accept a coded sequence of photons to carry out certain tasks. The smaller the ghost machine is the more limited in what it can do.

Controlling Multiple Nanobots (Ghost Machines) to do Group Tasks

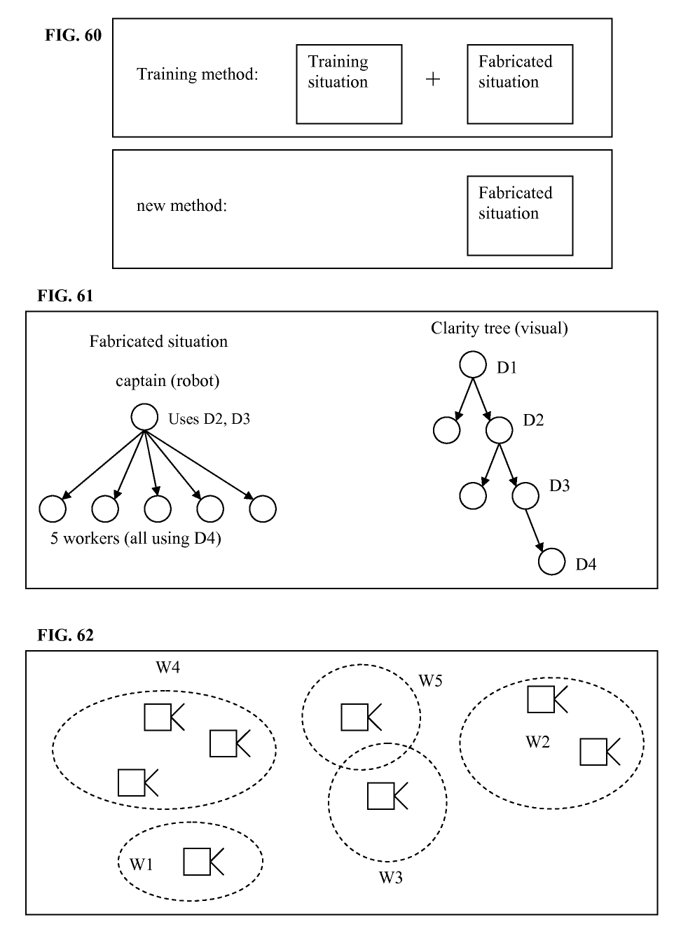

We can create ghost machines without using the method described in previous sections. In the previous sections I use the training method, whereby there is a training situation and there is a fabricated situation. The fabricated situation should correlate with the training situation. The new method is to get rid of the training situation. Only the fabricated situation is present (FIG. 60).

This means that the robots controlling the atom manipulator don't have to mimic the data in the station pathway. They can make up “any” fabricated situation and test it out in the real world during runtime. This new method only works for non-intelligent ghost machines like the nanobots. The nanobots don't have brains so they don't store data sequences of what they are thinking.

A hierarchical group of robots controlling the atom manipulator can use a videogame software to create the encapsulated work for the atom manipulator (FIG. 61). Each worker is under the supervision of the captain and the captain will communicate and analyze the work done by the workers through a videogame software. The captain will give orders for each worker to create the instructions to their ghost machines (nanobots) to do certain work in this area or that area. The workers will follow the captain's command. The videogame software will combine all the work done by all workers. The captain can then use the universal computer program to assign the encapsulated work to a fixed software function such as a button. The captain can use the button in the future to do further work.

FIG. 62 shows each worker controls a group of nanobots and they each have goals that are given by the captain. The captain will not only tell them which nanobots they are in charge of, but also what their goals are. If many of these examples are trained and the AI generates floaters from this example, the task can be accomplished regardless of how many nanobots are present or where these nanobots are located. In other words, the floater can solve the problem under “any” circumstances or challenges.

Different Sizes of Ghost Machines Working Together

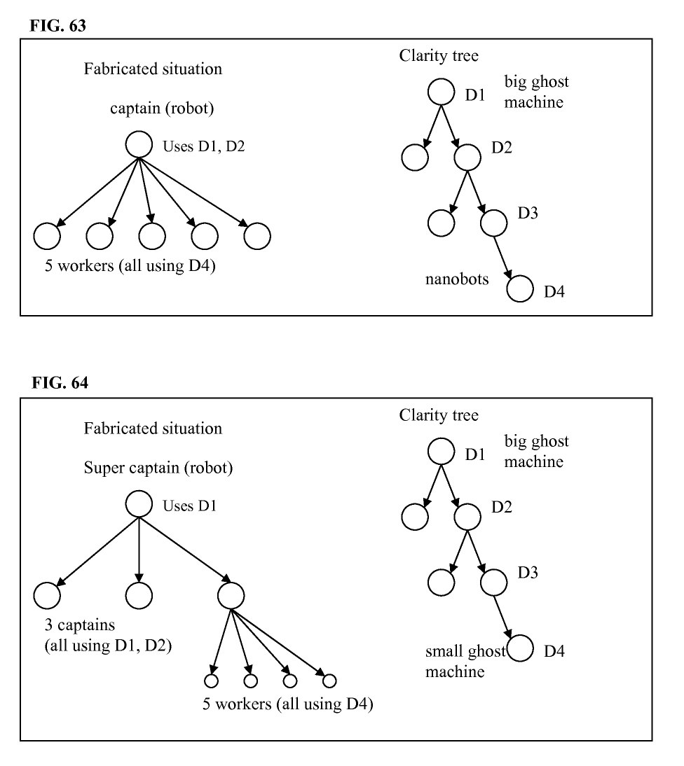

We talked about tiny robots like nanobots and we talked about big human robots that take the physical form of a ghost machine. In a dynamic environment different sized ghost machines have to work together to do work. The big ghost machines have to work with the tiny ghost machines to accomplish tasks. In order for different sized ghost machines to communicate with each other, a hierarchical team of robots have to control the atom manipulator. FIG. 63 is a diagram depicting a hierarchical team of robots providing the instructions (fabricated situation) for the atom manipulator. Just a reminder, the fabricated situation is done in fragmented sequences and is combined by the videogame software. The fabricated situation can also be encapsulated.

In the diagram D1-D4 represent visibility levels and the visibility level goes from general to specific. At the top of the tree (D1) human visibility is present and big ghost machines are being controlled. At D4, the level is atom visibility and small ghost machines are being controlled called nanobots. In the hierarchical team of robots controlling the atom manipulator, the captain is responsible for controlling the big ghost machines and will send tasks to the workers to control the smaller ghost machines. The captain and the workers are different entities and they do their own tasks. The videogame software will provide the communication means for the captain to communicate with the workers and vice versa. The captain is responsible for controlling the big ghost machine to do tasks and the workers are responsible for controlling the small ghost machines (nanobots) to do tasks.

For example, the task to be done by the team of robots might be to do lung cancer surgery on a patient. The captain will control the big robot to open up the body of the patient and to provide an opening toward the lungs. When that task has been fulfilled, the captain will send orders to the workers to control the tiny ghost machines (nanobots) to search and extract any cancer cells in the lungs. The workers will use the videogame software to do their jobs. Each worker might be given specific areas to search and destroy and these given areas are assigned by the videogame software. When all workers are done accomplishing their task, they will send a message to the captain via the videogame software stating they are done. The captain will observe the results and determine if the task is completed successfully. If it is, then the captain will control the big ghost machine to pull out of the patient and he will give orders to the workers again. This time, they have to use the tiny ghost machines to seal off all wounds made by the big robot. Their task includes bonding molecules together exactly to the state before the surgery layer by layer starting from the closest organ to the lungs.

After the workers have accomplished their second job, they will send a message to the captain via the videogame software stating they completed the task. The captain will observe the results to see if the tasks are completed successfully. If the captain is satisfied, then the entire task of curing a patient from lung cancer is completed.

This example shows that hierarchical teams of robots controlling the atom manipulator have to work together in order to communicate and control different sized ghost machines. Each ghost machine is controlled in different visibility levels and each worker is working in different visibility levels. The videogame software is what allows the robots to communicate with each other and to organize information for each robot.

Encapsulated Work by Different Sized Ghost Machines

The last example only serves one patient. What if the task to be done is to serve 3 patients. We simply add another upper level to the hierarchical team of robots controlling the atom manipulator. FIG. 64 is an illustration of a team of 3 captains and each captain has 5 workers. Each captain is given orders by the super captain to do tasks. The super captain will assign one patient per captain and their orders are to cure the patient from lung cancer.

Most of the time work has to be encapsulated by the videogame. What this means is that work has to be done at different times and independently from each other. Usually, encapsulated work is done from the bottom up.

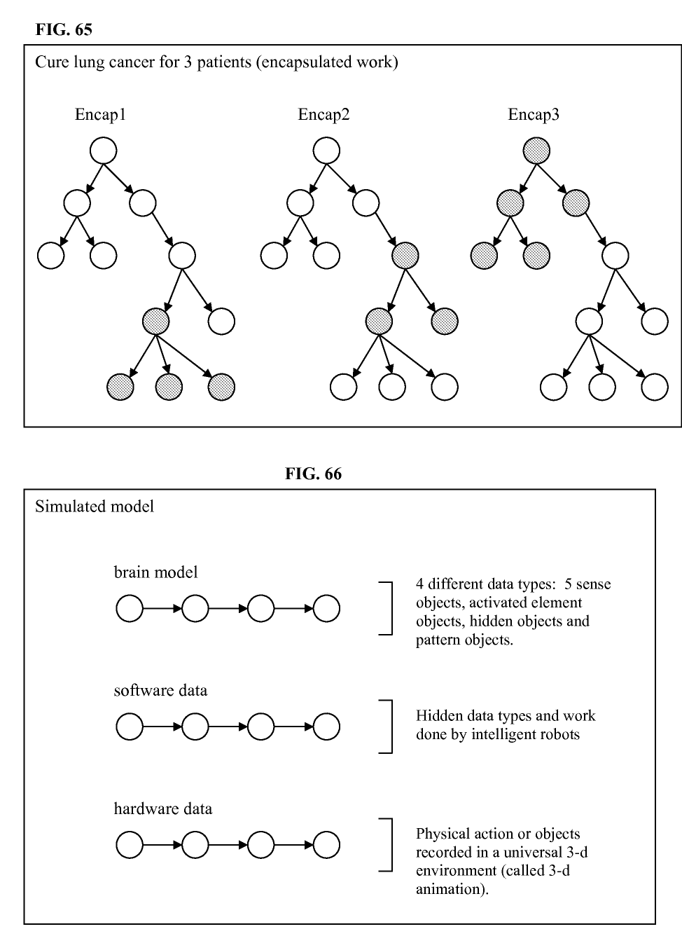

For extremely complex tasks, teams of robots work independently. Since all teams can't be trained at once, it is the job of each team member to encapsulate their work using the universal computer program. FIG. 65 shows that each section has to be trained from the bottom first and then trained towards the top levels. It can't be trained from the top to the bottom because if encap3 was trained first the desired output will be wrong and further because encap3 needs encap2 and encap1.

However, when all sections of the overall task are trained adequately, any section or combination of sections can be trained and each trained section will be stored in their respective areas. For example, if all sections in the overall task are trained, encap3 or encap2 or encap1 or element combinations from each section can be trained.

The videogame software will store the fixed interface functions in memory and combine them if necessarily.

The idea is to separate sections of the overall task into independent sections. What sections in the task should be grouped together independently and assigned to a fixed software function? People can do research and find the best groupings. These research methods are then put into books and should be widely read by people who are in the field. Of course these research methods don't have to be fixed; if other writers find a better method they can also replace old methods with newer methods.

5. Other Topics:

Simulated Models

Referring to FIG. 66, each simulated model comprises primarily three parts: brain model, software data and hardware data. Sequences containing all three parts are stored and organized inside the simulation brain and represented as a simulated model. Intelligent objects such as cells, insects, animals and human beings have a brain model, however, non-intelligent objects like chairs, computers, videogames, phones, furniture, buildings and so forth do not have a brain model.

The brain model comprises the 4 different data types: 5 sense objects, hidden objects, activated element objects and pattern objects. This will house all the data sensed from the intelligent object as well as its thought processes. There is a sub-part called the personal model that stores behavior patterns for that object.

The software data (FIG. 66) comprises hidden types of data or work done by intelligent robots. One example of software data are electrical signals sent over telephone lines. The electrical signals are the physical aspect of the signal, but the 0's and 1's that make up the signal is the hidden aspect of the signal. The software data is the hidden aspect because it is “hidden” and can't be accessed by observing physical traits. For example, we can't observe how the signal is transmitted to understand what that signal contains (the 0's and 1's).

Work for that simulated model done by the intelligent robots in the time machine is also stored in the software data. Work can be classified as any fixed tangible media, which includes books, computer programs, papers, computer files, holograms and so forth. Work can be a computer program that the robots built to store, retrieve and modify data. Work can also be stored in a computer file that contains schematic diagrams, pictures, videos, step instructions, knowledge and so forth.

As the robots predict that simulated model, it will store this work in the software data. Work can be inserted, deleted, modified or merged and can be in any media type. The robots working in the time machine will convert work into certain data type and insert them in a manner that is compatible with the pathways in memory (a simulated model is made up of pathways). The more work is put into the simulated model, the more detailed that simulated model will be. For example, if the simulated model is a human being, the robots have to predict each body part and how these body parts will be simulated in the computer. This will go on and on until the individual cells are predicted.

The hardware data (FIG. 66) represents the simulated model in a 3-dimensional manner. Any type of physical data of the simulated model is put as sequences in a 3-d environment called a 3-d animation. The 3-d animation is a sequence of physical objects that happen in a timeline. There is no one camera angle to represent the 3-d animation. A universal camera, from all angles, captures events or objects in sequence order. For example, in a human being simulated model, the human being's physical trait and actions will be the 3-d animation. The human being's external body and internal body will be stored in the 3-d animation. All actions of the human being as a direct result of its brain activities will also be recorded in the timeline of the 3-d animation. By the way, brain activities in terms of electrical discharges and how the electricity travels in pathways are known as hardware data. The information inside the electricity is known as the software data.

The material presented in this patent application related to the atom manipulator creates the 3-d animation for an object. The 3-d animation is actually the clarity tree. Here are the steps in creating the clarity tree:

1. The signalless technology takes cameras capturing from different angles of the environment and a form of AI to track all atoms, electrons and em radiation from the current environment. For simulated models, the same idea is used, whereby the intention is to use the signalless technology to store a 360 degree visual frame of the object we want to capture into pathways. A 3-d frame works like a regular 2-d camera frame, but it is in 3-dimensions. That means all internal and external atoms are tracked within a given focused area.

The clarity tree (or 3-d animation) for a given simulated model have defined boundary areas on an object. For example, a human being object will have only the physical boundaries related to a human being. The boundaries are determined through the self-organization process, whereby similar examples are compared and common traits are found. Sometimes boundaries are just estimates. A boundary for a human being might include clothing.

The clarity tree is based on how many times the simulation brain encountered this object. If there are lots of data related to an object in the simulation brain, then the clarity tree will have many visibility levels. If there are little data related to an object in the simulation brain, then the clarity tree will have little visibility levels.

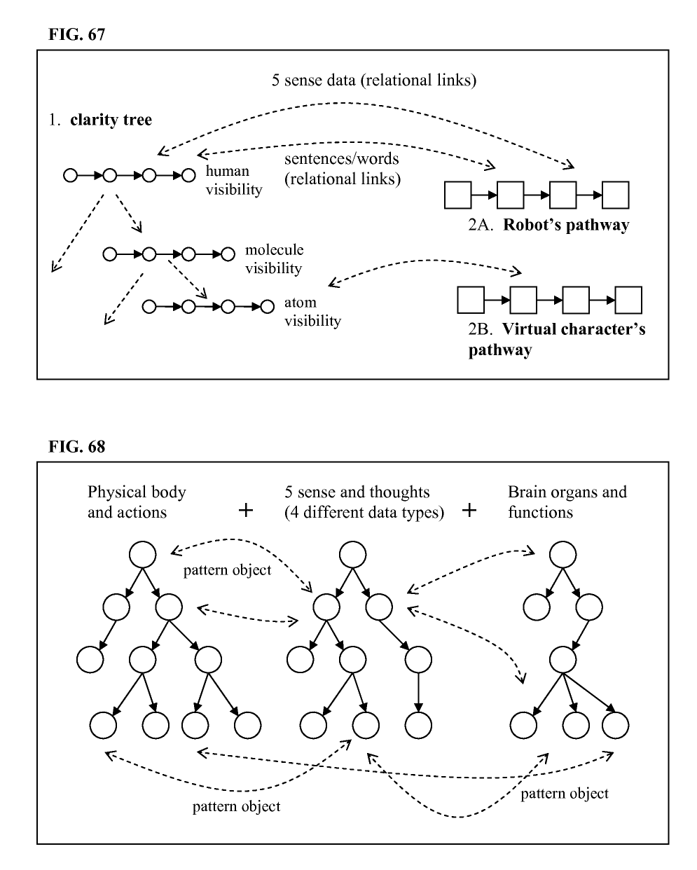

2. Robots in the real world or the virtual world will analyze each visibility level and their conscious thoughts, in terms of words/sentences, will identify objects, actions and events. These virtual characters have to do this for all visibility levels. Things that the virtual characters say will have reference pointers to objects in other levels of visibility. For example, if one virtual character is in the human visibility level he might say: “that is a car accident”, the words car accident will be referenced to the data in the lower levels such as the molecule visibility level or the atom visibility level. All data related to car accident in all levels will be referenced (FIG. 67).

Words and sentences to identify objects, actions and events in the clarity tree is important because language helps to organize data and to establish reference links for different visibility levels for each object. The learned groups (words/sentences) will help the commonality groups (the physical aspects) to organize data further. Automatic software to identify objects, events and actions can also be used. A software can be created, whereby it looks through each level of the clarity tree to identify objects, events and actions.

3. Using external software to simplify certain objects, actions and events. Hidden data are put into the data in each visibility level to help in identifying and grouping objects. For example, if the object is ambiguous like the weather on Earth, software can be used to put arrows for wind direction/speed; and groups can be generated for strong cloud coverage. These software simply makes it easier to delineate boundaries of objects, actions and events.

The simulated models stored in the simulation brain are created by “work” done by intelligent robots working in the time machine. They must define the brain model of the simulated model. Things that the intelligent objects are sensing from the environment and thought processes must be predicted. The hardware data (or 3-d animation) have to be predicted using tools like the signalless technology and the simulation brain. Finally, software data that is needed to understand the inner functions of the intelligent or non-intelligent object must be predicted.

Personal Model and Predicting the Exact Actions of a Human being

Predicting the exact future actions of a human being is very difficult. Learning human behavior in terms of pathways won't lead to an exact future action of a human being. They can help in aiding the predictions and giving probabilities of what might happen. The only way to solve this problem is to formulate the personal model. A simulated model has three pathway types: brain model, software data and hardware data. The person model is a sub-function in the brain model of an object (an object can be a human being or a table or a single cell).

The pathways from the lifespan of a human being have to self-organize and pattern objects will emerge. These patterns dictate the behavior of the specific human being—it is a personal model of that human being because this model is only concerned with how he/she thinks. FIG. 68 is a diagram depicting how patterns are found between all aspects of the human being. The physical body movements of the human being are compared with the mental thoughts of the human being. Brain organs of the human being and how they behave will be compared to the 5 senses of the human being. Thus, all aspects of a human being are searched and compared to find any pattern objects.

If you think about all the permutations and combinations of all data related to a human being, the outcome can run exponentially. The only way to solve this problem is to use supervised learning and to emphasize which data should be compared first, next and last. Data should be compared in a hierarchical manner. Data at the top of the tree are compared first because they are easier to compare and their possibilities are limited. FIG. 68 is a diagram depicting 3 hierarchical tree representing certain aspects of a human being. Most likely, on the top levels of each hierarchical tree are words/sentences and simplified data, while the bottom levels are the detail data.

Species of Simulated Models

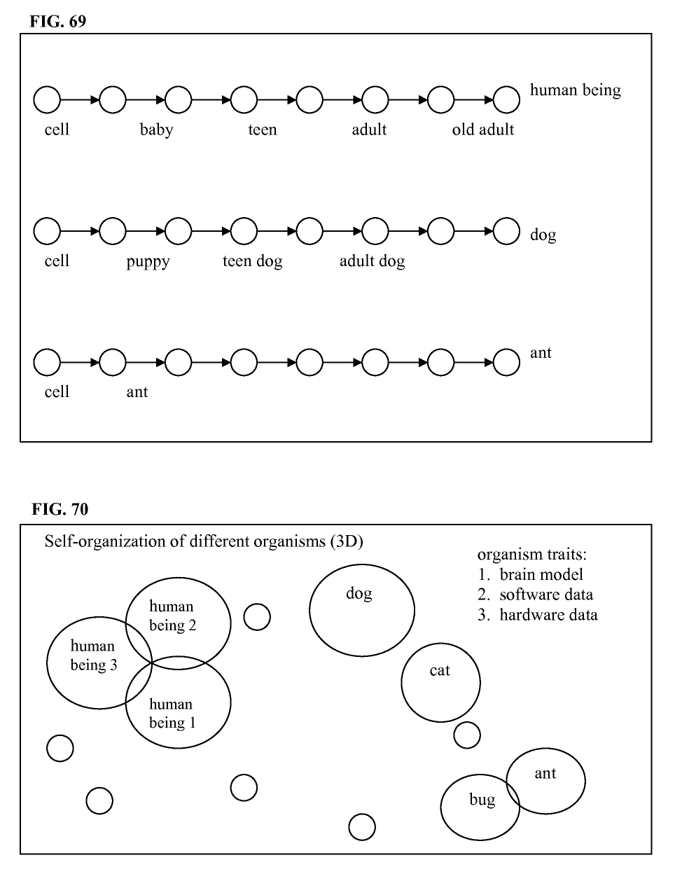

The robots have to create the simulated models for all robot species. All experiences of an intelligent object will be stored from the day it was born to the day it will die. The robots also have to define the 3-d animation for each fraction of a millisecond for that intelligent object. FIG. 69 is a diagram depicting the life-span of different intelligent objects: a human being, a dog and an ant. All their experiences will be stored in their respective simulated model and data on their 3-d animation will be filled in by the robots working in the time machine.

FIG. 70 is a diagram depicting the self-organization of different organisms in the simulation brain. Notice that organisms are classified according to their species. Human beings will most likely be organized with other human beings. Within a human being, young men will be organized with similar young men and older women will be organized with similar older women. Cats are more likely to be stored close to other similar animals such as a dog. Organisms like bugs and ants are similar objects because of their size and shape. They also sense data and act in similar manners.

The simulation brain also stores non-intelligent objects and also interactions between two or more objects. A simulated model can be created for two objects that interact with each other. For example, a human being can be one object and the other object can be a chair. The simulated model can outline how the two objects interact with each other and how the interactions change each other in terms of the three pathway types.

Of course, the more objects involved the more possibilities are stored in the simulated model. For example, the human being and the chair simulated model needs to store “all” sequence of interactions. This simulated model will be stored next to similar examples such as a human being sitting on a stool. Universal pathways will be created so that a fuzzy range of simulated models can be generated. An object can come in different sizes and shapes. All human beings look different, but if many examples are trained, a fuzzy range can be created called a floater. This floater will represent all human beings regardless of what they look like. Floaters help to manage infinite data in the simulation brain by creating simulated models that has a fuzzy range of itself.

In terms of the practical time machine, the intelligent robots that create the timeline for planet Earth has to use the simulation brain to do their predictions. They have to extract simulated models of objects they want to analyze and predict events in the timeline.

Various Methods to Predict the Future or Past

This section will outline the various prediction methods that the intelligent robots will use to predict the future or past. These are the most important prediction methods, my books outline hundreds of different prediction methods.

1. Using human intelligence to plot out events in a fixed tangible media. The most important aspect of predicting the future is work done by robots with human-level intelligence. The robot can use various software and hardware to predict events in the past or future. Investigators in CSI use human intelligence to solve crimes. They collect information from the crime scene, analyze evidence, plot out the timeline in a computer or report notebook, discuss with other investigators about possible events and so forth. These robots are no different. The only difference is that these robots can work in the real world or in a virtual world to investigate events.

2. Using the clarity tree in the simulated models to plot out events in the timeline. Events in the timeline should be plotted in a hierarchical manner. The most likely events to happen should be plotted first. Then, the details should be next. The robots (or investigators) use the simulation brain to find out what are the most likely actions of an object. The simulation brain has software that can search for information quickly and accurately. The simulated models in the simulation brain are already structured in a hierarchical manner because of self-organization. This hierarchical tree goes from general to specific. This will give the robots an easier time to extract the possibilities of an event in ranking order.

3. Using the personal model of a simulated model to give a more detail prediction of an event. A simulated model is an average model of how an object should behave. On the other hand, the personal model depicts a model of how that object will behave in a personal way. For example, if the robot wanted to predict the future actions of a person7, he can extract the best matched simulated model from the simulation brain. Based on what has already been predicted of person7, the robots can generate a personal model. This personal model will give more details on how person7 will behave in the future.

4. Combining simulated models together and using human intelligence to plot events in the timeline. Since the simulation brain can't store “all” permutations and combinations of simulated models, the robots have to use human intelligence to determine the future events when multiple simulated models interact with each other. The more simulated models the simulation brain has the easier it is to predict other events.

5. Using software to simplify and structure data in simulated models in a hierarchical manner. The clarity tree structures data, most notably visual data, in a hierarchical manner. The data goes from general to specific. The AI in the signalless technology is used to generate the clarity tree so that it goes from general to specific.

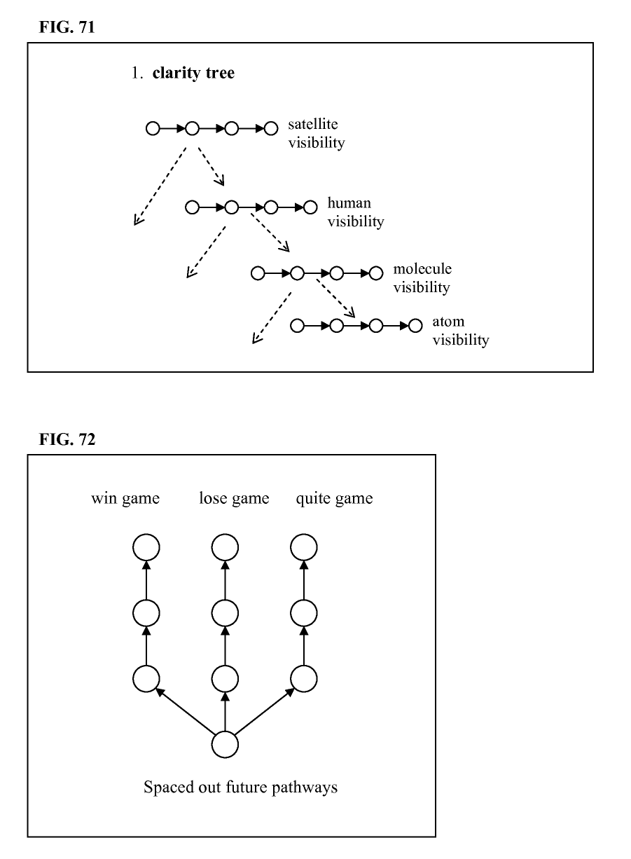

Let's move our attention towards liquid. Water is harder to track because the molecules slide from one molecule to the next based on force. Water can only be tracked using a hierarchical tracking system. A large lake is one area that water can be positioned and the water can't leave the lake. Within certain regions of the lake are smaller water regions. Within these smaller regions are even smaller regions. Liquid will be tracked hierarchically and in how they move. Computer software will be used to create hidden data pegged to this hierarchical structure of water. If you observe water from a satellite image, the water isn't moving. However, if you observe the same water from a camera, you can see the movements of the water. The AI should track the water from a hierarchical visibility tree. The AI might be able to track water movement from satellite visibility, but unable to track the water movement in terms of molecular visibility. The AI can use the satellite visibility and human visibility and to guess the water movement for the molecular and atom visibility levels. FIG. 71 is a diagram depicting the hierarchical structure of water and how the AI tracks water movements.

Some Methods to Predict the Future

1. Fabricating Similar Future Pathways

Predicting things like creativity and rare events are very hard to do. If the robots had to predict an artwork done by a human being, how exactly will these types of prediction be made? If you observe comic book artists such as jim lee, marc silvestri, todd mcfarlene and rob lefield you will notice that each artist has a style of drawing. Under certain story telling situations they draw in a certain way or they layout their characters in a certain way. I have been collecting comic books for over 14 years and I can tell you from past experience that I can be presented with a drawing and I can tell people who drew that picture. I can also predict what kinds of layout each artist will probable do.

The reason I was able to predict each artists artwork is because I have seen so much of their artwork. If you look at a famous artist like Leonardo di vinci and observe all his artwork, there is a clear pattern or style to his artwork.

The idea behind this first method of predicting the future is to generate similar future pathways of how an artist will create an artwork. Let's say that the robots wanted to predict a person writing a book. They can put the person into slightly different situations to create the book and generate multiple similar future pathways. The robots store the future pathways in a 3-d grid to self-organize common traits between all predicted pathways. This will form universal pathways that will happen regardless of what the environment is.

If I was to write a book 1,000 times and each book is written in a slightly different environment, there will be common things I will write about. Maybe the exact words will not be used or the exact content will not be in sequence order. However, there are common traits among the 1,000 books I have written. These common traits might be the book is about time travel using AI, the book will outline methods to predict the future, the beginning of the book will be the introduction, the book will also have additional topics at the end, the overall idea behind the book is similar and so forth. By generating similar future pathways, and determining the universal and rare events, the robots can better understand what are the universal events that will happen and what are the rare events that will happen.

Let's look at another example, when I was a teen I remember going to the park with my friend and playing catch the tennis ball. For a time we threw the tennis ball back and forth. On one of the plays, my friend was distracted by something that was happening on the road. I accidentally threw the ball and the ball landed on top of his head. The event where my friend was distracted and I threw the ball and it landed on top of his head is considered a rare event.

If the robots have to predict the entire day I was on the park, how exactly will they predict the rare event? How will they know that I threw the tennis ball 30 yards and it happen to land on someone's head? The answer lies in generating many similar future pathways and to establish relational links to each other. If the robots generate 1,000 different future pathways there might be 5 pathways that have me throwing the tennis ball and it landing on that person. The other future pathways might be similar events and they show that I threw the tennis ball and that ball came close to landing on his head. By establishing relational links between similar examples the rare event may not actually be rare.

We can also use these future pathways and compare them to previous events in life. I notice in my life this rare event wasn't the first time it happened. I remember in high school I was playing basketball and I threw the ball from full court and the ball went into the basket. In another event I made a bet with someone that I can throw a paper ball and it will land into the trash can. I actually won that bet. By observing my past and comparing similar rare events the robots can determine wither or not a rare event is actually rare.

Great golfers are great because they have the pathways in memory to perform their job well. That's why people like tiger woods always do well. He might slip up on some games but he always does well. People who are sport players such as quarterbacks are also consistent. They do well consistently and fans know how a player will perform in a game. Some people even have sports prediction sites that will rank each player and why certain teams are more likely to win a championship.

2. Spaced Out Future Pathways

Pathways can also be spaced out by having the robots plot out future events. For example, if the robots wanted to predict the future of a baseball game it might be difficult. Instead of plotting out the exact events leading up to the end results, the robots can predict the various possibilities of the end result. FIG. 72 is a diagram depicting 3 future pathways. Each is plotted with sentences to represent an event as a result of a baseball game. A team can lose the game, win the game or quite the game. There might be circumstances where the game can't continue because of weather related conditions or a team refuses to continue the game. These conditions are categorized into quitting the game. So, these plotted future pathways are created because of common sense and logical analysis. If you observe most of the simulated models for sport games, they already have these three outcomes stored in their pathways.

Spaced out future pathways isn't totally based on intelligent robots plotting future events, but are also selected from pathways in simulated models. Imagine that there are 1,000 pathways to choose from in a simulated model and they are all equal in probability, the robots can use a form of AI to randomly pick spaced out outcomes. Similar outcomes are excluded, the robots are only interested in a wide range of possibilities that are not related to each other. An AI software can be created to extract certain pathways from simulated models based on a user's preference.

3. Cut, Copy and Paste Future Pathways

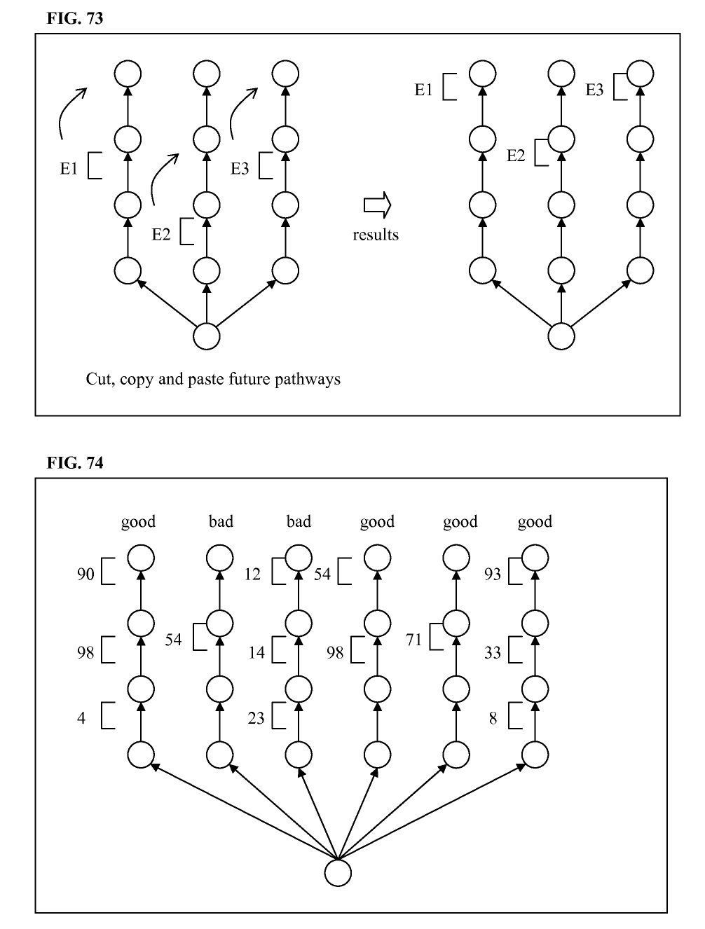

Sometimes, if a person does something in one area, they may not do the same thing in another area. Other times a person may not do the same things in different times. Space and time is very important to determine the appropriate actions for a person. This prediction method would require the robot to cut out certain events from a pathway and change the place and time it will occur (referring to FIG. 73). By having a wide variety of events put in different times and places, the robots will have a better idea of what are universal events and what are rare events. If it is proven that an event is rare, these prediction methods can outline how rare it truly is.

4. Determining Similar Traits Between Future Pathways Based on Pain and Pleasure

In addition to all the common traits mentioned above, the future pathways self-organize based on pain and pleasure (referring to FIG. 74). Each object, event or action has their own powerpoints. Some of these powerpoints are encapsulated. The robots have to outline the powerpoints for each event, object or action in each future pathway and to establish relational links to powerpoints of other future pathways. This type of self-organization is based on pain and pleasure. If two events have the same pleasure, but both events are totally different they will still be grouped together.

5. Simulating every aspect of an independent object into a software to determine its future actions. One method to predict a random number outputted by a computer is to simulate the entire computer inside a software and let the simulation output the random number. Any dependant factors that result in the random number must be included in the simulation.

Conclusion: all predicted methods mentioned above work together in combinations in order to predict the future with pinpoint accuracy. These methods are used to outline universal and rare event so that the robots can predict very complex situations such as artistic expressions or coincidental events. If an event predicted is considered rare these prediction methods can outline how rare these rare events are.

Additional Features Added to the AI Time Machine

The AI time machine is an all purpose software machine that can do tasks for a user. It can search over the internet to find information, answer questions, do individual or group tasks and so forth. A list of features was presented in the beginning of this patent application. Additional features of the AI time machine will include: controlling dummy robots and controlling the atom manipulator.

Dummy robots are simply robot shells that receive pathways to do tasks. The AI time machine can use the universal computer program to assign station pathways to dummy robots to do individual or group tasks. For example, 10 dummy robots are located in a car factory. A user inputs instructions into the AI time machine to build 5 custom made cars. The input media can be a software fillable form that takes in commands from the user. After the fillable form is submitted the AI time machine will search for the station pathways that will allow the dummy robots to operate to make 5 custom made cars.

The AI time machine uses the universal computer program to train itself to assign certain fixed interface functions to certain tasks.

To make the AI time machine more efficient, the dummy robots are replaced with ghost machines. The user can input the commands to build 5 custom made cars and the AI time machine will control the atom manipulator to create ghost machines to build the 5 custom made cars.

The AI time machine will use the universal computer program to assign fixed interface functions to encapsulate work done by the atom manipulator. The atom manipulator can build a house, write a book, solve a math equation, do research, do surgery and so forth without any physical robot. Once the interface functions are assigned to certain work, a user can execute these work by accessing the interface functions. It is very important the AI time machine goes through adequate training in order for these fixed interface functions to operate correctly.

Additional Capabilities of the Ghost Machines

Building Physical DNA and Single Cells

In my patent application called DNA machine software program, I describe how physical DNA is created. With the help of the atom manipulator, it is possible to create physical DNA and single cell organisms. We can actually build organic computers, cellphones, printers, cars, planes or aliens. These single cell organisms will go through mitosis and develop into an adult organism. In fact, we can design any type of dna we want. We can design a human being with 8 arms and 4 legs or a human being with blue skin. The various possibilities of design for dna can be unlimited.

DNA is very small, but individual DNA strands are made from thousands of molecules. If this atom manipulator can manipulate atoms, it can manipulate molecules even better. Organic life-forms use 4 chemical bases as the foundation for the DNA's genetic code. We can build DNA using only 2 chemical base or 8 chemical bases.

Existing organic DNA and RNA can also be manipulated to function a certain way. We can design the cells to create anything we want it to create—grow back an adult arm or grow a child heart, cure genetic diseases and so forth. We can also control the shape, size, and cell division aspects of the organic object.

This atom manipulator is one level higher than conventional nanotechnology because we are able to build materials atom-for-atom. We can control how materials are built at an atomic level. This will allow the atom manipulator to build the smallest machines, smallest computer chips, strongest metals, 100% pure materials and so forth.

No Post Office

Instead of shipping boxes and products through the post office, the atom manipulator can beam all objects from one location to a destination instantaneously. When a person orders a product online, the company can ship the product in less than one second. The atom manipulator has to fire atoms from the atom reserves layer to make a product. The process goes like this: the atom manipulator has to have a simulated model of a product in its database. This simulated model contains a detail atom-by-atom specs of the product being shipped. According to the simulated model, the atom manipulate will fire atoms from its atom reserves layer and bounce these atoms to their customer's home. These atoms will reach the customer's home in “packets”, just like packets over the internet. The atom manipulator will then create ghost machines to combine the atoms together, forming a product that the customer ordered.

Building rockets or any vehicle that can travel at the speed of light. The speed of light is about 380 billion miles per second. Using this technology, rockets can travel from Earth to Pluto in a few minutes (certainly less than an hour).

The foregoing has outlined, in general, the physical aspects of the invention and is to serve as an aid to better understanding the intended use and application of the invention. In reference to such, there is to be a clear understanding that the present invention is not limited to the method or detail of construction, fabrication, material, or application of use described and illustrated herein. Any other variation of fabrication, use, or application should be considered apparent as an alternative embodiment of the present invention.

What is claimed is:

1. A method for time travel, the steps comprising:
multiple robots working in the real world and the virtual world using investigative tools and a signalless technology to create a perfect timeline of Earth, whereby all objects, events and actions are recorded in said timeline every fraction of a nanosecond for the past and the future,
a time traveler will set a time travel date, said time traveler comprising at least one object; and said time traveler can be in at least one of the following states: frozen state and controlled changed state,
multiple atom manipulators are scattered throughout Earth and said atom manipulators will work together in an organized manner to manipulate the current environment based on said timeline, and will further create intelligent ghost machines to manipulate said current environment, and
from said current environment, the atom manipulator will incrementally manipulate said current environment until said current environment reaches said time travel date.

2. A method of claim 1, wherein said investigative tools comprises: all knowledge from said timeline of Earth, all knowledge from said timeline of the internet, research knowledge, knowledge data, software programs, hardware devices, computers, a time machine, networks, encapsulated work done by virtual characters, a simulation brain, and a universal brain.

3. A method of claim 1, wherein each robot has a 6^{th} sense, which is a virtual world, said robot comprising:
an artificial intelligent computer program repeats itself in a single for-loop to:
receive input from the environment based on the 5 senses called the current pathway,
use an image processor to dissect said current pathway into sections called partial data,
generate an initial encapsulated tree for said current pathway; and prepare variations to be searched,
average all data in said initial encapsulated tree for said current pathway,
execute two search functions, one using breadth-first search algorithm and the other using depth-first search algorithm,
target objects found in memory will have their element objects extracted and all element objects from all said target objects will compete to activate in said artificial intelligent program's mind,
find best pathway matches,
find best future pathway from said best pathway matches and calculate an optimal pathway,
extract specific data from predicted future pathways and insert them into said artificial intelligent program's conscious,
generate an optimal encapsulated tree for said current pathway,
store said current pathway and its' said optimal encapsulated tree in said optimal pathway, said current pathway comprising 4 different data types: 5 sense objects, hidden objects, activated element objects, and pattern objects,
follow future instructions of said optimal pathway,
retrain all objects in said optimal encapsulated tree starting from the root node,
universalize pathways or data in said optimal pathway, and
repeat said for-loop from the beginning;
a 3-dimensional memory to store all data received by said artificial intelligent program;
a long-term memory used by said artificial intelligent program; and
a time machine used by said artificial intelligent program.

4. A method of claim 3, in which said robot uses 3 world brains, comprising: real world brain, virtual world brain, and time machine brain, each brain stores pathways from objects existing in their world, said object being at least one of the following: a robot or a virtual character, an intelligent entity, a group of robots, a non-intelligent machine, a computer, and a network.

5. A method of claim 4, wherein said pathways in said virtual world brain and said time machine brain generates a universal computer program, whereby said robot in the virtual world establishes the situation and the results; and said virtual characters in the time machine world establishes the encapsulated work.

6. A method of claim 4, wherein each world brain self-organize their pathways and establish relational links with their pathways, forming station pathways, said station pathways being teams of virtual characters or robots working together to accomplish tasks.

7. A method of claim 5, in which said universal computer program comprises software to encapsulated work, the steps to assign a dummy fixed interface function from said software to an encapsulated work, comprises:
said robot in the virtual world will determine a problem to solve and to plan steps to solve said problem,
set the environment of the time machine according to said problem,
create the dummy interface function and pretend to access said dummy interface function,
copy itself into the time machine designated as a virtual character to do work,
submit desired output to said robot in the virtual world in a viewable manner, said desired output can be in any media.

8. A method of claim 1, wherein said atom manipulator comprises: a laser system, a signalless technology, an atom reserve layer, a passenger storage area, and a machine host body.

9. A method of claim 8, wherein said signalless technology generates a map on said current environment in the quickest time possible, and records all objects in said current environment in a hierarchical clarity tree, comprising:
at least one sensing device, said sensing device comprising: a camera, a 360 degree camera, GPS, sonar device, an EM radiation device; and
an AI system that uses the universal computer program to process input data from said sensing device.

10. A method of claim 1, in which said multiple robots in the virtual world further uses a prediction internet to communicate with other robots and input, delete, and modify individual predictions.

11. A method of claim 1, wherein said multiple robots further uses investigative methods to predict the past or future of Earth, comprising at least one of the following: using human intelligence to plot out events in a fixed tangible media, using the clarity tree in the simulated models to plot out events in the timeline, combining simulated models together and using human intelligence to plot events in the timeline, using software to simplify and structure data in simulated models in a hierarchical manner; and said investigative methods further comprising: fabricating similar future pathways, fabricating spaced out future pathways, cutting, copying and pasting future pathways, determining similar traits between future pathways based on pain and pleasure, simulating every aspect of an independent object into a software using human intelligence to determine said object's future actions.

12. A method of claim 8, in which said atom manipulator go through training sessions, said training sessions comprising 3 pathway data types: a clarity tree, at least one robot pathways, and encapsulated work, said atom manipulator uses fixed interface functions to control said laser system to operate, the steps comprising:
at least one robot will identify a task to accomplish with said atom manipulator;
entering a training session for-loop;
robots in the virtual world and virtual characters in the time machine are structured in a hierarchical manner to create encapsulated work for one training session;
generating the training session;
testing said training session in the real world;
assigning said encapsulated work to a fixed interface function in said atom manipulator using said universal computer program; and
repeating said training session for-loop from the beginning until said task is accomplished.

13. A method of claim 1, in which said atom manipulator generate intelligent ghost machines that work together to manipulate said current environment, said atom manipulator uses fixed interface functions to control said laser system to operate, the steps comprising:
at least one robot will identify a task to accomplish with said atom manipulator;
entering a training session for-loop;
robots in the virtual world and virtual characters in the time machine are structured in a hierarchical manner to create encapsulated work for one training session;
generating the training session;
testing said training session in the real world;
assigning said encapsulated work to a fixed interface function in said atom manipulator using said universal computer program; and
repeating said training session for-loop from the beginning until the ending of said station pathway.

14. A method of claim 13, wherein said training session for ghost machines comprises: a training situation and a fabricated situation; said training situation comprises: a station pathway and a clarity tree; and said fabricated situation comprises robot pathways, a clarity tree, and encapsulated work.

15. A method of claim 13, wherein said encapsulated work comprises teams of virtual characters or robots using the universal computer program, and further using videogame software and said investigative tools to repeatedly encapsulate their work.

16. A method of claim 13, wherein said encapsulated work for said teams of virtual characters or robots, comprises: translating tasks done in said station pathway by at least one of a physical robot and physical machine; and providing the same task done by said ghost machines, called a fabricated situation.

17. A method of claim 13, in which said virtual characters understand their rules, objectives, powers, and status from common knowledge, learned through at least one of the following: books, research papers, television, radio, school and college.

18. A method of claim 2, wherein said simulation brain comprises: simulated models and predicted models, each model comprising 3 pathway types:
a brain model, comprising the 4 different data types: 5 sense objects, hidden object, activated element objects and pattern objects, and further comprising a personal model, which self-organize behavioral and aspects of an object and outputting repeated pattern behavior in terms of thought and physical action;
a software data, which store hidden data related to the object being analyzed; and
a hardware data, which store the physical aspects of the object being analyzed in terms of a clarity tree, said clarity tree is generated by a signalless technology, which depicts hierarchical levels of visibility, each visibility level comprises pathways, which records objects in an environment in a 3-d manner and has at least one focus and at least one peripheral area.

19. A method of claim 2, in which said time machine or AI time machine is an all purpose AI system using said universal computer program to assign fixed interface functions to encapsulated work; and capabilities of the AI time machine comprises the following: predicting all events, actions and objects on planet Earth every fraction of a millisecond in the future and the past, predicting the past and future timeline of all contents on the internet, answering any question, accomplishing sequences of tasks, following orders and giving opinions, accomplishing work requiring one person or a team of people, controlling any physical machine and sharing intelligence by assumption, controlling dummy robots, controlling atom manipulators, and controlling ghost machines; said fixed interface functions can be at least one of the following media: software interface functions, voice activation and manual hardware controls.

20. A method of claim 1, wherein said atom manipulator manipulates objects in said current environment, generate hierarchically structured ghost machines, and providing said ghost machines' intelligence, physical actions, and communications, to create at least one of the following technologies: a technology to build cars, planes and rockets that travel at the speed of light, build intelligent weapons, create physical objects from thin air, use a chamber to manipulate objects, build force fields, make objects invisible, build super powerful lasers, build anti-gravity machines, create strong metals and alloys, create the smallest computer chips, store energy without any solar panels or wind turbines, make physical DNA, manipulate existing DNA, make single cell organisms, control the software and hardware of computers and servers without an internet connection, and manipulate any object in the world.
